(19) United States
(12) Patent Application Publication
(10) Pub. No.: US 2026/0333242 A1
(43) Pub. Date: Oct. 22, 2026

(54) CONFIGURING TRANSMIT POWER FOR SENSING TRANSMISSIONS

(71) Applicant: Lenovo (United States) Inc., Morrisville, NC (US)

(72) Inventors: Robin Rajan Thomas, Bad Nauheim (DE); Seyedomid Taghizadeh Motlagh, Oberursel (DE)

(73) Assignee: Lenovo (United States) Inc., Morrisville, NC (US)

(21) Appl. No.: 19/348,105

(22) Filed: Oct. 2, 2025

(51) Int. Cl. H04W 52/24; H04W 52/54

(52) U.S. Cl. CPC H04W 52/242; H04W 52/54

(57) ABSTRACT

Various aspects of the present disclosure relate to configuring transmit power for sensing transmissions. A network entity (NE) may transmit first signaling to a first device (e.g., a transmitting device) that indicates time-frequency information including one or more time-frequency resource identifiers for second signaling and that indicates respective sets of power control parameters. The second signaling is associated with a sensing mode of operation. The first device may transmit the second signaling to a second device (e.g., a receiving device) in the sensing mode of operation and based on the time-frequency resource information using at least one transmit power. The at least one transmit power is based on the respective sets of power control parameters. The second device may perform one or more measurements associated with the signaling and corresponding to one or more sensing targets. The second device may transmit the measurements to the NE.

### TECHNICAL FIELD

The present disclosure relates to wireless communications, and more specifically to power control at one or more devices.

### BACKGROUND

A wireless communications system may include one or multiple network communication devices, which may be otherwise known as network entity (NE) or network equipment, supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

As used herein, including in the claims, an article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The devices (e.g., NE, UE), processors, and methods of the present disclosure each have several innovative aspects, no single one of which is solely responsible for the desirable features disclosed herein.

A device (e.g., a transmitting device, including a UE, an NE, or a transmission-reception point (TRP)) for wireless communication is described. The device may be configured to, capable of, or operable to perform one or more operations as described herein. For example, the device may be configured to, capable of, or operable to receive first signaling that indicates time-frequency resource information including at least one or more time-frequency resource identifiers for second signaling (e.g., the second signaling and the first signaling may be the same or may be different) and that indicates respective sets of power control parameters corresponding to the one or more time-frequency resource identifiers, where the second signaling is associated with a sensing mode of operation, and transmit, in the sensing mode of operation and based on the time-frequency resource information, the second signaling using at least one transmit power, where the at least one transmit power is based on the respective sets of power control parameters.

A processor (e.g., a standalone processor chipset, or a component of a transmitting device) for wireless communication is described. The processor may be configured to, capable of, or operable to perform one or more operations as described herein. For example, the processor may be configured to, capable of, or operable to receive first signaling that indicates time-frequency resource information including at least one or more time-frequency resource identifiers for second signaling and that indicates respective sets of power control parameters corresponding to the one or more time-frequency resource identifiers, where the second signaling is associated with a sensing mode of operation, and transmit, in the sensing mode of operation and based on the time-frequency resource information, the second signaling using at least one transmit power, where the at least one transmit power is based on the respective sets of power control parameters.

A method performed or performable by a device (e.g., a transmitting device, including a UE, an NE, or a TRP) for wireless communication is described. The method may include receiving first signaling that indicates time-frequency resource information including at least one or more time-frequency resource identifiers for second signaling and that indicates respective sets of power control parameters corresponding to the one or more time-frequency resource identifiers, where the second signaling is associated with a sensing mode of operation, and transmitting, in the sensing mode of operation and based on the time-frequency resource information, the second signaling using at least one transmit power, where the at least one transmit power is based on the respective sets of power control parameters.

In some implementations of the device, the processor, and the method described herein, the device, the processor, and the method may further be configured to, capable of, or operable to transmit the second signaling using an update to the at least one transmit power, where the update to the at least one transmit power is based on one or more of a pathloss associated with one or more sensing targets, a maximum received self-interference power, a saturation power level, an isolation level between a transmitter and a receiver associated with the device, or a configured maximum transmit power for sensing and communication. In some implementations of the device, the processor, and the method described herein, the device, the processor, and the method may further be configured to, capable of, or operable to receive third signaling that indicates one or more measurements associated with the pathloss, the update to the at least one transmit power, a transmit power command, or a sensing transmit power command. In some implementations of the device, the processor, and the method described herein, the maximum received self-interference power, the saturation power level, or the isolation level are per at least one of transmit beam, receive beam, or transmit and receive beam pair. In some implementations of the device, the processor, and the method described herein, the device, the processor, and the method may further be configured to, capable of, or operable to apply the update to the at least one transmit power for a transmission time interval (TTI) including at least one of a set of sub-symbols, symbols, sub-slots, slots, subframes, frames, system frames, hyper frames, or a time duration corresponding to the second signaling.

In some implementations of the device, the processor, and the method described herein, the sensing mode of operation is monostatic, where the respective sets of power control parameters are based on one or more of a relative distance between the device and a sensing target or a direction of the device relative to the sensing target. In some implementations of the device, the processor, and the method described herein, the device, the processor, and the method may further be configured to, capable of, or operable to receive third signaling from one or more additional devices, perform one or more inter-site interference measurements associated with the third signaling, and transmit, to an NE (e.g., a configuration entity and/or a sensing result computation entity), the one or more inter-site interference measurements. In some implementations of the device, the processor, and the method described herein, the device, the processor, and the method may further be configured to, capable of, or operable to receive a measurement associated with a reflected path of a sensing target, where the measurement includes at least one of a signal-to-noise ratio (SNR), a signal-to-interference-noise ratio (SINR), a sensing SNR (SSNR), a sensing SINR (SSINR), a reference signal received power (RSRP), a reference signal received path power (RSRPP), a Doppler-delay path profile, a range-Doppler profile, or an angle-delay profile, and where the at least one transmit power is based on a difference between the measurement and a target measurement.

In some implementations of the device, the processor, and the method described herein, the device, the processor, and the method may further be configured to, capable of, or operable to transmit, to at least one of an additional device or an NE, third signaling that indicates the at least one transmit power. In some implementations of the device, the processor, and the method described herein, the at least one transmit power is based on a default transmit power, and where the default transmit power is based on an internal configuration of the device. In some implementations of the device, the processor, and the method described herein, the respective sets of power control parameters include an average energy per resource element (RE) associated with the second signaling, a bitmap that indicates one or more time locations of the second signaling for muting, a field that indicates a presence of one or more automatic gain control (AGC) symbols associated with the second signaling, a number of symbols associated with the second signaling, or the one or more time-frequency resource identifiers, and where the one or more time-frequency resource identifiers indicate one or more of an RE, a set of REs, a frequency layer, or a carrier frequency. In some implementations of the device, the processor, and the method described herein, the device includes one of a first UE, a first NE, or a TRP, and where the first signaling is received from one of a second NE or a second UE. In some implementations of the device, the processor, and the method described herein, the second signaling includes at least one of a sensing reference signal (SeRS), a positioning reference signal (PRS), a tracking reference signal (TRS), a channel state information reference signal (CSI-RS), a demodulation reference signal (DMRS), a phase tracking reference signal (PTRS), a sounding reference signal (SRS), a synchronization signal block (SSB), control signaling, or data symbols, and where the sensing mode of operation includes one or more of a monostatic sensing mode, a bistatic sensing mode, a multistatic sensing mode, or a common sensing mode.

A device (e.g., a receiving device, including a UE, an NE, or a TRP) for wireless communication is described. The device may be configured to, capable of, or operable to perform one or more operations as described herein. For example, the device may be configured to, capable of, or operable to receive signaling associated with a sensing mode of operation, where the signaling is associated with at least one transmit power that is based on time-frequency resource information including at least one or more time-frequency resource identifiers for the signaling and that is based on respective sets of power control parameters corresponding to the one or more time-frequency resource identifiers, and perform, based on the at least one transmit power, one or more measurements associated with the signaling.

A processor (e.g., a standalone processor chipset, or a component of a receiving device) for wireless communication is described. The processor may be configured to, capable of, or operable to perform one or more operations as described herein. For example, the processor may be configured to, capable of, or operable to receive signaling associated with a sensing mode of operation, where the signaling is associated with at least one transmit power that is based on time-frequency resource information including at least one or more time-frequency resource identifiers for the signaling and that is based on respective sets of power control parameters corresponding to the one or more time-frequency resource identifiers, and perform, based on the at least one transmit power, one or more measurements associated with the signaling.

A method performed or performable by a device (e.g., a receiving device, including a UE, an NE, or a TRP) for wireless communication is described. The method may include receiving signaling associated with a sensing mode of operation, where the signaling is associated with at least one transmit power that is based on time-frequency resource information including at least one or more time-frequency resource identifiers for the signaling and that is based on respective sets of power control parameters corresponding to the one or more time-frequency resource identifiers, and performing, based on the at least one transmit power, one or more measurements associated with the signaling.

In some implementations of the device, the processor, and the method described herein, the device, the processor, and the method may further be configured to, capable of, or operable to transmit, to at least one of an additional device or an NE, additional signaling that indicates at least one of an update to the at least one transmit power or the one or more measurements. In some implementations of the device, the processor, and the method described herein, the one or more measurements include a pathloss as a function of one or more pathloss parameters associated with the sensing mode of operation, and where the one or more pathloss parameters include one or more of a carrier frequency of the signaling, a first pathloss between an additional device that transmitted the signaling and a sensing target, a second pathloss between the sensing target and the device, a radar cross section (RCS) of the sensing target, a first estimated shadow fading between the additional device and the sensing target, or a second estimated shadow fading between the device and the sensing target. In some implementations, the device includes one of a first UE, a first NE, or a first TRP, and where the signaling is received from one of a second UE, a second NE, or a second TRP.

An NE (e.g., a network equipment, a base station, a gNB, a configuration entity, a sensing result computation entity or other radio access network (RAN) entity or core network (CN) entity) for wireless communication is described. The NE may be configured to, capable of, or operable to perform one or more operations as described herein. For example, the NE may be configured to, capable of, or operable to transmit first signaling that indicates time-frequency resource information including at least one or more time-frequency resource identifiers for signaling and that indicates respective sets of power control parameters corresponding to the one or more time-frequency resource identifiers, where the first signaling is associated with a sensing mode of operation, and where at least one transmit power for the first signaling is based on the respective sets of power control parameters, and receive, based on the first signaling and the sensing mode of operation, second signaling that indicates a set of measurements corresponding to one or more sensing targets.

A processor (e.g., a standalone processor chipset, or a component of an NE) for wireless communication is described. The processor may be configured to, capable of, or operable to perform one or more operations as described herein. For example, the processor may be configured to, capable of, or operable to transmit first signaling that indicates time-frequency resource information including at least one or more time-frequency resource identifiers for signaling and that indicates respective sets of power control parameters corresponding to the one or more time-frequency resource identifiers, where the first signaling is associated with a sensing mode of operation, and where at least one transmit power for the first signaling is based on the respective sets of power control parameters, and receive, based on the first signaling and the sensing mode of operation, second signaling that indicates a set of measurements corresponding to one or more sensing targets.

A method performed or performable by an NE for wireless communication is described. The method may include transmitting first signaling that indicates time-frequency resource information including at least one or more time-frequency resource identifiers for signaling and that indicates respective sets of power control parameters corresponding to the one or more time-frequency resource identifiers, where the first signaling is associated with a sensing mode of operation, and where at least one transmit power for the first signaling is based on the respective sets of power control parameters, and receiving, based on the first signaling and the sensing mode of operation, second signaling that indicates a set of measurements corresponding to one or more sensing targets.

In some implementations of the NE, the processor, and the method described herein, the NE, the processor, and the method may further be configured to, capable of, or operable to transmit third signaling that indicates one or more measurements associated with a pathloss, an update to the at least one transmit power, a transmit power command, or a sensing transmit power command. In some implementations of the NE, the processor, and the method described herein, the NE, the processor, and the method may further be configured to, capable of, or operable to receive, from one or more devices, one or more inter-site interference measurements. In some implementations of the NE, the processor, and the method described herein, the NE, the processor, and the method may further be configured to, capable of, or operable to receive, from a first device, a measurement associated with a reflected path of a sensing target, where the measurement includes at least one of an SNR, an SINR, an SSNR, an RSRP, an SSINR, an RSRPP, a Doppler-delay path profile, a range-Doppler profile, or an angle-delay profile, and where the at least one transmit power is based on a difference between the measurement and a target measurement. In some implementations, the NE, the processor, and the method may further be configured to, capable of, or operable to receive, from a device, third signaling that indicates the at least one transmit power.

### BRIEF DESCRIPTION OF THE DRAWINGS

FIGS. 1 through 3 illustrate examples of wireless communications systems in accordance with aspects of the present disclosure.

FIG. 4 illustrates an example network architecture diagram, in accordance with aspects of the present disclosure.

FIG. 5 illustrates an example of a transmission diagram, in accordance with aspects of the present disclosure.

FIG. 6 illustrates an example of a wireless communications system, in accordance with aspects of the present disclosure.

FIG. 7 illustrates an example of a process flow, in accordance with aspects of the present disclosure.

FIG. 8 illustrates an example of a signaling diagram, in accordance with aspects of the present disclosure.

FIGS. 9 through 11 illustrate examples of wireless communications systems in accordance with aspects of the present disclosure.

FIGS. 12 and 13 illustrate examples of process flows in accordance with aspects of the present disclosure.

FIGS. 14 and 15 illustrate examples of signaling diagrams in accordance with aspects of the present disclosure.

FIGS. 16 and 17 illustrate examples of transmission diagrams in accordance with aspects of the present disclosure.

FIG. 18 illustrates an example of a signaling diagram, in accordance with aspects of the present disclosure.

FIGS. 19 and 20 illustrate examples of transmission diagrams in accordance with aspects of the present disclosure.

FIG. 21 illustrates an example of a UE in accordance with aspects of the present disclosure.

FIG. 22 illustrates an example of a processor in accordance with aspects of the present disclosure.

FIG. 23 illustrates an example of an NE in accordance with aspects of the present disclosure.

FIG. 24 illustrates a flowchart of a method performed by a transmitting device (e.g., an NE, a TRP, or a UE) in accordance with aspects of the present disclosure.

FIG. 25 illustrates a flowchart of a method performed by an receiving device (e.g., an NE, a TRP, or a UE) in accordance with aspects of the present disclosure.

FIG. 26 illustrates a flowchart of a method performed by an NE (e.g., a base station, a gNB, a configuration entity, and/or sensing result computation entity) in accordance with aspects of the present disclosure.

### DETAILED DESCRIPTION

In a wireless communications system, one or more devices (TRPs, UEs, NEs, including base stations and gNBs, etc.) may support reception and/or transmission of wireless communication using time-frequency resources. For example, the devices may perform one or more sensing operations, including human and/or object detection, weather and/or automated guidance vehicle (AGV) monitoring and tracking, automotive sensing, and utilization of sensing and positioning information to manage wireless communications. To perform the sensing operations, one or more transmitting devices may transmit a signal that is deflected off of a sensing target towards one or more receiving devices. The receiving devices and/or a centralized entity (e.g., a sensing result computation entity) may perform one or more computations utilizing the received signal to determine information about the sensing target, including a position estimate and/or a velocity estimate, among other information.

In some cases, the receiving devices may have difficulty detecting nuances in the signal and/or may not detect the signal at all due to various factors, such as a distance between the transmitting devices and the sensing target, a distance between the receiving devices and the sensing target, RCS characteristics of the sensing target, a background and target channel, signaling from other transmitting devices that causes interference, and/or other communication services. To improve signal quality at a receiving device, a transmitting device may increase a transmit power for the signal. However, increasing a transmit power may increase a noise floor for the transmission and may also increase interference to other neighboring devices, as well as the transmitting device. Further, the transmitting and receiving devices may not have a defined configuration for adjusting the transmit power, leading to inaccurate sensing measurements due to inconsistent or unknown variations in transmit power.

As described herein, to reduce interference caused by adjusting a transmit power, as well as to establish a common transmit power configuration for transmitting and receiving devices, an NE may transmit signaling to a transmitting device that indicates time-frequency information, including time-frequency resource identifiers, and corresponding sets of power control parameters to apply to signaling in a sensing mode of operation (e.g., one or more sensing transmissions). The power control parameters may include, but are not limited to, an average energy per RE for the signaling, a bitmap that indicates one or more time locations of the signaling for muting, a field that indicates a presence of one or more AGC symbols in the signaling, a number of symbols in the sensing signaling, pathloss compensation factors, maximum transmit power limits, beam-specific power adjustments, or interference mitigation parameters. The transmitting device may use the power control parameters to determine and/or update a transmit power for transmitting the signaling to at least one receiving device in the sensing mode of operation. The transmitting device may apply the power control parameters on a per-resource basis according to the time-frequency resource identifiers, where different sets of power control parameters may be applied to different REs, resource sets, frequency layers, or carrier frequencies as indicated by the corresponding time-frequency resource identifiers. The receiving device may perform measurements on the signaling and may transmit the measurements to an NE (e.g., a base station, a gNB, a configuration entity, and/or a sensing result computation entity).

In some examples, a UE in a wireless communications system may transmit a power headroom report to an NE that indicates a remaining transmit power for an uplink transmission relative to a maximum allowed transmit power at the UE (e.g., remaining transmit power budget per carrier layer and/or frequency layer). The NE may utilize the remaining transmit power information to determine a resource allocation and one or more transmit power control parameters for the UE to manage a battery life of the UE and schedule resources to maintain a reliable uplink transmission without exceeding power capabilities of the UE. However, a transmitting device (e.g., an NE, UE, or TRP, among other example devices) may not be configured to transmit a power headroom report indicating transmit power information for sensing transmissions and/or other communication unrelated to sensing performed by the transmitting device in a sensing mode of operation. A transmitting device not transmitting a power headroom report in a sensing mode of operation may lead to inefficient resource allocation and/or excessive power consumption at the transmitting device due to a transmit power at the transmitting device for various types of communications, including signaling related to the sensing operations, exceeding a transmit power capability of the transmitting device and/or failing to satisfy one or more transmit power criterion (e.g., regulatory requirements for transmit power).

As described herein, to improve resource allocation and power consumption at a device (e.g., a transmitting device or a receiving device, including a UE, an NE, and/or a TRP), the device may receive a request from another device (e.g., a UE, an NE, a TRP, a base station, a gNB, a configuration entity, and/or a sensing result computation entity) for a power headroom report that indicates a remaining transmit power for a transmission in a sensing mode of operation. The device may generate and transmit the power headroom report, which may enable the requesting device to improve resource allocation for sensing and communications related transmissions, adjust power control parameters, and coordinate sensing operations across multiple devices. The power headroom report may include, but is not limited to, remaining power budget for different signal types (e.g., signaling related to sensing and/or signaling that is not related to sensing), beam-specific power headroom values, or power limitations based on interference values. The power headroom report may be triggered by one or more conditions, such as periodically, upon expiration of one or more timers, a change in transmit power exceeding a threshold, initiation of a sensing operation, or upon receiving the request. In some cases, an NE or other device may configure the trigger conditions, such as in the request and/or in additional signaling (e.g., control signaling).

In some cases, a receiving device may have maximum power handing capabilities, such as for an analog-to-digital converter (ADC) and/or other radio frequency components of the receiving device. If an incoming signal exceeds the maximum power handling capabilities of the receiving device, then the signal may be distorted, degrading the signal quality and potentially introducing errors. For example, the receiving device may not detect one or more peaks of the signal (e.g., the peaks may be truncated), which is referred to as clipping of the signal. Additionally, or alternatively, a device may operate as both a receiving device and a transmitting device (e.g., in a monostatic sensing mode of operation). Transmitting operations at the device may cause interference to one or more receiving operations at the device, and vice versa. The interference may also impact signal quality and introduce errors into the transmitting and receiving operations.

As described herein, to improve signal quality and reduce errors for sensing operations, an NE (e.g., a base station, a gNB, a configuration entity, and/or a sensing result computation entity) may transmit signaling to a transmitting device and/or to a receiving device that indicates whether or not signaling in a sensing mode of operation includes AGC symbols and/or gap symbols, as well as information for generating the AGC symbols and/or the gap symbols. The transmitting device may transmit the AGC symbols at a predetermined power level to enable the receiving device to calibrate AGC circuitry before processing remaining time-frequency resources, including time-frequency resources allocated for the sensing mode of operation (e.g., one or more sensing transmissions). The gap symbols may be symbols that are muted (e.g., transmitted with zero power or not transmitted), creating time intervals that provide for the receiving device to adjust receiver settings or reduce interference from concurrent transmit and receive operations. The signaling from the NE may explicitly indicate the presence and configuration of AGC symbols and/or gap symbols, and may be single signal or multiple signals (e.g., one message or signal to indicate information related to the AGC symbols and one message or signal to indicate information related to the gap symbols). For example, the signaling may include a bitmap, where each bit corresponds to a symbol position within a TTI, with bit values indicating whether a symbol is an AGC symbol, a gap symbol, or a symbol in a sensing transmission. Additionally, or alternatively, the signaling may include dedicated fields that indicate a numerical quantity (e.g., number, amount) of AGC symbols, a position of the AGC symbols within a transmission, transmit power levels of the AGC symbols, a presence of gap symbols, a duration or numerical quantity of the gap symbols, or a position of the gap symbols. The signaling may also indicate timing relationships, such as an offset between AGC symbols and sensing transmissions, or a periodicity of gap symbols within a sensing transmission sequence. Based on the received configuration, the transmitting device may generate and transmit the sensing transmission and/or additional transmissions for data or control signaling, among other example communications that are not related to sensing, according to the indicated pattern. The transmitting device may transmit one or more AGC symbols at the beginning and/or end of a transmission burst using a configured power level, may include one or more gap symbols between symbols during which no transmission occurs, may transmit one or more symbols in a sensing transmission (e.g., sensing symbols), and/or may transmit one or more symbols in a communication transmission (e.g., communication symbols including control information or data).

By performing the described techniques, a device in a wireless communications system can achieve improved sensing performance and power efficiency across multiple operational scenarios. For example, configuring power control parameters for a sensing mode of operation enables consistent transmit power configurations across sensing transmissions for transmitting and receiving devices, reducing interference while maintaining a threshold signal quality for accurate sensing measurements. Further, requesting and/or configuring power headroom reporting for sensing operations provides for NEs to improve resource allocation and reduce or prevent power capability violations, thereby extending battery life of transmitting devices and ensuring reliable sensing transmissions. Explicitly configuring AGC symbols and gap symbols for a sensing mode of operation enables receiving devices to calibrate receiver circuitry and reduce or mitigate self-interference, resulting in improved signal quality and reduced measurement errors in a sensing mode of operation.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

Aspects of the present disclosure are described in the context of a wireless communications system. Aspects of the present disclosure are further set forth in the accompanying drawings and the description below. The description set forth herein, in connection with the accompanying drawings, describes example implementations and does not represent all the implementations that may be implemented or that are within the scope of the claims. The detailed description includes specific details for the purpose of providing an understanding of the described implementations. These implementations, however, may be practiced without these specific details. Additionally, the description set forth herein, in connection with the accompanying drawings is provided to enable a person having ordinary skill in the art to make or use the present disclosure. Various modifications to the disclosure will be apparent to a person having ordinary skill in the art, and the generic principles defined herein may be applied to other variations without departing from the scope of the present disclosure. Thus, the present disclosure is not limited to the examples and implementations described herein but is to be accorded the broadest scope consistent with the principles and novel features disclosed herein.

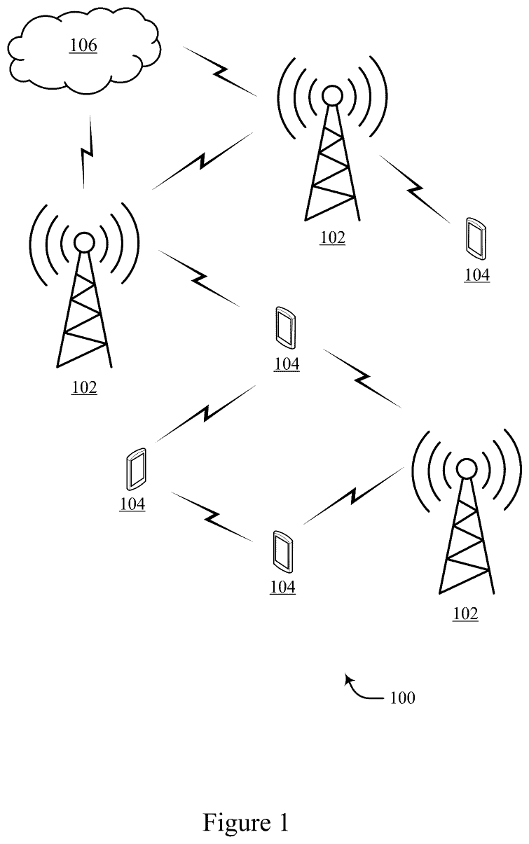

FIG. 1 illustrates an example of a wireless communications system 100 in accordance with aspects of the present disclosure. The wireless communications system 100 may include one or more NEs 102, one or more UEs 104, and a CN 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, an NE, network infrastructure (or infrastructure), a RAN, a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NEs 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NEs 102 may communicate with each other directly. In some other implementations, the NEs 102 may communicate with each other indirectly (e.g., via the CN 106). In some implementations, one or more NEs 102 may include subcomponents, such as an access NE, which may be an example of an access node controller (ANC). An ANC may communicate with the one or more UEs 104 through one or more other access network transmission entities, which may be referred to as radio heads, smart radio heads, or TRPs.

In some implementations, an NE 102 may be configured in a disaggregated architecture, which may be configured to utilize a protocol stack physically or logically distributed among two or more network entities, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, an NE 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a TRP. One or more components of the network entities in a disaggregated RAN architecture may be co-located, or one or more components of the network entities may be located in distributed locations (e.g., separate physical locations). In some implementations, one or more network entities of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaptation protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack, and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities that are in communication via such communication links.

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106. The CN 106 may support 5G wireless sensing (5GS), providing capabilities to obtain information about characteristics of an environment and/or objects within the environment (shape, size, speed, location, distances or relative motion between objects, etc.) using NR radio frequency signals and, optionally, previously defined information available in the EPC and/or evolved-universal terrestrial radio access (E-UTRA).

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 Gigahertz (GHz)), FR2 (24.25 GHz-52.6 GHz), FR3 (7.125 GHz-24.25 GHz), FR4 (52.6 GHz-114.25 GHz), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

One or more devices in the wireless communications system 100 (e.g., a UE 104, an NE 102, a base station, a gNB) may leverage signaling to gather information for detection, identification, and tracking of various targets in a wireless sensing operation or procedure. For example, the devices may process the signaling to obtain Doppler measurements, range measurements, and/or velocity measurements to detect and characterize motion of the targets, including deriving mobility or tracking information related to the targets. The devices in the wireless communications system 100 may implement the wireless sensing operation or procedure for various use cases, including, but not limited to, human or object detection (e.g., detecting a sensing target with a focus on frequencies from 0.5 to 52.6 GHz), weather or AGV monitoring and tracking, automotive sensing, and utilization of sensing and positioning information for V2X.

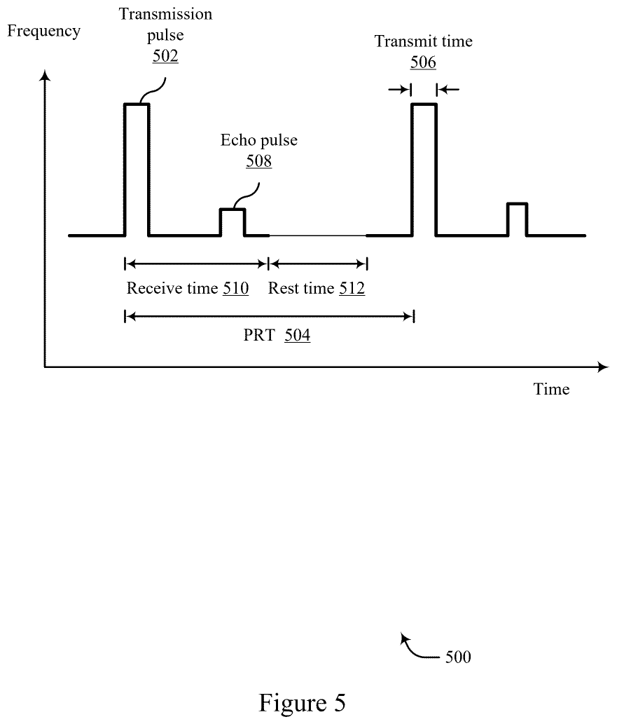

In some cases, the devices in the wireless communications system 100 may account for various performance criterion for the wireless sensing operation or procedure (accuracy, resolution, latency, etc.) based on one or more characteristics of one or more sensing targets (e.g., RCS) and/or an environment to be sensed in a target sensing service area. The devices in the wireless communications system 100 may support various sensing modes of operation involving different RAN entities (e.g., NEs 102, base stations, gNBs, and UEs 104) and/or CN entities (e.g., NEs 102 integrated with the CN 106 and/or that provide support for the CN 106). The sensing modes of operation may include, but are not limited to, a monostatic sensing mode of operation, a bistatic sensing mode of operation, a multi-static sensing mode of operation, and a common sensing mode of operation, which are described in further detail with respect to FIG. 5.

In some cases, depending on a type of sensing mode of operation, adaptation of a transmit power for signaling or transmission related to sensing may be beneficial for detection and/or tracking of the sensing targets and to reduce or prevent interference from different sources, which can in turn degrade the accuracy and/or quality of the sensing measurement. The signaling or transmission related to the sensing may also be referred to as sensing signaling, a sensing transmission, or signaling in a sensing mode of operation. The sensing signaling may include radio frequency signals transmitted by one or more devices, referred to as transmitting devices or sensing transmitters, to enable detection, identification, tracking, or characterization of sensing targets within the wireless communications system 100. The transmitting devices may include, but are not limited to, one or more NEs 102, TRPs, and/or UEs 104. The sensing signaling may include various types of reference signals, data, and/or control information configured for wireless sensing operations. For example, the transmitting device may transmit signaling to reflect off of sensing targets towards one or more devices, referred to as receiving devices or sensing receivers. The receiving devices may include, but are not limited to, one or more NEs 102, TRPs, and/or UEs 104 and can be located at a same or different entity or device as the transmitting device. The receiving devices may measure information about target characteristics, such as position, velocity, range, or RCS, and may provide the information to the transmitting device or an NE (e.g., a RAN entity and/or a CN entity).

In some cases, the sensing signaling may include one or more reference signals. The reference signals may include, but are not limited to, SeRSs for sensing, PRSs that may be used for both positioning and sensing applications, TRSs that may provide timing and frequency synchronization information for the wireless sensing operations, CSI-RSs that may be configured to measure channel conditions and interference levels relevant to the wireless sensing operations, DMRSs that may assist in demodulating sensing-related control information or data, PTRSs that may provide information to compensate for phase noise in sensing transmissions, SRSs that may enable uplink-based sensing measurements, and/or SSBs to provide timing and frequency reference for the wireless sensing operations. Additionally, or alternatively, the sensing signaling may include control signaling, such as configuration information for measurement reports and/or coordination messages related to the wireless sensing operations. Additionally, or alternatively, the sensing signaling may include data symbols that carry sensing-related information or measurements between devices participating in the wireless sensing operation.

In some cases, an energy per RE may be constant across a signal bandwidth and across reference signal symbols (e.g., OFDM symbols) within a reference signal occasion allocated for the sensing transmission. A transmitting device and/or a receiving device may improve a signal quality and accuracy of a sensing transmission by introducing a power offset (e.g., increasing a transmit power for sensing transmissions) and/or a muting pattern. A muting pattern may indicate one or more time-frequency resources in signaling that are intentionally transmitted with zero power or are not transmitted. The muting pattern may indicate one or more of REs, symbols, or other time intervals for which a transmit power is set to zero or reduced to a threshold value close to zero to create gaps in the transmitted signal. In some cases, a transmitting device may apply the muting pattern to enhance the detectability of reflected signals by reducing interference and improving a signal quality at receiving devices. However, the power offset may introduce additional interference at the transmitting device and/or at the receiving device (e.g., self-interference and/or inter-cell interference) and may increase a noise floor. The noise floor may refer to a level of background noise present in the wireless communications system 100, and increasing a transmit power may increase the noise floor by contributing additional signal components that impact sensing transmissions and receptions and may reduce overall sensitivity of the wireless communications system 100.

In some cases, an ability of devices to detect a sensing target may depend on various factors, such as a distance between a transmitting device and a sensing target (e.g., sensing transmitter-to-sensing target distance), a distance between the sensing target and a receiving device (e.g., sensing target-to-sensing receiver distance), sensing target RCS characteristics (e.g., how the sensing target reflects electromagnetic waves), background and target channel conditions, other sensing transmitters, and/or communication services. The RCS characteristics may include a physical size of the sensing target, where larger objects may have higher RCS values and are more easily detectable than smaller objects. Additionally, or alternatively, the RCS characteristics may include a shape and geometry of the sensing target, as objects with flat surfaces perpendicular to the transmitted signal may produce stronger reflections than curved or angled surfaces. Additionally, or alternatively, the RCS characteristics may include material properties of the sensing target, where metallic objects may provide stronger reflections compared to non-metallic materials, such as wood, plastic, or fabric. Additionally, or alternatively, the RCS characteristics may include an orientation of the sensing target relative to the transmitting and receiving devices, as a same target may present different RCS values when viewed from different angles. Additionally, or alternatively, the RCS characteristics may include a surface roughness of the sensing target, with smooth surfaces providing more specular reflection, while rough surfaces may cause more diffuse scattering. A frequency of the transmitted signal may influence the RCS characteristics, as the interaction between electromagnetic waves and the sensing target may vary across different frequency bands. The background and target channel conditions may refer to the propagation environment characteristics that impact signal transmission and reception, including multipath fading, shadowing effects, atmospheric attenuation, clutter from surrounding objects, and interference from other radio frequency sources, among other examples.

In some cases, one or more devices in the wireless communications system 100 may not have a defined configuration for adjusting a transmit power for signaling in a sensing mode of operation (e.g., sensing signaling and/or sensing transmissions), leading to inaccurate sensing measurements due to inconsistent or unknown variations in transmit power. Thus, the devices may enable a general and/or common transmit power adaptation according to time-frequency resources allocated via time-frequency resource information for a sensing mode of operation and according to different conditions to improve detectability of a reflected and/or backscattered signal. The devices may also implement the transmit power adaptation to reduce or prevent inter-site interference for monostatic, bistatic, and/or multi-static scenarios due to resource scheduling conflicts and link conditions using pathloss measured from one or more reference signals in the sensing mode of operation, which may have sensing-specific parameters different from pathloss measured from one or more reference signals that are for communications other than sensing.

Additionally, or alternatively, the devices in the wireless communications system 100 may not have a defined power budget management and headroom reporting. An NE 102 may be unaware of a transmit power budget between data and/or reference signal transmissions dedicated to communication on one or more channels, sensing transmissions on one or more channels, or both communication and sensing transmissions on one or more channels. In some examples, the NE 102 may request a power headroom report from one or more devices in the wireless communications system 100 that are in a sensing mode of operation. The NE 102 may also indicate one or more trigger conditions for transmitting the power headroom report.

Additionally, or alternatively, the devices (e.g., receiving devices) in the wireless communications system 100 may experience clipping of signaling due to signal power levels exceeding a range of receiver components at a receiving device. Clipping of signaling may refer to a distortion that occurs when an input signal amplitude exceeds a maximum handling capability of an ADC or other radio frequency components of a receiving device. Clipping may occur when reflected signals from sensing targets arrive at a receiving device with power levels that exceed the maximum handling capability, causing the signal peaks to be truncated. The truncation may result in loss of signal information and may introduce harmonic distortion, which can degrade the quality of sensing measurements and reduce the accuracy of target detection, ranging, and velocity estimation. In the wireless sensing operations, a range of received signals can vary based on sensing target distance, RCS characteristics, and multipath propagation effects. Further, in monostatic sensing scenarios where a device operates as both a transmitter and a receiver, self-interference from the transmitted signal may contribute to clipping by elevating the overall received power level. Clipping may also occur if there are multiple sensing transmissions concurrently, creating interference patterns that push a received signal power beyond an operating range of receiver components at the receiving device.

The devices may implement AGC symbols, gap symbols, and/or a guard period to provide isolation between various wireless sensing operations. A guard period is a time interval with zero transmission power that may span one or more gap symbols and provides temporal isolation between different transmission types, sensing transmissions from multiple devices, or transmit and receive modes in monostatic sensing scenarios to reduce interference and enable switching between operations. A receiving device and/or a transmitting device may receive and implement configuration information that indicates various configurations for generating and/or receiving AGC symbols, gap symbols, and/or a guard period depending on whether wireless sensing operations are performed or wireless sensing and other communication operations are performed within a TTI. The configuration information can include, but is not limited to, AGC generation rules including how many AGC symbols to include and how to realize an AGC symbol, dynamic indications of the presence of a gap symbols and/or a number of gap symbols, time-frequency location information of the AGC symbols and/or gap symbols, and/or a flag to implicitly indicate where to place the AGC symbols and/or gap symbols based on the sensing time-frequency resource allocation (e.g., no explicit indications of where to place the AGC symbols and/or gap symbols). In some cases, the configuration information may be defined (e.g., configured, preconfigured, hard coded) at a transmitting device, a receiving device, and/or a transmitting and receiving device, such that the device may generate or apply the AGC symbols and/or gap symbols without an explicit indication of the configuration information, such as upon receiving a time-frequency resource in a sensing mode of operation.

Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

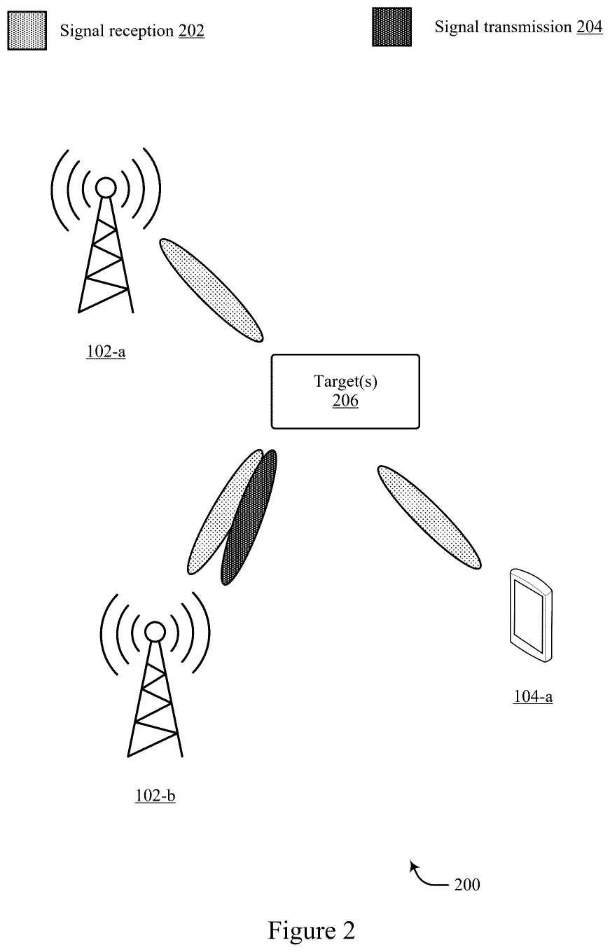

FIG. 2 illustrates an example of a wireless communications system 200 in accordance with aspects of the present disclosure. In some examples, the wireless communications system 200 implements or is implemented by aspects of the wireless communications system 100. For example, the wireless communications system 200 may include an NE 102-a, an NE 102-b, and a UE 104-a, which may be examples of the corresponding devices as described with reference to FIG. 1. The NE 102-a, the NE 102-b, and the UE 104-a may exchange (e.g., output, transmit, receive, communicate) signaling, including control signaling and/or data. For example, the NE 102-a, the NE 102-b, and the UE 104-a may perform signal reception 202, while an NE 102-b may perform signal transmission 204. In some cases, the NE 102-a, the NE 102-b, and the UE 104-a may perform wireless sensing.

In some cases, the NE 102-a, the NE 102-b, and the UE 104-a may use signals (e.g., reference signals, data signals, or other radio frequency signals) to detect, locate, and track objects or targets 206 within an environment of the wireless communications system 200, which is referred to as wireless sensing or radio sensing. The NE 102-a, the NE 102-b, and the UE 104-a may perform wireless sensing operations by transmitting and receiving wireless signals that interact with (e.g., collide with, are directed toward) one or more targets 206. A target, or sensing target, refer to an object or human that is to be detected and/or tracked. The target may vary according to type, size, and characteristic (e.g., human, unmanned aerial vehicle (UAV), vehicle, AGV, UE, animal, hazardous objects, safety hazards, and so forth). In some cases, a UE may be embedded within or part of a target 206, such as a UAV, vehicle, or human. A target may be stationary or in motion and may be located within the wireless communications system 200. The NE 102-b may perform signal transmission 204, such as by transmitting control signaling or data towards the targets 206. The signals may reflect off the targets 206 towards the NE 102-a, the NE 102-b, and/or the UE 104-a. The NE 102-a, the NE 102-b, and/or the UE 104-a may receive (e.g., capture) the reflected signal and analyze the reflected signal to extract information about a position, movement, or other characteristics of the targets 206.

Wireless sensing includes a variety of scenarios, where the network may configure participating devices (one or more UEs, NEs, base stations, gNBs, TRPs, etc.) to enable sensing functionality. The network may configure network and UE entities, nodes, and/or devices to act as sensing transmitting devices and sensing receiving devices. Additionally, or alternatively, the network may configure the devices to perform sensing signaling (e.g., reference signals) and one or more measurements on received sensing signaling. Additionally, or alternatively, the network may configure reporting procedures to provide associated sensing results to the network, where the sensing results include information derived from processing sensing measurement data. The sensing measurement data includes data collected from radio or wireless signals impacted (e.g., reflected, refracted, diffracted) by an object or environment of interest for sensing purposes. The functional split between the network and UE entities, nodes, and/or devices for a defined sensing task may take various forms, depending on the availability of sensing-capable devices and the criterion of the sensing operation.

The wireless communications system 200 may implement various sensing scenarios. In some cases, the sensing scenarios may include sensing transmitting and sensing receiving at separate devices, where the sensing signaling (e.g., a reference signal used for sensing and/or data or control channels known to the network TRP nodes) is transmitted and received by different devices. Additionally, or alternatively, the sensing scenarios may include sensing transmitting and sensing receiving as a same device, where the sensing signaling is transmitted and received by the same device. Additionally, or alternatively, the sensing scenarios may include sensing transmitting at a first type of device (e.g., an NE) and sensing receiving at a second type of device (e.g., a UE), where the sensing signaling is transmitted by a RAN entity or device and received by one or more UEs. Additionally, or alternatively, the sensing scenarios may include sensing transmitting at a UE and sensing receiving at a RAN node (e.g., an NE or TRP), where sensing signaling is received by one or more NEs and transmitted by a UE. Additionally, or alternatively, the sensing scenarios may include sensing transmitting at a UE and sensing receiving at a different UE, where the sensing signaling is received by one or more UEs and transmitted by a single UE. Additionally, or alternatively, the sensing scenarios may include sensing transmitting and sensing receiving at a same UE.

In some cases, the NE 102-a, the NE 102-b, and/or the UE 104-a may perform wireless sensing for one or more use cases, including, but not limited to, human or object detection, weather or AGV monitoring and tracking, or automotive sensing and exploitation of sensing and positioning information. For example, the NE 102-a, the NE 102-b, and/or the UE 104-a may perform wireless sensing for indoor positioning and navigation, where the system may detect and track the movement of targets 206 (people, objects, devices, etc.) within a building or enclosed space for crowd management, asset tracking, emergency response, or other applications. In some other cases, the NE 102-a, the NE 102-b, and/or the UE 104-a may perform wireless sensing for vehicular applications, such as detecting and tracking vehicles on a road, pedestrians, or obstacles to enhance road safety and support autonomous driving systems. Additionally, or alternatively, the NE 102-a, the NE 102-b, and/or the UE 104-a may perform wireless sensing in industrial settings for monitoring machinery, detecting unauthorized access to restricted areas, or ensuring worker safety in hazardous environments. Different sensing applications may have different performance criteria for sensing results (accuracy, resolution, latency, etc.), which may depend on characteristics of targets 206 and/or the environment to be sensed in a target sensing service area. A sensing service area is a geographic location within which one or more devices can provide sensing services that satisfy a threshold quality (e.g., with or without obstacles). The targets 206 may be stationary (e.g., without motion) or dynamic (e.g., exhibiting movement of various velocities or speeds). The targets may be categorized into a first category including device-free and/or passive targets and a second category including device-based and/or active targets. Device-free and/or passive targets include an object not associated with the wireless communications system 200. Device-based and/or active targets are a human and/or object at or embedded within a device (e.g., a human holding a UE, UE embedded within a UAV, UE within automotive vehicles).

In some cases, a network may configure one or more participating devices, including, but not limited to, TRPs, NEs, UEs, sensing management components (SMCs), or positioning reference units (PRUs), or CN entities, to enable sensing functionality. For example, the network may allocate one or more devices as transmitting devices (e.g., entities, nodes) for wireless sensing and one or more devices as receiving devices for wireless sensing. In the wireless communications system 200 the network may configure the NE 102-a, the NE 102-b, and the UE 104-a as receiving devices and the NE 102-b as a transmitting device. The network may also configure signaling for the wireless sensing (e.g., reference signals, including SeRSs, PRSs, TRSs, CSI-RSs, DMRSs, PTRSs, SRSs, SSBs, control signaling, and/or data symbols, among other examples), measurements performed on the received signaling, and reporting procedures to provide results of the wireless sensing (e.g., sensing information). That is, the functional split between the devices in the wireless communications system 200 for a sensing task (e.g., operation) may take various forms, depending on the availability of the devices and the criteria of the sensing task. The network selects and/or configures the devices to act as transmitting devices (e.g., sensing transmitting nodes) and/or receiving devices (e.g., sensing receiving nodes) according to device capabilities for sensing, as well as with respect to a defined sensing task.

In some cases, the transmitting device and the receiving device may be separate RAN nodes, such as the NE 102-a and the NE 102-b. Thus, signaling for wireless sensing (e.g., an SeRS, another reference signal used for sensing, or data and control channels known to the NE 102-a and the NE 102-b) is transmitted and received by different NEs. Additionally, or alternatively, the transmitting device and the receiving device may be a same radio RAN node (e.g., the NE 102-b may perform signal transmission 204 and signal reception 202). Thus, the signaling for wireless sensing is transmitted and received by a same NE. Additionally, or alternatively, an NE 102-b may be a transmitting device, and a UE 104-a may be a receiving device. The NE 102-b may perform signal transmission 204 and one or more UEs including the UE 104-a may perform signal reception 202 of the signaling transmitted by the NE 102-b. A NE (e.g., the NE 102-a or the NE 102-b) may select and/or configure the UEs to be receiving devices based on factors, such as UE capabilities for sensing and a sensing task.

The transmitting and receiving devices may be any combination or numerical quantity of NEs or UEs. The UE 104-a may be any UE type and may include any UE category. The tasks described as being performed by an NE may additionally, or alternatively, be performed by a UE or RAN node (e.g., a smart repeater node, an IAB node, a roadside unit (RSU), or any other RAN node). The tasks described as being performed by a UE may additionally, or alternatively, be performed by an NE or a RAN node. In some examples, one or more transmitting devices and/or one or more receiving devices of a sensing measurement process include one or more of a TRP associated to a gNB-CU or DU, a gNB-DU, a gNB-CU, a UE, an IAB node, an RSU, or a dedicated sensing radio. In some examples, a receiving device may be a sensor (e.g., for wireless communications or not related to wireless communications) with a capability to provide sensing data, or a device (e.g., a UE or a RAN node) connected to the sensor that can obtain, process, and transfer the sensing data of the sensor to other devices in the wireless communications system 200 (e.g., any type of data, including data that is related to wireless communications or data that is not related to wireless communications).

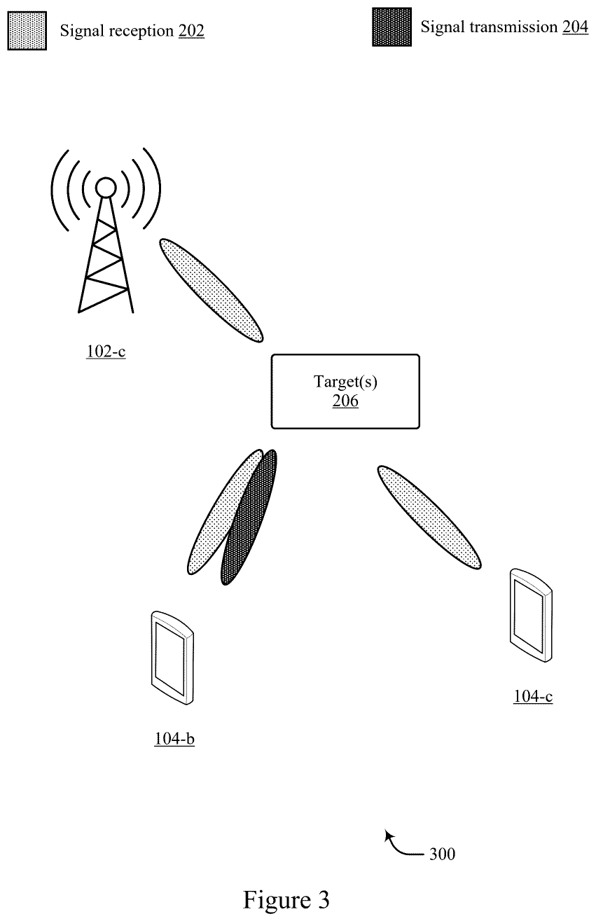

FIG. 3 illustrates an example of a wireless communications system 300 in accordance with aspects of the present disclosure. In some examples, the wireless communications system 300 implements or is implemented by aspects of the wireless communications system 100 and the wireless communications system 200. For example, the wireless communications system 300 may include an NE 102-c, a UE 104-b, a UE 104-c, one or more targets 206, signal reception 202, and signal transmission 204, which may be examples of the corresponding devices and actions as described with reference to FIGS. 1 and 2. The NE 102-c, the UE 104-b, and the UE 104-c may exchange (e.g., output, transmit, receive, communicate) signaling, including control signaling and/or data, as part of a wireless sensing procedure. For example, the NE 102-c, the UE 104-b, and the UE 104-c may perform signal reception 202, while a UE 104-b may perform signal transmission 204.

The NE 102-c, the UE 104-b, and the UE 104-c may be examples of receiving devices for wireless sensing, and the UE 104-b may be an example of a transmitting device for wireless sensing, as described with reference to FIG. 2. For example, the transmitting device for wireless sensing may be a UE 104-b, and a receiving device for the wireless sensing may be an NE 102-c or other RAN node. Thus, one or more NEs receive the signaling for the wireless sensing (e.g., SeRS, other reference signal, or a data and control channel transmitted by the UE 104-b) transmitted by the UE 104-b. The network selects and/or configures the UE 104-b to act as a transmitting device according to capabilities of the UE 104-b for sensing, as well as the sensing task. Additionally, or alternatively, the transmitting device is the UE 104-b, and the receiving device is a UE 104-c. Thus, a UE 104-b transmits the signaling for the wireless sensing, and one or more UEs including the UE 104-c receive the signaling. The network or a UE may determine the selection and/or configuration of the wireless sensing. For example, the network and/or a UE selects and/or configures the UEs to act as a transmitting devices and/or receiving devices according to the UE capabilities for sensing, as well as the sensing task. Additionally, or alternatively, the transmitting device and the receiving device may be a same UE (e.g., the UE 104-b). That is, the signaling for wireless sensing is transmitted and received by the UE 104-b. The UE or the network may select and/or configure the wireless sensing according to capabilities of the UE 104-b for sensing, as well as sensing task.

The transmitting and receiving devices may be any combination or numerical quantity of NEs or UEs. The UE 104-b and the UE 104-c may be any UE type and may include any UE category. The tasks described as being performed by an NE may additionally, or alternatively, be performed by a UE or RAN node (e.g., a smart repeater node, an IAB node, a roadside unit (RSU), or any other RAN node). The tasks described as being performed by a UE may additionally, or alternatively, be performed by an NE or a RAN node. In some examples, one or more transmitting devices and/or one or more receiving devices of a sensing measurement process include one or more of a TRP associated to a gNB-CU or DU, a gNB-DU, a gNB-CU, a UE, an NCR, an IAB node, an RSU, or a dedicated sensing radio. In some examples, a receiving device may be a sensor (e.g., for wireless communications or not related to wireless communications) with a capability to provide sensing data, or a device (e.g., a UE or a RAN node) connected to the sensor that can obtain, process, and transfer the sensing data of the sensor to other devices in the wireless communications system 300.

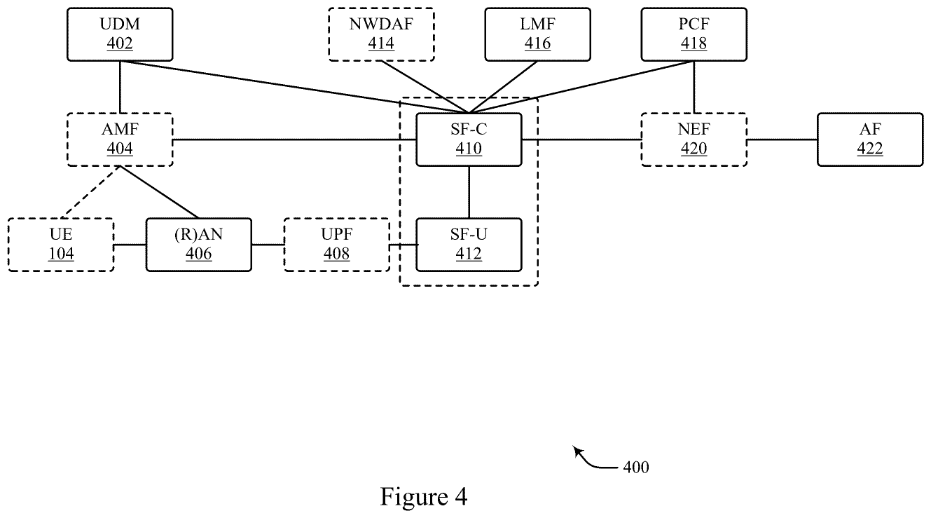

FIG. 4 illustrates an example network architecture diagram 400 in accordance with aspects of the present disclosure. In some examples, the network architecture diagram 400 implements or is implemented by aspects of the wireless communications system 100, the wireless communications system 200, and the wireless communications system 300. For example, the network architecture diagram 400 may implement or be implemented by one or more NEs and UEs, which may be examples of the corresponding devices and actions as described with reference to FIGS. 1 through 3.

The network architecture diagram 400 may be an example of a 5G core architecture that integrates sensing and communication by introducing a new sensing function. The sensing function may be included via various architectures, including a tight coupling integrated sensing and communication network architecture, a tight coupling integrated sensing and communication network architecture with control plane and user plane split, a sensing function collocated with a location and management function (LMF), and/or a loose coupling integrated sensing and communication network architecture. The network architecture diagram 400 may include a unified data management (UDM) 402, which manages subscriber data and profiles. The UDM 402 may be connected to an access and mobility management function (AMF) 404 via an interface for subscriber data management and authentication procedures. The AMF 404 may perform access control and mobility management. An access network (AN) or radio AN (RAN) 406 may provide a wireless interface between devices and the CN. For example, an interface may connect the RAN 406 to the AMF 404 and may carry signaling related to radio resource management, mobility, and handover procedures. In some cases, the network architecture diagram 400 may include a user plane function (UPF) 408 to perform user data routing and forwarding. An interface between the RAN 406 and the UPF 408 may carry user plane data between the two entities.

For sensing operations, the network architecture diagram 400 may include one or more sensing entities. For example, the network architecture diagram 400 may include a sensing function control (SF-C) 410 that manages sensing tasks and a sensing function user plane (SF-U) 412 that processes sensing data. The SF-C 410 may be a dedicated network function handling the sensing control plane, such as the interaction with the sensing consumer via a network exposure function (NEF) and information exchange with other network functions for gathering UE information (e.g., from the AMF 404, UDM 402, and/or an LMF, UE related policies from a policy control function (PCF), and/or analytics from a network data analytics function (NWDAF)). The SF-C 410 may also handle sensing radio signals for performing an analysis or prediction for determining a sensing target. In a tight coupling integrated sensing and communication network architecture with control plane and user plane split, the sensing function has two dedicated network function counterparts, including the SF-C 410 that handles the control plane aspects and the SF-U 412 that is responsible for collecting the sensing radio signals via the user plane (e.g., via the RAN and UPF). The tight coupling integrated sensing and communication network architecture splits and offloads relatively heavy data volumes (e.g., greater than a threshold) associated with sensing radio signals to the user plane to ensure relatively light traffic (e.g., communications other than sensing signaling) in the control plane. Additionally, or alternatively, the functions performed by the SF-C 410 and the SF-U 412 may be performed by a single sensing entity.

In some examples, the network architecture diagram 400 includes a NWDAF 414 to provide data analytics capabilities to the SF-C 410. Additionally, or alternatively, the SF-C 410 may implement an LMF 416 to determine device locations, where the sensing function appears as a logical network function embedded in the LMF to perform sensing (e.g., taking advantage of the knowledge of a UE location). The network architecture diagram 400 may also include a PCF 418 to define and enforce network policies, an NEF 420 to expose network capabilities to external applications, and an application function (AF) 422 to represent external applications that utilize network services. In a loose coupling integrated sensing and communication network architecture, the sensing function is independent of the 5G core, such as for local field scenarios or private networks, and the interaction with the 5G core is minimal (e.g., less than a threshold). The loose coupling integrated sensing and communication network architecture utilizes an sensing function close to a RAN (e.g., to collect and process the sensing radio signals locally), and interacts with the 5G core for the purpose of exposure via an NEF, for getting a UE location from the AMF and for analytics (e.g., by the NWDAF). In some cases, the entities in the network architecture diagram 400 communicate via interfaces connecting the entities to enable integrated communication and sensing capabilities for devices in a wireless communications system (e.g., the wireless communications system 100 through the wireless communications system 300).

In some cases, the entities in the network architecture diagram 400 may be arranged in a hierarchical structure, with the SF-C 410 serving as a central node connecting multiple other entities in the network architecture diagram 400. The UDM 402, the NWDAF 414, the LMF 416, and the PCF 418 may be directly connected to the SF-C 410, enabling data exchange and control flow between the UDM 402, the NWDAF 414, the LMF 416, and the PCF 418 and a sensing function. The AMF 404 may be connected to both the UDM 402 and the RAN 406, which may provide for management of access and mobility between the CN and RAN 406. The UPF 408 may be connected to both the RAN 406 and the SF-U 412 to manage user plane data for both communication and sensing functions.

In some cases, the sensing function (e.g., the SF-C 410 and/or the SF-U 412) may be a dedicated network function to handle sensing control plane procedures and sensing radio signals for performing analysis or prediction for determining targets. The control plane procedures can include, but is not limited to, interaction with a sensing consumer via an NEF 420 and information exchange with other network functions for gathering UE information, (e.g., from the AMF 404, UDM 402, LMF 416, UE related policies from the PCF 418, and analytics from the NWDAF 414). In some other cases, the sensing function may include two dedicated network functions, including the SF-C 410 and the SF-U 412. The SF-C 410 handles control plane procedures, while the SF-U 412 is responsible for collecting the sensing radio signals via the user plane (e.g., via the RAN 406 and UPF 408). Thus, the SF-C 410 and the SF-U 412 route (e.g., divide, split, offload) data volumes associated with sensing radio signals to the user plane to enable relatively lighter data traffic (e.g., singling) in the control plane. In some cases, the sensing function may be collocated with the LMF 416, such that the sensing function is a logical network function embedded in the LMF 416 that performs wireless sensing using UE location information. In some other cases, the sensing function is independent of the 5G core (e.g., for local field scenarios or private networks). The sensing function may be close to the RAN 406 to collect and process the sensing radio signals locally and may interact with the 5G core for the purpose of exposure via an NEF 420 for sending the UE location from the AMF 404 and for analytics at the NWDAF 414.

In some examples, a sensing controller function (SensMF) includes one or more of a UE, a RAN node, a gNB or gNB-CU, an LMF, a sensing function, or any combination thereof, The SensMF may receive a request for sensing information from a service consumer (e.g., a requesting third party application). Additionally, or alternatively, the SensMF may determine a selection and/or a configuration of a sensing operation, including a configuration of one or more of a transmitting device and/or receiving device. Additionally, or alternatively, the SensMF may select and/or configure the involved devices (e.g., nodes) for sensing transmission, sensing reception, sensing measurement, and reporting of the conducted measurements. Additionally, or alternatively, the SensMF may collect the sensing measurements. Additionally, or alternatively, the SensMF may perform, configure, or request computation of the sensing measurements and determine the sensing information based on the obtained sensing measurements. Additionally, or alternatively, the SensMF may report (e.g., expose) obtained sensing information to the entity requesting the sensing information.

In some examples, if the SensMF includes multiple nodes (e.g., entities), then one or more of processes for sensing may be implemented by a node of the SensMF and one or more different processes may be implemented by additional nodes of the SensMF (e.g., implemented in the sensing function and an NE). In some examples, if the SensMF includes multiple nodes, then the communication among the SensMF nodes is implicit to wireless sensing. In some examples, if a SensMF includes a sensing function and an NE, such as a gNB (e.g., serving or head gNB of a related UE to the sensing task or a selected serving gNB for a sensing task), then the sensing function receives the request, collects the sensing measurements, performs, configures, or requests computation of the sensing measurements, and reports the sensing information. The gNB node determines the selection and/or configuration of the sensing operation and selects and/or configures the involved devices for sensing transmission and sensing reception. In some other examples, the sensing function and gNB jointly determine selection and/or configuration of the sensing operation and collect the sensing measurements, where a first part of the configuration or determination is performed by the sensing function and a second part of the configuration or determination is performed by the gNB. The SensMF may be a RAN node (e.g., a selected gNB acting as a serving gNB for a sensing task), a sensing function residing in a CN, a UE, or any combination thereof.

FIG. 5 illustrates an example transmission diagram 500 in accordance with aspects of the present disclosure. In some examples, the transmission diagram 500 implements or is implemented by aspects of the wireless communications system 100, the wireless communications system 200, the wireless communications system 300, and the network architecture diagram 400. For example, the transmission diagram 500 may implement or be implemented by one or more NEs and UEs, which may be examples of the corresponding devices and actions as described with reference to FIGS. 1 through 3.

One or more devices (e.g., UEs and/or NEs) may transmit signaling according to the transmission diagram 500. For example, the devices may transmit the signaling using communication resources, which may include resources in the time domain and resources in the frequency domain. The signaling may include one or more reference signals or other control signaling and/or data transmissions. A waveform refers to a shape and characteristics of a signal used to transmit information or detect targets. Example waveforms include, but are not limited to, a continuous wave (CW), a simple sinusoidal signal used in basic radar systems, a frequency modulated continuous wave (FMCW), where the frequency changes over time (e.g., often used in automotive radar), and OFDM, among others. In some cases, communication and radar technologies are deployed as separate (e.g., independent systems) with a separate waveform. However, there are use cases, such as the automotive, smart factory, medical monitoring, etc., where joint radio communications and radar sensing using the same waveform are considered beneficial for efficient usage of the radio frequency spectrum, as well usage of the same hardware to perform high data rate communications and precise ranging. Radar systems can be classified into the one or more categories. The categories include monostatic radar, bistatic radar, and multistatic radar. A monostatic radar system is a radar system in which the transmitter and receiver are collocated. A bistatic radar system is a radar system that includes a transmitter and receiver that are separated by a distance comparable to the expected target distance. A multistatic radar system is a radar system that includes multiple spatially diverse monostatic radar or bistatic radar components within an overlapping coverage area.

Radar signals are characterized by a transmission pulse 502 that is modulated onto a radio frequency carrier and is used to detect one or more targets that can be resolved in the time domain. For example, for a single reflector, a transmission pulse 502 with a measured round-trip time, t, provides the range, R, with respect to a target, which is calculated according to Equation 1:

$$R = \frac{ct}{2} \qquad ( 1 )$$

A range resolution, ΔR, is calculated according to Equation 2:

$$Δ R = \frac{c τ}{2} , \qquad ( 2 )$$

where τ is the pulse width and c is the speed of light. The radar pulses may be transmitted periodically, such that range information can be provided in real time. For example, a device may transmit a transmission pulse 502 according to a pulse repetition time (PRT) 504, which may also be referred to as a pulse repetition period (PRP). The transmission pulse 502 may span a transmit time 506. A receiving device may monitor for the transmission pulse 502 and a corresponding echo pulse 508 during a receive time 510. A device may wait for a returning echo signal during a rest time 512.

In some examples, a device may perform one or more measurements on a signal received in a sensing mode of operation. For example, the measurements may include, but are not limited to an SNR, an SINR, an SSNR, an SSINR, an RSRP, an RSRPP, a Doppler-delay path profile, a range-Doppler profile, or an angle-delay profile. An SNR may represent a ratio of signal power to noise power in the received sensing signal, which may indicate the quality of the sensing transmission relative to background noise. An SINR may represent a ratio of signal power to the combined interference and noise power, which may provide an indication of sensing signal quality in the presence of interference from other transmissions. An SSNR may represent a sensing-specific SNR that accounts for characteristics unique to sensing operations, such as target reflection properties and sensing waveform characteristics. An SSINR may represent a sensing-specific SINR that considers interference effects to various sensing scenarios, including inter-sensing interference and self-interference in monostatic configurations. An RSRP may represent the received power of a reference signal used for sensing operations, which may provide information about signal strength and propagation characteristics between transmitting and receiving devices. An RSRPP may represent the received power of a specific path component in a multipath sensing environment, which may enable identification and characterization of individual reflection paths from sensing targets. A Doppler-delay path profile may represent the distribution of signal energy across different delay and Doppler frequency bins, which may enable detection and characterization of moving targets and corresponding velocities. A range-Doppler profile may represent a two-dimensional representation of target reflections as a function of range and velocity, which may provide information about target distance and motion characteristics. An angle-delay profile may represent the distribution of signal energy across different arrival angles and time delays, which may enable determination of target direction and distance relative to the receiving device.

An SMF and/or sensing function manages the overall coordination and scheduling of resources for the sensing of one or more targets (e.g., an object and/or human). The SMF and/or sensing function also calculates or verifies a final sensing result and/or any velocity or Doppler estimates and may estimate the achieved sensing accuracy or sensing quality of service (QoS). The sensing QoS and/or key performance indicators (KPIs) may include confidence interval, positioning accuracy, velocity estimate accuracy, sensing resolution, in terms of range and/or velocity resolution, sensing service latency, or probability of missed detection and probability of false alarm. The SMF and/or sensing function receives sensing requests for a target within a network area by a sensing client, which may be external or internal to a network or device, respectively. The SMF interacts with the various NEs and UEs in order to exchange location information applicable to UE assisted and UE based sensing methods and interacts with the NG-RAN to obtain sensing information. This is an example of a sensing result computation entity. An SMC includes all or part of the SMF or sensing function. The SMC may reside at the NG-RAN and may be another example of a sensing result computation entity.

In some examples, devices may implement systematic procedures to determine or adapt a transmit power in a sensing and/or communication environment. The procedures may cover different use cases and scenarios in which sensing of one or more targets may be performed depending on the wireless communication entity (e.g., node, device) configuring one or more reference signals for sensing and/or communication purposes, the wireless communication entity transmitting the reference signal (e.g., the transmitting device), the wireless communication entity receiving the reference signals and performing the measurement of the received reference signal (e.g., the receiving device), the wireless communication entity computing and/or determining the relevant sensing or radar metrics. Various combinations of wireless communication entities or nodes may be configured to perform the described tasks depending on the sensing scenarios, as illustrated in Table 1.

TABLE 1
Sensing Scenarios

| | Sensing | |
|---|---|---|
| Scenario | Type | Description |
| TRP-TRP | Monostatic | A TRP of a gNB acts as a transmitting device while a same TRP acts |
| | | as a receiving device. Also includes a quasi-monostatic case, where a |
| | | different TRP of a same gNB may act as a receiving device, in which |
| | | half-duplex operations are supported. |
| UE-UE | Monostatic | A UE may act as a transmitting device while the same UE acts as |
| | | receiving device. |
| TRP-TRP | Bistatic | A TRP of a gNB acts as a transmitting device while another TRP from |
| | | a different and/or a neighboring gNB acts as a receiving device. |
| UE-UE | Bistatic | A UE acts as a transmitting device while another UE acts as a |
| | | receiving device. |
| TRP-UE | Bistatic | A TRP of a gNB acts as a transmitting device while a UE acts as a |
| | | receiving device. This UE may be served by the same gNB acting as a |
| | | transmitting device or different gNB. |
| UE-TRP | Bistatic | A UE acts as a transmitting device while a UE acts as a receiving |
| | | device. This UE may be served by the same gNB acting as a |
| | | transmitting device or different gNB. |

Additionally, or alternatively, the one or more targets may be categorized into a first category including device-free and/or passive targets and a second category including device-based and/or active targets. Device-free and/or passive targets include an object not associated with a wireless communications system. Device-based and/or active targets are a human and/or object embedded with a device (e.g., a human holding a UE, UE embedded within a UAV, UE within automotive vehicles).

In some cases, one or more devices (e.g., transmitting device and/or receiving devices) may operate under various assumptions regarding mobility characteristics of transmitting device, receiving devices, and sensing targets. The assumptions may impact one or more power control mechanisms and procedures implemented for sensing operations. For example, in scenarios where transmitting devices and receiving devices are stationary and the sensing target is moving relative to the transmitting devices and receiving devices (e.g., in TRP-TRP monostatic or TRP-TRP bistatic configurations), the power control may be adapted based on the relative motion of the sensing target. In some other scenarios, both transmitting devices and receiving devices may be mobile and the sensing target may also move relative to the transmitting devices and receiving devices (e.g., UE-UE monostatic or UE-UE bistatic configurations). The mobility pattern may result in implementation of fine-tuned or granular continuous power control to reduce interference, while ensuring accurate detection and tracking, as the relative positions and channel conditions between the transmitting device, receiving device, and sensing target may change dynamically. Additionally, or alternatively, scenarios where either the transmitting device or receiving device is stationary while the other node is mobile, and the sensing target is moving relative to both (e.g., in TRP-UE bistatic or UE-TRP bistatic configurations), may also result in implementation of adaptive power control mechanisms to account for the changing propagation characteristics and interference conditions.

The power control schemes described herein may be configured in a common manner across different sensing scenarios or may be based on defined sensing techniques. The power control schemes may be broadly divided into two categories. The first category includes open loop sensing power control mechanisms, and may operate without feedback from the receiving device. The devices may not implement open loop sensing power control mechanisms for monostatic cases, as the co-located transmitting device and receiving device may reside at a same entity or node (e.g., a base station or UE) and may adapt the power of the reference signal used for sensing. The devices may apply the open loop sensing power control mechanisms to bistatic or multistatic scenarios, where the transmitting device and receiving device are spatially separated. The second category includes closed loop sensing power control mechanisms, and may utilize feedback information from the receiving device to continuously or discretely improve (e.g., adjust, update) the power allocation for detection and tracking. The dynamic adaptations may be based on background and target channel conditions, interference levels, and sensing target characteristics (e.g., RCS). Closed loop mechanisms may enable more precise power control by incorporating real-time measurements and feedback from the receiving device to adjust transmit power levels according to changing environmental conditions and sensing criterion (e.g., requirements).

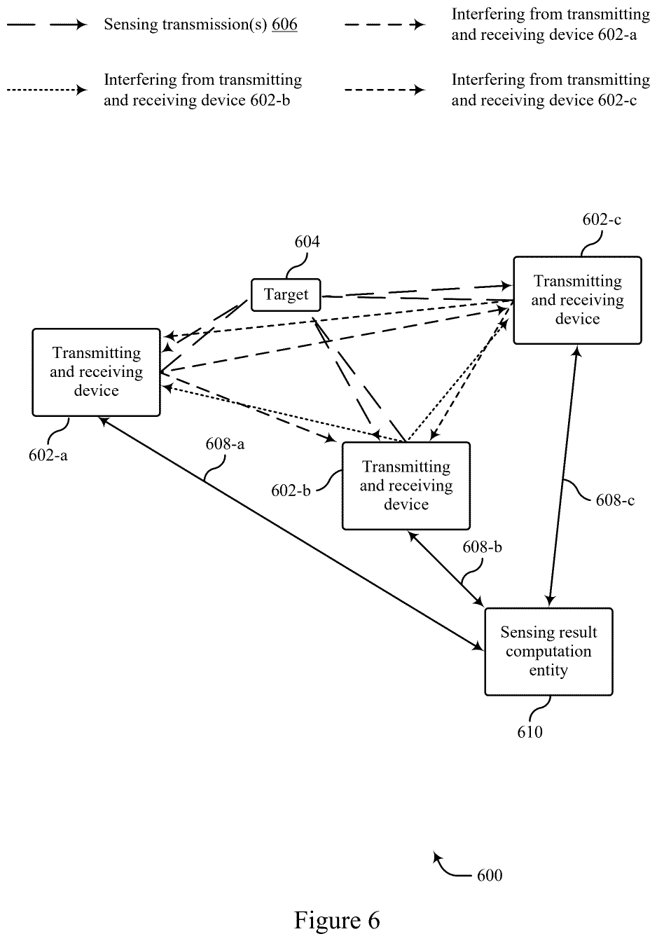

FIG. 6 illustrates an example of a wireless communications system 600 in accordance with aspects of the present disclosure. In some examples, the wireless communications system 600 implements or is implemented by aspects of the wireless communications system 100, the wireless communications system 200, the wireless communications system 300, the network architecture diagram 400, and the transmission diagram 500. For example, the wireless communications system 600 may include a transmitting and receiving device 602-a, a transmitting and receiving device 602-b, and a transmitting and receiving device 602-c, which may be examples of one or more NEs and UEs, as described with reference to FIGS. 1 through 5. For example, the transmitting and receiving device 602-a, the transmitting and receiving device 602-b, and/or the transmitting and receiving device 602-c may be examples of UEs and/or NEs (e.g., base stations, gNBs, TRPs, or other NEs) that are capable of both transmitting and receiving signaling in a monostatic sensing mode of operation.

The signaling may be directed towards a target 604 (e.g., a sensing target), and may be an example of one or more sensing transmissions 606. The sensing transmissions 606 may include any numerical quantity of transmissions. A sensing transmission 606 may include, but is not limited to, a reference signal transmission, a data transmission, and/or a control information transmission (e.g., control signaling) that is part of or related to a sensing mode of operation to detect the target 604. The wireless communications system 600 may include a communication link 608-a to enable communication between the transmitting and receiving device 602-a and a sensing result computation entity 610, a communication link 608-b to enable communication between the transmitting and receiving device 602-b and the sensing result computation entity 610, and/or a communication link 608-c to enable communication between the transmitting and receiving device 602-c and the sensing result computation entity 610. The sensing result computation entity 610 may be an example of an NE that manages measurements collected via sensing operations and/or one or more configurations related to the sensing operations. For example, the sensing result computation entity 610 may be an example of a measurement entity, which performs a measurement of a transmitted signal (e.g., a reference signal in a sensing transmission 606) for the purposes of fulfilling a service (e.g., communication, sensing, positioning, or any combination thereof). Exemplary measurement entities or nodes may include, but are not limited to, base stations (e.g., gNB or other base station), DUs, CUs, UEs, devices, PRUs, sensing reference units (SRUs), customer premise equipment (CPEs), or the like. The communication link 608-a through the communication link 608-c may be examples of wired, such as physical connections, or wireless connections, such as for over-the-air communications.

In some cases, a reference signal energy or energy per RE utilized for the sensing transmission 606 (e.g., detection, localization and tracking of the target 604) are constant over a signal bandwidth across the symbols (e.g., OFDM symbols) of the sensing transmission 606. The sensing transmission 606 may include, but is not limited to, an SeRS, a PRS (e.g., a downlink PRS (DL-PRS)), a CSI-RS, a TRS, a DM-RS, a PTRS, an SRS, an SSB, control symbols, data symbols, or any combination thereof. The sensing transmission 606 may include any combination of reference signal, data, and/or control information. A configuration entity (e.g., an NE) may configure a power parameter as part of a configuration for the sensing transmission 606. A configuration entity or node determines and/or provides a configuration to another device, entity, or node. Exemplary configuration entities may include, but are not limited to, a base station (e.g., gNB or other base station), location server (e.g., an LMF), a sensing server (e.g., a sensing function), a head base station (e.g., gNB or other base station), or an SMC, among other examples. For example, the configuration entity may transmit signaling to a receiving device to improve a detectability (e.g., signal quality) of the sensing transmission 606 for measuring information related to one or more targets (e.g., the target 604).

In some cases, the power parameter may be structured in a hierarchical or ordered structure in terms of one or more of resources that occupy REs, resource sets, frequency layers, and/or carrier frequencies. The configuration entity may transmit time-frequency resource information to a transmitting device (e.g., the transmitting and receiving device 602-a, the transmitting and receiving device 602-b, the transmitting and receiving device 602-c, or another transmitting device), such as in same signaling as one or more power parameters or in different signaling. The time-frequency resource information may include one or more time-frequency resource identifiers and may optionally include an allocation of time-frequency resources for a sensing transmission. The time-frequency resource identifiers may include an identifier of resources that occupy REs, an identifier of a resource set, an identifier of a frequency layer, or an identifier of a carrier frequency, among other examples. The time-frequency resource identifiers may enable indication of which time-frequency resources are associated with respective power control parameters for a sensing transmissions. A transmitting device may utilize the time-frequency resource identifiers to determine a transmit power at a per-resource level according to a hierarchical or ordered structure. For example, the transmitting device may apply different power control parameters to different REs, resource sets, frequency layers, or carrier frequencies as specified by the corresponding time-frequency resource identifiers in the time-frequency resource information. The hierarchical structure may enable the transmitting device to implement granular power control, where power levels are applied to individual resources or groups of resources based on respective identifiers. The per-resource power determination may account for varying channel conditions, interference levels, and sensing criterion across different time-frequency resources within a sensing transmission.

In some examples, an energy per RE may be constant (e.g., equal, uniform) across resources in a resource set. In some other examples, an energy per RE may not be constant across resources in a resource set. In some examples, any of the resources used for sensing and/or communication other than sensing may use a uniform modulation scheme (e.g., quadrature phase shift keying (QPSK), gray mapping) or a non-uniform modulation scheme based on probabilistic shaping or geometric shaping impacting the energy per RE. The power parameter may in part include or may be referred to as a power offset or resource power parameter, among other examples. A resource configuration for the sensing transmission 606 is shown in Table 2, while Table 3 shows the manner in which related power parameters and related behaviors may be applied in the context of a resource or resource set.

TABLE 2
Common resource configuration parameters for sensing purposes

| Parameter | Description |
|---|---|
| RS-Sensing-Resource-ID | This field specifies the sensing transmission |
| | 606 resource identifier, which is used to |
| | identify a resource for the sensing transmission |
| | 606. |
| RS-Sensing-Sequence-ID | This field specifies the sequence identifier used |
| | to initialize a parameter used to generate a |
| | sequence (e.g., initial state defined by cᵢₙᵢₜ value |
| | used in a pseudo random generator to generate |
| | a sequence for transmission with a sensing |
| | transmission 606). |
| RS-Sensing-Combsize-RE-Offset | This field specifies the RE spacing in each |
| | symbol of the resource for the sensing |
| | transmission 606 and the RE offset in the |
| | frequency domain for the first symbol in a |
| | resource for the sensing transmission 606. All |
| | resource sets for the sensing transmission 606 |
| | belonging to a same positioning frequency |
| | layer have a same value of comb size. Relative |
| | RE offsets of following symbols are defined |
| | relative to the RE offset in the frequency |
| | domain of the first symbol in the resource for |
| | the sensing transmission 606. The comb size |
| | configuration is aligned with the comb size |
| | configuration for the frequency layer. |
| RS-SensingResourceSlotOffset | This field specifies the starting slot of the |
| | resource for the sensing transmission 606 with |
| | respect to the corresponding resource set for |
| | the sensing transmission 606 slot offset. |
| RS-Sensing-QCL-Info | This field specifies the quasi-colocation (QCL) |
| | indication for a resource for the sensing |
| | transmission 606 with another signal (e.g., |
| | reference signal) from a serving or neighboring |
| | cell and/or the same or a neighboring TRP. |
| | In some examples, when two configured |
| | resources for the sensing transmission 606 |
| | (e.g., associated with two RS-Sensing- |
| | Resource-ID) are associated with different |
| | TRPs as distinct transmission points, a QCL |
| | relation between the two resources may |
| | describe a shared illumination pattern of a |
| | target or sensing area (e.g., resources) are |
| | directed towards the same sensing target and/or |
| | area or illuminate the same sensing target area |
| | with a similar energy-per-area density and/or |
| | pattern. |

TABLE 3
Power parameter implementation examples for a configuration for sensing purposes

Implementation Example 1: Sens-RS-ResourcePower, value range from [Xₘᵢₙ to Xₘₐₓ in steps
of y]
This field specifies the average energy per RE of the REs that carry the sensing transmission 606,
which is expressed in dBm that is used for the sensing transmission 606. The receiving device
(e.g., sensing receiver) assumes constant energy per RE is used for all REs of a given sensing
transmission 606 resource. The parameters Xmin and Xmax represent the value range, while y
represents the step size.

Implementation Example 2:
TDM Example: Reference signal resources for sensing are time-division multiplexed (TDMed)
Resource Set 1:
{
RS-Sensing-ResourceSet-ID
RS-Sensing-Periodicity-and-ResourceSetSlotOffset
RS-Sensing-RepetitionPattern
Resource-Index
RS-Sensing-MutingOption1
RS-Sensing-MutingOption2
RS-Sensing-NumSymbols [Enumerated: 1, 2,..., N_{Sym}]
AGC-Symbols: ‘1’ included or not included ‘0’
Sens-RS-ResourcePower, value range from [Xmin to Xmax in steps of y]
{
Resource Set 2:
{
RS-Sensing-ResourceSet-ID
RS-Sensing-Periodicity-and-ResourceSetSlotOffset
RS-Sensing-RepetitionPattern
Resource-Index
RS-Sensing -MutingOption1
RS-Sensing -MutingOption2
RS-Sensing-NumSymbols [Enumerated: 1, 2,..., N_{Sym}]
AGC-Symbols: ‘1’ included or not included ‘0’
Sens-RS-ResourcePower, value range from [Xmin to Xmax in steps of y]
}

RS-Sensing-ResourceSet-ID: This field specifies the sensing transmission 606 resource set
identifier, which is used to identify the resource set for sensing purposes of the TRP across all the
frequency layers and/or carriers.
RS-Sensing-Periodicity-and-ResourceSetSlotOffset: This field specifies the periodicity of the
sensing transmission 606 allocation in slots configured per resource set for sensing purposes and
the slot offset with respect to system frame number (SFN) #0 slot #0 for a TRP where the
resource set for sensing purposes, resource set, is configured (e.g., slot where the first resource
for sensing purposes of a resource set for sensing purposes occurs). In some cases, the slot offset
may be defined with respect to a common reference time, defined by one or more transmitting
devices (e.g., sensing transmitters).
RS-Sensing-RepetitionPattern: This field specifies the number of instances in which each
resource for sensing purposes is repeated for a single instance of the resource set for sensing
purposes. The field is applied to each resource of the resource set for sensing purposes. The field
may include enumerated values (e.g., 2,4, 6, 8, 16, 32 corresponding to 2, 4, 6, 8, 16, 32 resource
repetitions, respectively). If the field is absent, then the value is 1 (e.g., no resource repetition). In
some cases, the power parameter is constant across initial transmissions and each repetition of the
resource for sensing purposes. In some other cases, a sub-set of transmissions may be allocated
with one power parameter and/or value, and another power parameter and/or value may be set for
another sub-set of transmissions, where a transmission may include an initial transmission and/or
a set of repetitions.
Resource-Index: This field specifies a list or index of resources, as described in Table 2.
RS-Sensing -MutingOption1: This field specifies the resource for sensing purposes muting
configuration of the TRP, beam, and/or slot for the muting option one and includes the following
sub-parameters: A bitmap of the time locations where the resource for sensing purposes is
transmitted (value ‘1’) or not (value ‘0’). In some cases, the time locations may be OFDM
symbols within a slot. Each bit of the bitmap corresponds to a sub-set of resources for sensing
purposes or repetition of the resources for sensing purposes within an instance of a resource set
for sensing purposes. If this field is absent, then muting option one is not in use for the TRP(s).
RS-Sensing -MutingOption2: This field specifies the signaling for sensing purposes muting
configuration of resource sets for sensing purposes for muting option two and includes the
following sub-parameters: defines a bitmap of the time locations where the resource for sensing
purposes is transmitted (value ‘1’) or not (value ‘0’) for a resource set for sensing purposes. A key
difference to the above described muting option one is that muting option two is performed on a
resource set level, where a resource set includes a set or group of resources. The muting option
two provides for a broader set of resources belonging to a group to be muted concurrently as
opposed to individual resource configurations.
Sens-RS-ResourcePower [Xmin to Xmax in steps of y]: This field specifies the average energy
per RE of the REs that carry the sensing transmission 606, which is expressed in dBm that is used
for sensing transmission 606. The receiving device assumes constant energy per RE is used for all
REs of a given resource for sensing purposes. The parameters Xmin and Xmax represent the
value range, while y represents the step size.
RS-Sensing-NumSymbols: This field specifies the number of symbols of REs that carry the
sensing transmission 606, where the information element (IE) and/or parameter Sens-RS-
ResourcePower is applied. The symbols may be continuous, discontinuous, or form a comb
pattern in the time domain.
AGC-Symbols: This field specifies the inclusion of one or more AGC symbols before and after
the REs that carry the sensing transmission 606, where the IE and/or parameter Sens-RS-
ResourcePower is applied. In some cases, the one or more AGC symbols are appended to the
REs that carry the sensing transmission 606. If an AGC symbol is transmitted immediately
preceding a resource for sensing purposes or immediately after a resource for sensing purposes,
then the generated AGC symbol includes the RE offset in the AGC symbol is the same as that in
the last symbol of the resource for sensing purposes. The sequence for sensing purposes is
generated based on the symbol index of the AGC symbol within the slot. In some other cases, the
amplitude scaling factor follows the amplitude scaling factor β_{RS-sensing} of the resource for sensing
purposes to make the power of the OFDM symbol immediately preceding the resource for
sensing purposes the same as the power of the resource for sensing purposes.
In some examples, the reception of AGC symbols are associated with a time-domain gap between
the AGC symbols and the sensing resources for which an adjusted AGC gain applies by the
receiving device according to reception at the AGC symbols. For example, the gap may be
sufficient to provide for an update of the AGC scaling factor. In some other examples, the time-
domain gap is indicated by the receiving device to the transmitting device or the sensing function
and/or SensMF as a capability IE.

Due to the varying change of a transmit power between the monostatic and bistatic or multi-static cases, the hierarchical resources may be provided in terms of the sensing mode of operation. One or more devices may support a monostatic sensing mode of operation, a bistatic sensing mode of operation, a multi-static sensing mode of operation, or a common sensing mode sensing mode of operation applicable to both monostatic and bistatic or multi-static time-frequency resources. The common sensing mode of operation may provide unified sensing resource allocation and power control mechanisms that can be utilized across different sensing deployment scenarios within a same wireless communications system 600.

In some cases, the devices in the wireless communications system 600 may implement an adaptive power control procedure and mechanism for a monostatic sensing mode of operation to detect and track a target 604 in a robust and accurate manner. The adaptive power control procedures can enable enhanced detection coverage of targets (e.g., the target 604) depending on the distance between the collocated transmitter and receiver (e.g., the transmitting and receiving device 602-a through the transmitting and receiving device 602-c). Further, monostatic interference (I_{monostatatic}) may be defined according to Equation 3:

$${I}_{monostatatic} = {I}_{Self - interference} + {\sum }_{n = 1}^{N} {I}_{Other - TRPs}^{n} + {I}_{T C} + {I}_{B C} , \qquad ( 3 )$$

where I_{Self-interference,dB} is a self-interference component and

$${I}_{Other - TRPs , dB}^{n}$$

is an inter-site interference component from a total of N TRPs. I_{TC,dB} and I_{BC,dB} are interfering signals from target specific channels (e.g., interference from targets with similar signal characteristics as the target, including RCS characteristics) and interfering signals from the background channel (e.g., a surrounding environment), respectively, of a same transmitter and receiver pair. The self-interference is a relatively significant (e.g., greater than a threshold) contributor to overall interference in the monostatic sensing mode of operation, which is mitigated using self-interference cancellation algorithms, among other example algorithms and procedures.

In some examples, the

$${I}_{Other - TRPs , dB}^{n}$$

component may be suppressed or controlled (e.g., managed) in the presence of other monostatic sensing signals depending on a type of configured power control scheme depending on the implementations. The wireless communications system 600 illustrates a scenario of a monostatic sensing mode of operation with three transmitting and receiving devices. The transmitting and receiving devices (e.g., the transmitting and receiving device 602-a through the transmitting and receiving device 602-c) may each be examples of TRPs, UEs, or a combination of TRPs and UEs. The wireless communications system 600 includes monostatic interference when each transmitting and receiving device performs beam sweeping independently, resulting in beam transmission of one monostatic transmission interfering with another monostatic reception. The receiver receiving multiple sensing signals can also be viewed as one or more new sensing measurements (e.g., sensing SNR, RSRP, or RSRPP measurements, among other examples). The new sensing measurements can occur when the target 604 has not yet been detected when omni-directional beam sweeping is performed. A centralized sensing result computation entity (e.g., the sensing result computation entity 610) may coordinate the omni-directional beam sweeping. However, depending on a target detection or resulting target movement or position, spatial beam sweeping conflicts or overlaps may occur for a configured resource for different sensing transmitters and receivers and can scale proportionately depending on the density of the deployment.

In some examples, a power offset or power resource parameter may be applied to a sensing transmission 606 in a monostatic sensing mode of operation. The power offset and/or application of the power offset can be configured either by a transmitting device (e.g., equipped with an SMC either in the NG-RAN or UE) or by a centralized sensing configuration and result computation entity residing in the CN (e.g., sensing function, SensMF, the sensing result computation entity 610). The centralized configuration entity may configure a different resource power for sensing transmissions 606 in a monostatic sensing mode of operation depending on a relative distance or direction of a TRP relative to the one or more sensing targets (e.g., the target 604). The ramp up or ramp down of the resource power for sensing may be defined according to the step size parameter (y) within Xmin and Xmax value ranges. The value ranges may be further adjusted in an adaptable manner based on the dynamic range considering the background and target channel. In some other examples, the muting or zero resource power coordination driven by a centralized or decentralized configuration entity can enable interference reduction (e.g., avoidance, mitigation) in instances where a neighbouring TRP transmit beam sweep including signaling used for sensing and/or communications other than sensing impacts a reception at a target monostatic receiver.

In some other examples, the monostatic transmitting device (e.g., a transmitter at a transmitting and receiving device) may be configured to perform inter-site sensing signal measurements from other sensing transmitters based on the received interference reference signal used for sensing purposes or communications purposes (e.g., communications other than sensing, including data and/or control signaling transmissions). The measured inter-site sensing signal measurements can be reported to a requesting entity and/or node, including a sensing transmitter equipped with an SMC either in the NG-RAN or UE or by a centralized sensing configuration and result computation entity residing in the CN (e.g., sensing function, SensMF, the sensing result computation entity 610).

In some cases, a resource allocated for the sensing transmissions 606 from the transmitting and receiving device 602-a through the transmitting and receiving device 602-c are separated (e.g., orthogonalized) in one or more of a time domain, a frequency domain, a beam domain (e.g., spatial domain), or a sequence domain, such that the configured sensing transmissions 606 do not cause interfering to the receivers at the transmitting and receiving device 602-a through the transmitting and receiving device 602-c and/or facilitate joint measurement over multiple signals at the receivers of the transmitting and receiving device 602-a through the transmitting and receiving device 602-c.

In some examples, a transmitting device (e.g., TRP, gNB, or UE) can control or adapt a transmit power depending on a measured pathloss towards one or more targets (e.g., the target 604). A sensing and/or radar pathloss is defined by Equation 4:

$$P {L}_{s e n s i n g} ( {d}_{1} , {d}_{2} ) = P L ( {d}_{1} ) + P L ( {d}_{2} ) + {log}_{10} ( \frac{{λ}^{2}}{4 π} ) - 10 {log}_{10} ( {σ}_{R C S} ) + S {F}_{dB , 1} + S {F}_{dB , 2} , \qquad ( 4 )$$

where d₁ is the sensing transmitter to sensing target distance, d₂ is the sensing target to sensing receiver distance, λ is the wavelength of the transmitted signal, σ_{RCS} is the RCS of the sensing target and SF_{dB,1} and SF_{dB,2} are the shadow fading parameters generated for the transmitting device-sensing target link and sensing target-receiving device link, respectively. For monostatic sensing, d1=d2, PL_{dB} (d₁)=PL_{dB} (d₂), SF_{dB,1}=SF_{dB,2}. That is, the transmitter performs sensing or radar pathloss compensation to overcome twice the pathloss experienced in non-monostatic scenarios to reliably detect one or more sensing targets (e.g., the target 604) and therefore enhanced transmit power adaptation schemes may improve the signal quality at receiving devices and/or receivers.

In an uplink communication scenario, a UE computes a transmit power (P_{Comm-Tx}) according to Equation 5:

P_{Comm-Tx}=min{P_{cmax},P_{0,DL}+10 log₁₀(2^{μ}M)+α_{DL}PL_{DL}+Δ} (5)

where P_{cmax} is a UE configured and allowable maximum transmit power, P_{0,DL} is the nominal power provide to the UE, μ refers to the subcarrier spacing at which a signal is transmitted, M refers to the number of physical resource blocks (PRBs) utilized to transmit the configured signal (e.g., reference signal), α_{DL} is the configured fractional power or pathloss factor together with the computed one-way propagation downlink pathloss (PL_{DL}), and Δ is a closed loop power control parameter which provides for an NE (e.g., a base station) to adjust a transmit power of a UE and for open loop power control, Δ=0.

As a result, the sensing power control procedure may depend on a measured monostatic pathloss, which can be applicable to both monostatic sensing modes of operation in wireless communications systems with UEs and/or TRPs operating as transmitting and receiving devices (e.g., the transmitting and receiving device 602-a through the transmitting and receiving device 602-c). The power control procedure, as shown in Equation 6, may be applied for adapting a transmit power for a sensing transmission 606 in a monostatic sensing mode of operation depending on the application and/or scenario (e.g., performing detection or performing tracking including position estimation and velocity estimation).

P_{Monostatic-Sense-Tx}=min{P_{csmax},P_{Tx,PL}}, (6)

where P_{csmax} may be applicable to a UE with relatively strict transmit power limits (e.g., threshold maximum transmit powers). One or more base stations or TRPs may also implement energy criterion and usage monitoring. The configured P_{csmax} may be set for TRPs or base stations (e.g., instead of a fixed upper bound transmit power limit applicable only to UEs in the context of more energy efficient communication or sensing). In some cases, P_{csmax} is dependent on a power class of the transmitting device or transmitter, providing for an allowed maximum power reduction, effective isotropic radiate power (EIRP).

In some cases, the value of P_{csmax} is further determined according to a maximum received self-interference power or saturation power level and/or the isolation level between a transmitter and a receiver. In some examples, the maximum receiver saturation power level and/or the isolation level are determined per transmit beam, receive beam, transmit-receive beam pair, or any combination thereof. A post-detection transmit power pathloss function, (P_{Tx,PL}), is calculated according to Equation 7:

P_{Tx,PL}=P_{0,2-way}+10 log₁₀(2^{μ}M)+β_{2-way}PL_{sensing}+Δₛₑₙₛₑ, (7)

where P_{0,2-way} is a configured (e.g., defined, preconfigured) received target power assuming compensation of the full pathloss, which can be adjusted internally for monostatic transmitter and/or receiver or may be received from a distributed sensing SMC either in the NG-RAN or UE or by a centralized sensing configuration and result computation entity residing in the CN (e.g., sensing function, SensMF or sensing result computation entity 610), μ and M are the SCS and number of PRBs, as defined earlier, β_{2-way} is a toggling factor with a value range β_{2-way}={0,1} enabling or disabling pathloss compensation for adapting the monostatic transmit power, and Δₛₑₙₛₑ is the closed loop power parameter to progressively adapt the power for sensing purposes. P_{Monostatic-Sense-Tx} may be applied over a configured TTI. The TTI may include a set of sub-symbols, symbols, sub-slots, mini-slots, slots, subframes, frames, system frames, hyper frames, and/or a defined time duration in which to perform a transmission (e.g., the sensing transmission 606).

A pre-detection transmit power control (e.g., prior to detecting the target 604) can be described in terms of adapting a power control prior to detection of a sensing target to meet a detection criterion or SSNR or SNR, which is independent of the sensing pathloss. A receiver performs a measurement associated with one or more reflected or echo paths of a target 604, where the measurement may include one of a measured SSNR SNR, RSRP, RSRPP, Doppler-delay path profile, range-Doppler profile, and/or angle-delay profile, among other example measurements. The receiving device may then report one or more of the measurement metrics (e.g., measured values) to the transmitting device or centralized sensing configuration entity (e.g., the sensing result computation entity 610). The transmitting device or centralized sensing configuration entity may compare the received measurements with the target measurements (e.g., target SNR or SSNR). The transmitting device may then ramp up or ramp down the transmit power according to a delta between received and measured measurements and target measurements. The ramp up or ramp down of the transmit power may be configured steps. In some cases, the power control mechanism may depend on a measured SNR or SSNR (e.g., as opposed to the pathloss).

In some examples, the beam correspondence holds between the transmit and receive beams of the measurements at the transmitting device and/or the receiving device. In some other examples, the transmit and/or receive power are measured including the impact of the spatial directivity addition by the transmit and receive beams towards the path associated with the target 604. If the transmit beam is associated with X-times higher energy density towards the path associated with target 604 compared to the receive beam utilized to perform receive power and/or pathloss measurements, then the transmit power is determined according to Equation 8:

P_{Monostatic-Sense-Tx}=min{P_{csmax},P_{Tx,PL}/X}. (8)

In some examples, upon determination of a transmit power level according to the adjustments for pathloss compensation, the determined transmit power is further reported to a sensing controller and/or aggregator (e.g., the sensing result computation entity 610) or to the receiving device associated with the reception of the sensing signal with adjusted transmit power.

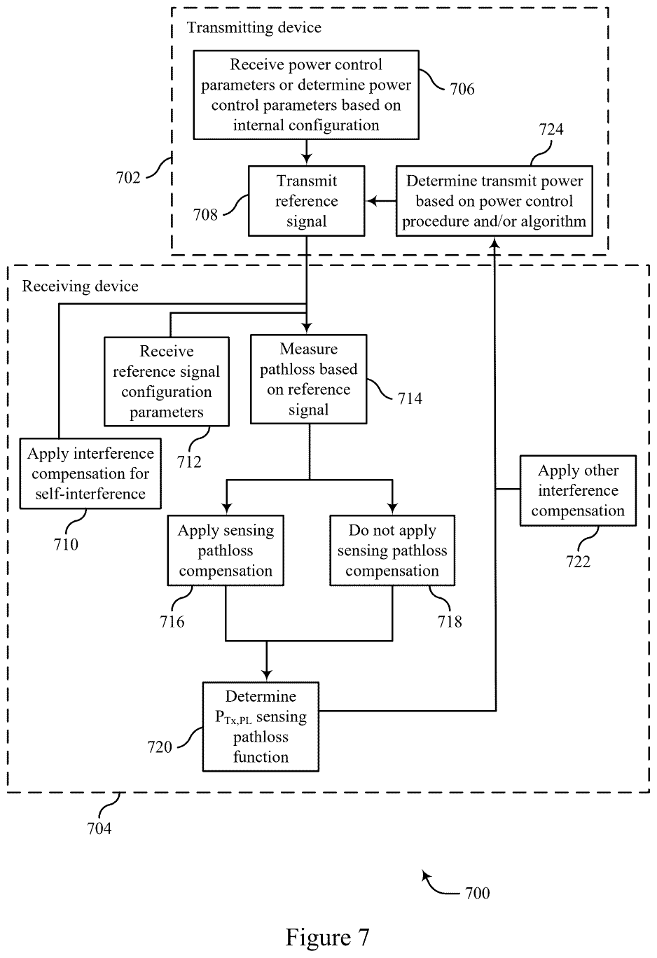

FIG. 7 illustrates an example of a process flow 700 in accordance with aspects of the present disclosure. In some examples, the process flow 700 implements or is implemented by aspects of the wireless communications system 100, the wireless communications system 200, the wireless communications system 300, the network architecture diagram 400, the transmission diagram 500, and the wireless communications system 600. The process flow 700 may implement or be implemented by a transmitting device 702 and a receiving device 704 (e.g., a transmitter and a receiver, respectively, at a transmitting and receiving device for monostatic sensing modes of operation), which may be implemented by one or more devices in a wireless communications system, as described with reference to FIGS. 1 through 6. For example, the process flow 700 includes an example of a power control procedure for a monostatic sensing mode of operation, which can be extended to bistatic and multistatic systems considering that the transmitter and the receiver are residing in different and/or separate entities with different geographical coordinates. The process flow 700 may also be adapted for hybrid sensing modes, where devices can dynamically switch between monostatic, bistatic, and multistatic configurations based on sensing criterion (e.g., requirements), target characteristics, or network conditions. Alternative examples of the following may be implemented, where some processes are performed in a different order than described or are not performed. In some cases, processes may include additional features not mentioned below, or further processes may be added.

At 706, the transmitting device 702 may receive power control parameters from another entity, including a distributed sensing SMC either in an NG-RAN or UE or by a centralized sensing configuration and result computation entity residing in the CN (e.g., sensing function, SensMF, or sensing result computation entity). Additionally, or alternatively, the transmitting device 702 may select a default setting for one or more power control parameters depending on an internal configuration. The power control parameters may be received via higher layer signaling (e.g., NAS or RRC signaling), MAC-control elements (MAC-CEs), downlink control information (DCI), uplink control information (UCI), or sidelink control information (SCI). Exemplary power control parameters may include, but are not limited to, one or more parameters described in the P_{Monostatic-Sense-Tx} procedures (e.g., P_{0,2-way}). For example, the power control parameters may include pathloss compensation factors, maximum transmit power limits, beam-specific power adjustments, interference mitigation parameters, target SNR values, sensing-specific scaling factors, and frequency-dependent power offsets. In some cases, the power control parameters may be dynamically updated based on changing channel conditions, sensing target characteristics, or network criterion.

At 708, the transmitting device 702 may transmit one or more initial sensing transmissions, such as a reference signal or multiple reference signals for sensing purposes. The sensing transmissions may be used for detection and/or tracking of a target. This includes a reference signal or other transmission used for communication, sensing, or both communication and sensing. The sensing transmission may be used to measure at least a pathloss (e.g., a reference pathloss for sensing, referred to as sensing pathloss reference), which is used to determine a transmit power to detect or track a target. The initial sensing transmissions may be characterized by time-frequency resource locations, a resource identifier, one or more time-frequency patterns, bandwidth, periodicity, and/or a time and frequency offset with respect to slot and RE, respectively. For the initial transmission, a default configuration may be determined depending on a deployment of the network, inter-site distance (ISD) between neighboring TRPs, geometry of the various anchor nodes (e.g., TRPs), and expected sensing target characteristics. Exemplary sensing transmissions may include, but are not limited to, a PRS, an SeRS, an SRS, a CSI-RS, a TRS, a DMRS, an SSB, or other reference signals, data symbols, or control information symbols. The initial transmission may utilize adaptive waveforms for one or more sensing scenarios, such as frequency-modulated continuous wave (FMCW) signals for range detection or orthogonal frequency-division multiplexing (OFDM) signals for communication-sensing integration. In some examples, the measurement of the sensing pathloss and/or computation of the adjusted transmit power level is done subsequent to a determination or detection of a target being present, of a propagation path associated with a sensing target, and thereby the measurement or determination of the pathloss and/or receive or transmit power levels are done after the determination of the sensing target being present and/or the measured path is associated with scattering of a sensing target of interest. In some cases, the indication of the target being present is further received via a sensing controller and/or aggregator entity. In some other cases, the transmitting device may transmit the sensing transmission based on a target SSNR (e.g., not dependent on the sensing pathloss) to achieve one or more target metrics (e.g., probability of detection, probability of false alarm, probability of missed detection, range resolution, velocity resolution, or angle resolution).

At 710, the receiving device 704 may apply self-interference cancellation techniques and/or schemes at the receiver front end. The techniques may include analog cancellation methods, such as circulator-based isolation, digital cancellation methods, such as successive interference cancellation (SIC), or hybrid approaches combining both analog and digital techniques. The self-interference cancellation may be performed in a time domain, a frequency domain, or a spatial domain using beamforming techniques. In some cases, the receiving device 704 may dynamically adjust cancellation parameters based on real-time interference measurements. The self-interference cancellation may also include power control mechanisms to limit transmit power based on receiver saturation levels and isolation capabilities between transmit and receive chains.

At 712, the receiving device 704 may receive one or more transmit configuration parameters (e.g., for a reference signal or other sensing transmission), which can be used as input for the sensing pathloss function computation. Additionally, or alternatively, other sensing-specific parameters, such as RCS characteristics (e.g., σ_{RCS}), target velocity estimates, multipath channel characteristics, Doppler spread parameters, and environmental clutter statistics may also be provided to the receiver to be used to compute the sensing pathloss function. In the case that the transmitter and receiver are co-located, such information may be received from the transmitter via a hardware interface, which may be proprietary or a specified interface, such as a common public radio interface (CPRI) or enhanced CPRI (eCPRI). The configuration parameters may also include beam-specific information, antenna array characteristics, and calibration data for accurate pathloss estimation.

At 714, the receiving device 704 may measure the pathloss reference based on the received sensing transmission (e.g., reference signals). The pathloss reference may be used in the context of the measured received power or path power to compute the sensing pathloss function. The pathloss measurement may account for both line-of-sight (LOS) and non-line-of-sight (NLOS) propagation paths, multipath fading effects, shadowing, and frequency-dependent propagation characteristics. The receiving device 704 may perform measurements across multiple frequency bands, time instances, and spatial directions to obtain a pathloss characterization. The pathloss reference may be measured for different polarizations, beam directions, and antenna configurations to support diverse sensing scenarios.

At 716 and 718, the receiving device 704 may autonomously choose or be configured to apply pathloss compensation via the β_{2-way} parameter. The decision to apply or not apply pathloss compensation may be based on sensing mode criterion, target detection criterion (e.g., a probability of missed detection or a probability of detection of the target), interference levels, or network configuration. At 716, when pathloss compensation is applied, the receiving device 704 may use the β_{2-way} parameter to adjust the transmit power based on the two-way pathloss experienced by the sensing signal. At 718, when pathloss compensation is not applied, the receiving device 704 may rely on other power control mechanisms or maintain a fixed transmit power level. The choice between these approaches may be dynamically determined based on real-time channel conditions, sensing performance criterion, or interference management considerations. Alternative pathloss compensation schemes may include partial compensation, frequency-selective compensation, or adaptive compensation based on target characteristics.

At 720, the receiving device 704 may compute or determine the sensing pathloss function (P_{Tx,PL}) or perform detection measurements (e.g., based on SNR, SSNR, SSINR, or SINR). The sensing pathloss function may incorporate various factors, including distance-dependent pathloss, frequency-dependent attenuation, RCS characteristics of the sensing target, multipath propagation effects, and environmental factors such as weather conditions or atmospheric attenuation. The computation may utilize advanced algorithms, such as maximum likelihood estimation, Bayesian inference, or neural network-based approaches to improve accuracy. The receiving device 704 may also perform additional measurements, such as angle-of-arrival (AoA) estimation, time-of-flight (ToF) measurements, Doppler shift analysis, and range-Doppler profiling to enhance the sensing pathloss function. In some cases, the pathloss function may be computed separately for different sensing targets, propagation paths, or frequency bands to support multi-target sensing scenarios.

At 722, the receiving device 704 may apply any other types of interference mitigation schemes. In some examples, the other types of interference mitigation schemes include limiting the transmit power to a maximum receiver saturation power level plus an isolation level between transmit and receive antenna ports. Additional interference mitigation techniques may include inter-cell interference coordination (ICIC), enhanced ICIC (eICIC), coordinated multipoint (CoMP) transmission, interference alignment, and advanced receiver techniques, such as minimum mean square error (MMSE) filtering or successive interference cancellation. The receiving device 704 may also employ spatial filtering techniques using multiple antennas, temporal filtering to suppress time-varying interference, or frequency-domain filtering to mitigate narrowband interference. The interference mitigation may be coordinated across multiple devices in the network to improve overall sensing performance, while minimizing interference to communication services.

At 724, the receiving device 704 may share the outcome of the sensing pathloss function (P_{Tx,PL}) and/or self-interference cancellation or other types of interference mitigation schemes with the transmitter to determine a transmit power (P_{Monostatic-Sense-Tx}) based on the received information. In the case that the transmitter and receiver are co-located, such information may be received from the receiver via a hardware interface, which may be proprietary or a specified interface, such as CPRI, eCPRI, or other fronthaul interfaces. The information sharing may occur through various signaling mechanisms, including UCI, DCI, SCI, MAC-CEs, NAS signaling, RRC signaling, dedicated sensing control channels, or higher-layer sensing protocols (e.g., based on NAS signaling). Additionally, or alternatively, the receiver may directly compute the transmit power (P_{Monostatic-Sense-Tx}) which the receiver can share with a transmitter for co-located transmitter and receiver configurations. In some cases, the transmit power may be determined in part due to the receiver saturation power supported by the receiver and the achievable isolation level between transmit and receive chains. In some other cases, the transmitter may determine the power control based on the pre-detection power control mechanism, which is independent of (e.g., does not use) the pathloss for sensing. The power control algorithm may incorporate feedback mechanisms in closed loop power control to improve performance based on sensing quality metrics, interference measurements, and network conditions. In some examples, the transmit power may be determined in part due to a receiver noise floor power, receiver quantization noise, distortion level, or any combination thereof. For example, for various supported transmit powers, the noise floor or distortion level will be adapted accordingly, and some reflections or echoes based on the received paths may not be buried or embedded in the noise floor.

In some cases, a transmitting device supports multiple values for a maximum configured transmit power for sensing and communication (P_{csmax}) depending on whether the transmit power is being applied to a communication transmission (e.g., control information or data), a sensing transmission, or a combination of both transmission types. The P_{csmax} may also be set based on regional regulatory criterion for an NE and/or a UE radio frequency transmission or reception, specific absorption rate (SAR) limitations, electromagnetic compatibility (EMC) requirements, and coexistence criterion with other radio services. Different values of P_{csmax} may be configured for different frequency bands, carrier aggregation scenarios, or dual connectivity configurations. The maximum transmit power may also vary based on device capabilities, thermal conditions, battery levels, or network load conditions.

In some cases, at a transmitter-side different antenna panels may be associated with different values of P_{csmax} based on multi-panel transmissions. In the case of large arrays (e.g., greater than a threshold) and/or massive multiple-input multiple-output (MIMO) arrays, different sub-arrays may be associated with different P_{csmax} values based on one or more physical characteristics, power amplifier capabilities, thermal constraints, or beam-forming criterion. In some other cases, combinations of P_{csmax} and the maximum configured transmit power for communication (P_{cmax}) may be associated with multiple panels or sub-arrays to enable flexible power allocation strategies. In some other cases, the minimum of min(P_{csmax}, P_{cmax}) may be associated with each panel or sub-array to ensure compliance with the most restrictive power limitation. In some other examples, the number of antenna elements per sub-array or per-panel can influence the value of P_{csmax}, where arrays with more elements may have higher maximum transmit power capabilities due to improved beamforming gain and directivity.

If multiple transmit and receive antenna ports are present, then separate or different values for isolation of each transmit and receive pair and/or the receive saturation power at each receive antenna port or panel may be indicated (e.g., considered) for the computation of the maximum transmit power. In some examples, the maximum transmit power may be a number that satisfies (e.g., is less than) the saturation power limitation of each of the antenna ports. The isolation values may be measured, calibrated, or estimated based on antenna design characteristics, physical separation, polarization diversity, or active cancellation techniques. Different antenna configurations, such as cross-polarized antennas, spatially separated antennas, or frequency-selective antennas, may provide different isolation levels that are to be accounted for in a power control algorithm. The receive saturation power may vary based on receiver architecture, ADC characteristics, AGC settings, and front-end amplifier specifications.

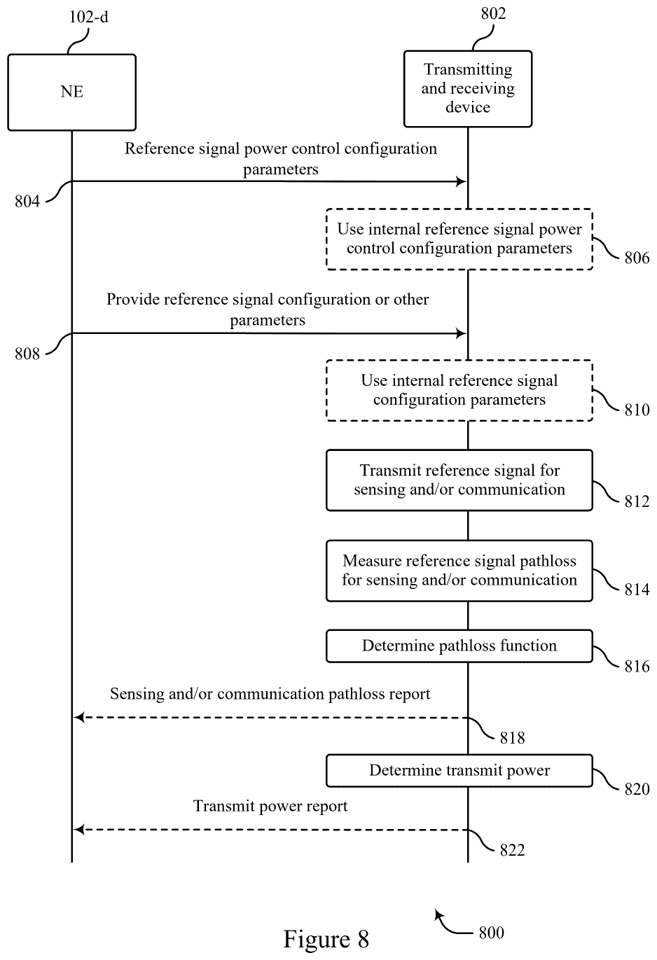

FIG. 8 illustrates an example of a signaling diagram 800 in accordance with aspects of the present disclosure. In some examples, the signaling diagram 800 implements or is implemented by aspects of the wireless communications system 100, the wireless communications system 200, the wireless communications system 300, the network architecture diagram 400, the transmission diagram 500, the wireless communications system 600, and the process flow 700. The signaling diagram 800 may implement or be implemented by an NE 102-d and a transmitting and receiving device 802 (e.g., a device capable of both transmitting and receiving operations for monostatic sensing modes of operation), which may be implemented by one or more devices in a wireless communications system, as described with reference to FIGS. 1 through 7. For example, the signaling diagram 800 includes an example of a power control configuration and reporting procedure for a monostatic sensing mode of operation, which can be extended to bistatic and multistatic systems. The signaling diagram 800 may also be adapted for hybrid sensing modes where devices can dynamically switch between monostatic, bistatic, and multistatic configurations based on sensing requirements, target characteristics, or network conditions. Alternative examples of the following may be implemented, where some processes are performed in a different order than described or are not performed. In some cases, processes may include additional features not mentioned below, or further processes may be added.

At 804, the NE 102-d may transmit reference signal power control configuration parameters to a transmitting and receiving device 802. The transmitting and receiving device 802 may be an example of a transmitting and receiving device as described with reference to FIG. 6. The transmitting device may utilize the power control configuration parameters (e.g., power control information) to determine a transmit power for a sensing transmission, including an initial sensing transmission. For example, the transmitting device may receive power control parameters from another entity, such as a distributed SMC either in the NG-RAN or UE or by a centralized sensing configuration and result computation entity residing in the CN (e.g., sensing function, SensMF, sensing results computation entity). Additional information can also be provided regarding the reference signal power control parameters of other neighboring TRPs, such as transmit power, muting patterns, transmit power step size, target base receiver power or sensitivity, or receiver saturation power. The power control configuration parameters may include, but are not limited to, an average energy per RE associated with sensing signaling, a bitmap that indicates one or more time locations of sensing signaling for muting, a field that indicates a presence of one or more AGC symbols associated with sensing signaling, a number of symbols associated with sensing signaling, pathloss compensation factors, maximum transmit power limits, beam-specific power adjustments, or interference mitigation parameters.

At 806, the transmitter of the transmitting and receiving device 802 may utilize available pre-configured reference signal power control parameters or internal reference signal power control parameters. For example, the transmitting device may utilize reference signal configuration parameters, such as bandwidth (e.g., expressed in number of PRBs), subcarrier spacing, carrier frequency, time domain parameters including number of symbols, periodicity, or normal or extended cyclic prefix, to transmit one or more reference signals for sensing purposes and/or adaptive power control. Other sensing-specific parameters include, but are not limited to, RCS, type of object, target material, expected point cloud, point cloud format (e.g., static point clouds, dynamic point clouds, lidar sequence point clouds, point cloud quality, anticipated organized point clouds or anticipated unorganized point clouds including three dimensional (3D) Cartesian (X, Y, Z) coordinates, additional attributes, like RGB color, normal vectors, masks, intensity, and timestamps).

At 808, the transmitter of the transmitting and receiving device 802 receives the reference signal-specific and/or sensing-specific configuration parameters from the NE 102-d. The reference signal-specific configuration parameters may include, but are not limited to, reference signal sequence identifiers, resource allocation patterns, transmission timing parameters, frequency domain resource assignments (FDRAs), power spectral density (PSD) configurations, and reference signal port mappings. For example, the reference signal-specific parameters may indicate which PRS sequences to use, the REs or resource blocks (RBs) allocated for transmission, the periodicity and offset of reference signal occasions, and the number of consecutive symbols allocated for reference signal transmission. The sensing-specific configuration parameters may include target detection parameters, such as expected RCS values, sensing range criterion, velocity estimation parameters, AoA estimation configurations, and sensing waveform characteristics.

At 810, the transmitter of the transmitting and receiving device 802 may utilize available reference signal-specific configuration and/or sensing-specific configuration parameters or internal reference signal configuration parameters. The internal reference signal configuration parameters may include stored reference signal sequences, default resource allocation patterns, fallback transmission parameters, and device-specific sensing capabilities. For example, the transmitting and receiving device 802 may maintain internal configurations for different sensing modes (e.g., monostatic, bistatic, multistatic), default power control settings for various frequency bands, and pre-configured beam patterns for sensing operations.

At 812, the transmitter of the transmitting and receiving device 802 may transmit a reference signal (e.g., initial reference signal transmission) or multiple of reference signals which may be used for detection and/or tracking of a target or alternatively a reference signal for communication or in another implementation a reference signal for communication and sensing. The reference signal transmission may include various types of signals, such as SeRSs, PRSs, TRSs, CSI-RSs, DMRSs, PTRSs, SRSs, or SSBs. The transmission may be configured with defined power levels determined from the received power control parameters, applied across the allocated time-frequency resources according to the resource identifiers. For example, different power levels may be applied to different REs, resource sets, frequency layers, or carrier frequencies as indicated by the corresponding time-frequency resource identifiers. The transmission may also include muting patterns, in which one or more time-frequency resources are intentionally not transmitted or transmitted with zero power to reduce interference and improve signal quality at the receiving devices.

At 814, the receiver of the transmitting and receiving device 802 may perform one or more measurements based on the received scatterers and/or reflections from the target object. The measurements may include one of a RSRP, RSRPP, or any other related received strength measurement according to one or more received paths associated to one or more scattering points of a sensing target. Additional measurements may include, but are not limited to, SNR, SINR, SSNR, SSINR, Doppler-delay path profiles, range-Doppler profiles, and angle-delay profiles. For example, the receiver may measure the time-of-flight of reflected signals to determine target range, analyze Doppler frequency shifts to estimate target velocity, and evaluate angle-of-arrival information to determine target direction. The measurements may be performed on multiple reflection paths from the same target or different targets, enabling the transmitting and receiving device 802 to characterize complex sensing environments with multiple scattering objects. The receiver may also measure interference levels from other sensing transmissions or communication signals to support interference mitigation and to improve power control.

At 816, the transmitting and receiving device 802 determines the pathloss function taking into account sensing-specific characteristics or performs detection measurements which is used to adapt the transmit power. In another implementation, the pathloss function takes into account communication-specific pathloss, while an alternative implementation may consider both sensing-specific pathloss and communication-specific pathloss. The sensing-specific pathloss function may account for unique characteristics of sensing operations, such as the two-way propagation path (e.g., transmitter to target to receiver), RCS of the sensing target, multipath propagation effects in the sensing environment, and frequency-dependent scattering characteristics. For example, the pathloss function may be calculated as a function of carrier frequency, first pathloss between the transmitting device and sensing target, second pathloss between the sensing target and receiving device, RCS of the sensing target, estimated shadow fading between the transmitting device and sensing target, and estimated shadow fading between the receiving device and sensing target. The transmitting and receiving device 802 may also consider environmental factors, such as atmospheric attenuation and interference from other radio frequency sources when determining the pathloss function for power control.

At 818, the transmitting and receiving device 802 may report the sensing-specific pathloss, communication-specific pathloss, or both sensing-specific pathloss and communication-specific pathloss to the NE 102-d. The report may be solicited by the requesting entity or may be unsolicited (e.g., may not be requested). Associated information with the pathloss may include timestamp, pathloss margins and/or uncertainty, quality indicators and related parameters. The pathloss report may include per-path pathloss measurements for different reflection paths, statistical characteristics of the pathloss measurements (e.g., mean, variance, confidence intervals), frequency-dependent pathloss variations, and environmental context information. For example, the report may indicate pathloss measurements for different sensing targets, beam-specific pathloss values for different transmission and reception beam pairs, and temporal variations in pathloss due to target movement or environmental changes. The report may also include recommendations for transmit power adjustments based on the measured pathloss characteristics and sensing performance criterion.

At 820, the transmitting and receiving device 802 may compute or determine the transmit power based in part on the pathloss function and various other parameters, such as maximum allowable transmit power, self-interference, co-site or inter-site interference, or other interference considerations. For example, the transmitting and receiving device 802 may determine transmit power updates based on pathloss associated with sensing targets, maximum received self-interference power, saturation power level, isolation level between transmitter and receiver components, and configured maximum transmit power for sensing and communication operations. The power determination may be performed on a per-resource basis according to the time-frequency resource identifiers, where different transmit power levels may be applied to different REs, resource sets, frequency layers, or carrier frequencies. The device may also consider beam-specific power adjustments, where different power levels are applied for different transmit beam, receive beam, or transmit-receive beam pair combinations to improve sensing performance, while managing interference.

At 822, the transmitting and receiving device 802 may report the determined transmit power to the NE 102-d. This report may be solicited by the requesting entity or unsolicited. Associated information with the transmit power may include timestamp and transmission related parameters. The transmit power report may provide information about the determined transmit power, including the transmit power levels applied to different time-frequency resources, the factors for determining the power adjustments (e.g., pathloss compensation, interference mitigation), and performance metrics achieved with the selected transmit power levels. For example, the report may include per-resource transmit power values, beam-specific power settings, power headroom information indicating remaining transmit power capability, and performance metrics (e.g., achieved SNR or target detection performance). The report may also include recommendations for future power control parameter updates based on the observed sensing performance and changing environmental conditions. Additionally, or alternatively, the report may indicate a duration for which the transmit power settings are to be applied, such as for TTIs (e.g., including sub-symbols, symbols, sub-slots, slots, subframes, frames, system frames, hyper frames, or time durations corresponding to sensing signaling).

In some examples, the transmit power level associated with a monostatic sensing operation is determined autonomously by the transmitting device and receiving device and, in some examples, based on additional limitations of the transmit power which are known or indicated by the SMF. In some such examples, the generated measurements based on the monostatic sensing are reported, together with the determined transmit power level (e.g., RTT and/or RSRPP of the detected sensing path is reported together with the transmitted power associated with the sensing resource). The autonomous power determination in monostatic sensing may consider the relative distance between the device and sensing target, the direction of the device relative to the sensing target, and the specific characteristics of the monostatic sensing scenario such as self-interference levels and isolation between transmit and receive components.

In some examples, the power of a sensing signal is determined based on the estimate of the pathloss of an interference path or interference power generated on reception of other signals at one or more receiver nodes. In some such examples, the interference channel pathloss is determined via a prior transmission of a reference signal by a device experiencing interference and estimation of the corresponding channel pathloss. In some examples, subsequent to the determination of the interference channel pathloss, the transmit power level is determined such that the transmit power does not exceed an allowed or tolerable received interference level at the device experiencing the interference. The interference-aware power control may involve coordination between multiple sensing devices to minimize inter-site interference while maintaining adequate sensing performance. For example, devices may exchange interference measurements and coordinate transmit power levels to ensure that a cumulative interference at a receiving device remains below one or more threshold values.

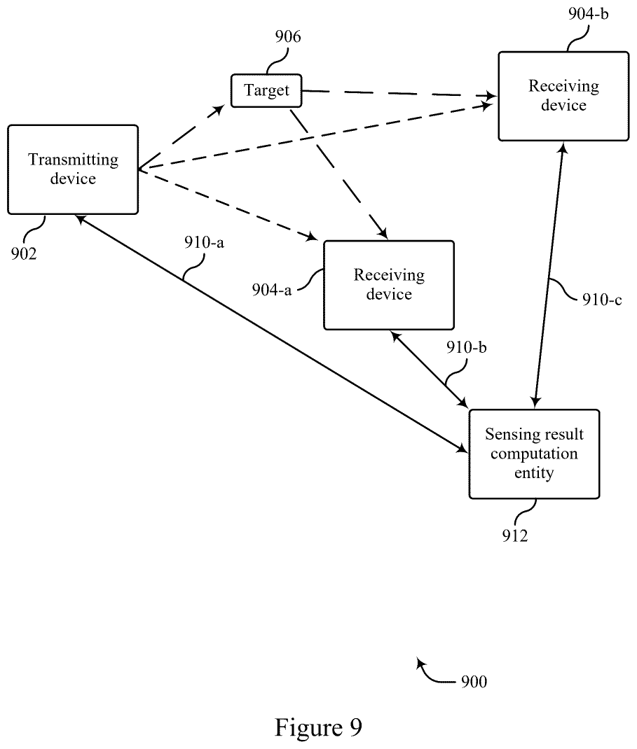

FIG. 9 illustrates an example of a wireless communications system 900 in accordance with aspects of the present disclosure. In some examples, the wireless communications system 900 implements or is implemented by aspects of the wireless communications system 100, the wireless communications system 200, the wireless communications system 300, the network architecture diagram 400, the transmission diagram 500, the wireless communications system 600, the process flow 700, and the signaling diagram 800. For example, the wireless communications system 900 may include a transmitting device 902, a receiving device 904-a, and a receiving device 904-b, which may be examples of one or more NEs (e.g., base stations, gNBs, TRPs, or other NEs) and UEs, as described with reference to FIGS. 1 through 8.

The signaling may be directed towards a target 906 (e.g., a sensing target), and may be an example of one or more sensing transmissions 908. The sensing transmissions 908 may include any numerical quantity of transmissions. A sensing transmission 908 may include, but is not limited to, a reference signal transmission, a data transmission, and/or a control information transmission (e.g., control signaling) that is part of or related to a sensing mode of operation to detect the target 906. The wireless communications system 900 may include a communication link 910-a to enable communication between the transmitting device 902 and a sensing result computation entity 912, a communication link 910-b to enable communication between the receiving device 904-a and the sensing result computation entity 912, and/or a communication link 910-c to enable communication between the receiving device 904-b and the sensing result computation entity 912. The sensing result computation entity 912 may be an example of an NE that manages measurements collected via sensing operations and/or one or more configurations related to the sensing operations. The communication link 910-a through the communication link 910-c may be examples of wired, such as physical connections, or wireless connections, such as for over-the-air communications.

In some examples, adaptive power control procedures and mechanisms may be developed for bistatic and multi-static sensing modes of operation to detect and/or track a target 906 in a robust and accurate manner. The adaptive power control procedures can enable enhanced detection coverage of targets (e.g., the target 906) depending on a distance between a transmitting device 902 and one or more receiving devices (e.g., the receiving device 904-a and the receiving device 904-b). Further, bistatic interference (I_{bistatic}) may be defined according to Equation 9:

$${I}_{bistatlc} = {\sum }_{n = 1}^{N} {I}_{Other - TRP}^{n} + {I}_{T C} + {I}_{B C} , \qquad ( 9 )$$

where

$${I}_{Other - TRPs , dB}^{n}$$

is a total inter-site interference component from a total of N TRPs. I_{TC,dB} and I_{BC,dB} are interfering signals from target specific channels and interfering signals from the background channel, respectively, of a transmitting device 902 and receiving device pair (e.g., the receiving device 904-a and the receiving device 904-b).

In some cases, the

$${I}_{Other - TRPs , dB}^{n}$$

component may be suppressed or controlled (e.g., managed) in the presence of other bistatic and/or multi-static sensing signals depending on a type of configured power control scheme. In some other cases, the transmissions may be utilized to obtain delay, angle, and/or Doppler profiles of a same sensing target (e.g., the target 906). The transmitting device 902 may be an example of an NE, a TRP, or a UE. Additionally, or alternatively, the receiving device 904-a and the receiving device 904-b may be examples of any combination of NEs, TRPs, and/or UEs (e.g., a TRP-TRP bistatic or multi-static sensing scenario, or a UE-UE bistatic or multi-static sensing scenario, among other examples). The receiving device 904-a and the receiving device 904-b may be susceptible to LOS interference from the transmitting device 902.

In some cases, the transmitting device 902 may be configured to perform inter-site sensing measurements from other transmitting devices based on a received interference reference signal used for sensing purposes or communications purposes. The measured inter-site sensing measurements can be reported to a requesting entity or node (e.g., a transmitting device equipped with an SMC either in the NG-RAN or UE or by a centralized sensing configuration and result computation entity residing in the CN, including a sensing function, an SensMF, or the sensing result computation entity 912).

The transmitting device 902 (e.g., a TRP, gNB, base station, or UE) can control or adapt a transmitted power depending on a measured pathloss towards one or more sensing targets (e.g., the target 906). Considering a sensing or radar pathloss is defined by Equation 10:

$$P {L}_{s e n s i n g} ( {d}_{1} , {d}_{2} ) = P L ( {d}_{1} ) + P L ( {d}_{2} ) + {log}_{10} ( \frac{{λ}^{2}}{4 π} ) - 10 {log}_{10} ( {σ}_{R C S} ) + S {F}_{dB , 1} + S {F}_{dB , 2} , \qquad ( 10 )$$

where d₁ is the sensing transmitter to sensing target distance, d₂ is the sensing target to sensing receiver distance, λ is the wavelength of the transmitted signal, σ_{RCS} is the RCS of the sensing target and SF_{dB,1} and SF_{dB,2} are the shadow fading parameters generated for the transmitting device-sensing target link and sensing target-receiving device link, respectively. For bistatic sensing, PL_{dB}(d₁)=PL_{dB}(d₂),SF_{dB,1}=SF_{dB,2} or PL_{dB} (d₁)≠PL_{dB}(d₂),SF_{dB,1}≠SF_{dB,2}. The transmitting device 902 performs sensing or radar pathloss compensation to overcome the pathloss experienced over d₁ and d₂ distances to reliably detect one or more sensing targets. The transmitting device 902 may implement enhanced transmit power adaptation schemes to improve signal quality in sensing modes of operation.

The sensing power control procedure may depend on the measured bistatic or multi-static pathloss, which can be applicable to a UE, an NE, and/or a TRP involved in bistatic or multistatic scenarios. The following power control procedure may be applied for adapting the bistatic transmit power depending on the application or scenario (e.g., performing detection or performing tracking including position estimation and velocity estimation). An adaptive power control scheme for a single transmitting device (e.g., an NE, a UE, or a TRP) is given according to Equations 11 and 12:

P_{Bistatic-Sense-Tx,Beam1}=min{P_{csmax},P_{Tx,Beam1,PL}} (11)

P_{Bistatic-Sense-Tx,Beam2}=min{P_{csmax},P_{Tx,Beam2,PL}}. (12)

The transmit power can be adjusted per transmit beam basis taking into account that d₂ with respect to the receiving device 904-a may differ for d₂ with respect to the receiving device 904-b. For two receiving devices, the power is adapted for two beams, including beam 1 and beam 2. The power adaptation can be extended up to N beams depending on a UE, an NE, or TRP capability. Each transmit beam aims to improve the sensing signal for each receiving device, giving rise to Equations 13 and 14:

P_{Tx,Beam1,PL}=P_{0,Rx1}+10 log₁₀(2^{μ}M)+β_{2-way}PL_{Tx,Beam1,sensing}+Δₛₑₙₛₑ (13)

P_{Tx,Beam2,PL}=P_{0,Rx2}+10 log₁₀(2^{μ}M)+β_{2-way}PL_{Tx,Beam2,sensing}+Δₛₑₙₛₑ (14)

The transmit power per beam scheme may also consider the pathloss compensation power mismatch at a receiving device depending on a receiving device beam used to receive and/or measure the echo or backscattered signal form the target 906 to one or more defined transmit beams.

P_{0,Rx1} and P_{0,Rx2} are defined (e.g., configured, pre-configured) received target powers assuming compensation of the full pathloss, which can be provided to the receiving device 904-a and receiving device 904-b via an interface depending on a receiver type (e.g., NE, TRP, or UE) or may be received from a distributed sensing SMC either in the NG-RAN or UE or by a centralized sensing configuration and result computation entity residing in the CN (e.g., sensing function, SensMF, or sensing result computation entity 912), μ and M are the SCS and number of PRBs, as defined earlier, β_{2-way} is a toggling factor with a value range β_{2-way}={0,1} enabling or disabling pathloss compensation for adapting the transmit power, and Δₛₑₙₛₑ is the closed-loop power parameter to progressively adapt the power for sensing purposes, which can also be referred to as a sensing transmit power command (STPC). P_{Bistastic-Sense-Tx1} and P_{Bistastic-Sense-Tx2} may be applied over a configured TTI (e.g., set of symbols, sub-slots, mini-slots, slots, subframes, frames, system frames, hyper frames, and so forth).

In some examples, the beam correspondence holds between the transmit and receive beams of the transmitting device and receiving device measurements for each sensing target. In some other examples, the transmit and receive power are measured including the impact of the spatial directivity addition by the transmit and receive beams towards the path associated with the n-th sensing target. If the transmit beam is associated with Xₙ-times higher energy density towards the path associated with sensing target compared to the beam utilized to perform receive power and/or pathloss measurements, then the transmit power is determined according to Equation 15:

$${P}_{Monostatic - S e n s e - T x} = min \{ {P}_{cs max} , \frac{{P}_{Tx , PL}}{{X}_{n}} \} \qquad ( 15 )$$

In some examples, upon determination of a transmit power level according to the adjustments for pathloss compensation, the determined transmit power for each beam or target is reported to the sensing controller or aggregator (e.g., the sensing result computation entity 912) or to the receiving device associated with the reception or measurement of the sensing signal with adjusted transmit power (e.g., the receiving device 904-a or the receiving device 904-b).

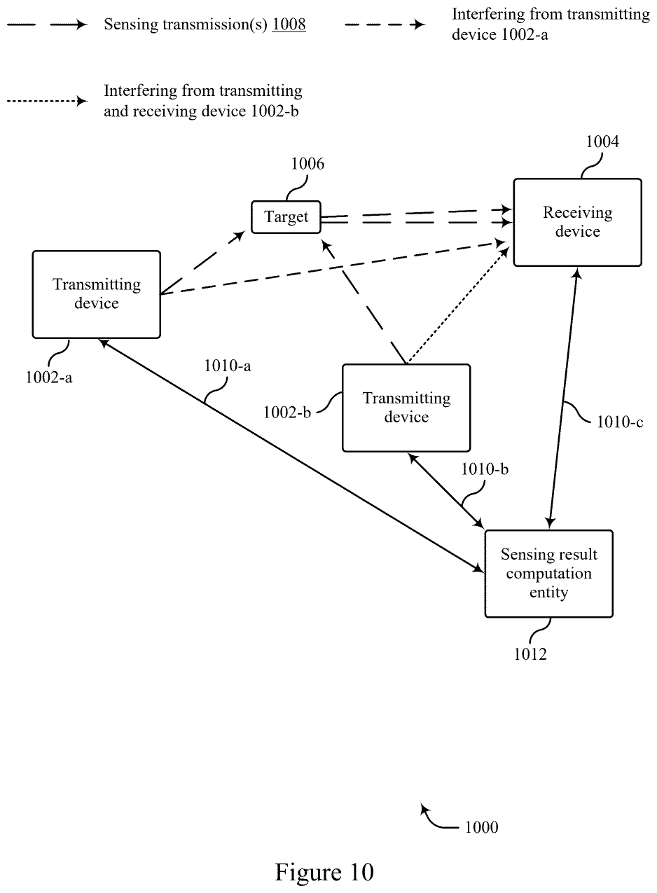

FIG. 10 illustrates an example of a wireless communications system 1000 in accordance with aspects of the present disclosure. In some examples, the wireless communications system 1000 implements or is implemented by aspects of the wireless communications system 100, the wireless communications system 200, the wireless communications system 300, the network architecture diagram 400, the transmission diagram 500, the wireless communications system 600, the process flow 700, the signaling diagram 800, and the wireless communications system 900. For example, the wireless communications system 1000 may include a transmitting device 1002-a, a transmitting device 1002-b, and a receiving device 1004, which may be examples of one or more NEs (e.g., base stations, gNBs, TRPs, or other NEs) and UEs, as described with reference to FIGS. 1 through 9.

The signaling may be directed towards a target 1006 (e.g., a sensing target), and may be an example of one or more sensing transmissions 1008. The sensing transmissions 1008 may include any numerical quantity of transmissions. A sensing transmission 1008 may include, but is not limited to, a reference signal transmission, a data transmission, and/or a control information transmission (e.g., control signaling) that is part of or related to a sensing mode of operation to detect the target 1006. The wireless communications system 1000 may include a communication link 1010-a to enable communication between the transmitting device 1002-a and a sensing result computation entity 1012, a communication link 1010-b to enable communication between the transmitting device 1002-b and the sensing result computation entity 1012, and/or a communication link 1010-c to enable communication between the receiving device 1004 and the sensing result computation entity 1012. The sensing result computation entity 1012 may be an example of an NE that manages measurements collected via sensing operations and/or one or more configurations related to the sensing operations. The communication link 1010-a through the communication link 1010-c may be examples of wired, such as physical connections, or wireless connections, such as for over-the-air communications.

The wireless communications system 1000 illustrates an example of a bistatic and/or multistatic mode of operation, where the receiving device 1004 is susceptible to LOS interference from the transmitting device 1002-a and the transmitting device 1002-b. The transmitting device 1002-a and/or the transmitting device 1002-b may be an example of any combination of UEs, NEs, or TRPs. Additionally, or alternatively, the receiving device 1004 may be an example of a UE, an NE, or a TRP. The adaptive power control scheme for the transmitting device 1002-a and the transmitting device 1002-b is given according to Equations 16 and 17, respectively:

P_{Bistatic-Sense-Tx1}=min{P_{csmax},P_{Tx1,PL}} (16)

P_{Bistatic-Sense-Tx2}=min{P_{csmax},P_{Tx2,PL}}, (17)

where P_{csmax} may be applicable to a UE with relatively strict power transmit limits (e.g., less than a threshold maximum transmit power). In some cases, NEs (e.g., base stations) and/or TRPs may consider energy criterion and usage, and a configured P_{csmax} may also be set for TRPs or base stations (e.g., as opposed to a fixed upper bound transmit power limit applicable only to UEs in the context of more energy efficient communication or sensing). In some cases, P_{csmax} is dependent on a power class of a transmitter, providing for maximum power reduction, EIRP.

The transmit power based on the pathloss at the transmitting device 1002-a (P_{Tx1,PL}) and the transmitting device 1002-b (P_{Tx2,PL}) are defined according to Equations 18 and 19:

P_{Tx1,PL}=P_{0,Rx}+10 log₁₀(2^{μ}M)+β_{2-way}PL_{Tx1,sensing}+Δₛₑₙₛₑ (18)

P_{Tx2,PL}=P_{0,Rx}+10 log₁₀(2^{μ}M)+β_{2-way}PL_{Tx2,sensing}+Δₛₑₙₛₑ, (19)

where P_{0,Rx} is a defined (e.g., pre-configured, configured) received target power assuming compensation of the full pathloss, which can be provided to the receiving device 1004 via an interface depending on a receiver type (e.g., TRP or UE) or may be received from a distributed sensing SMC either in the NG-RAN or UE or by a centralized sensing configuration and result computation entity residing in the CN (e.g., a sensing function, SensMF, or the sensing result computation entity 1012), μ and M are the subcarrier spacing and a number of PRBs, β_{2-way} is a toggling factor with a value range β_{2-way}={0,1} enabling or disabling pathloss compensation for adapting the monostatic transmit power, and Δₛₑₙₛₑ is a closed-loop power parameter to adapt the power for sensing purposes, which can also be referred to as a STPC. P_{Bistastic-Sense-Tx1} and P_{Bistastic-Sense-Tx2} may be applied over a configured TTI (e.g., set of symbols, sub-slots, mini-slots, slots, subframes, frames, system frames, hyper frames, and so forth).

A pre-detection (e.g., prior to detecting the target 1006) transmit power control for transmitting device 1002-a and transmitting device 1002-b can be described in terms of adapting the power control prior to detection of a target 1006 to meet a detection criterion (e.g., SSNR or SNR), which is independent of the sensing pathloss. The receiving device 1004 performs a measurement associated with one or more reflected or echo paths of a target 1006, where the measurement may include one or more of a measured SSNR, SNR, RSRP, RSRPP, Doppler-delay path profile, range-Doppler profile, or angle-delay profile, among other examples. The receiving device 1004 may report one or more of the measurement metrics to the transmitting devices or centralized sensing configuration entity (e.g., the sensing result computation entity 1012). The transmitting devices or the centralized sensing configuration entity mazy compare the received measurements with one or more target measurements (e.g., target SNR or SSNR). The transmitting devices may then ramp up or ramp down a transmit power according to a delta between the received or measured measurements and target measurements. The ramp up or ramp down of the transmit power may be configured steps. The power control mechanism is rather dependent on the measured SNR or SSNR as opposed to the pathloss.

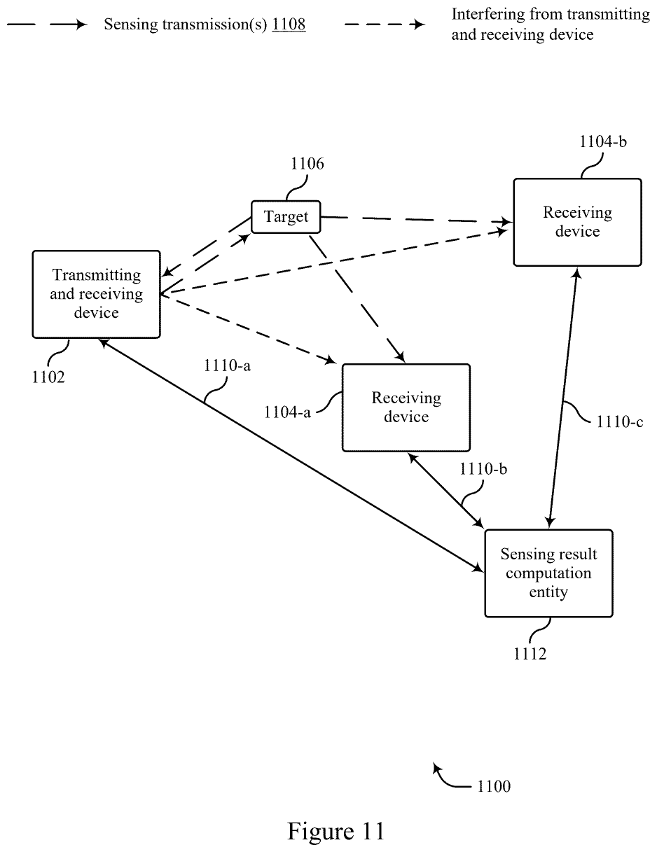

FIG. 11 illustrates an example of a wireless communications system 1100 in accordance with aspects of the present disclosure. In some examples, the wireless communications system 1100 implements or is implemented by aspects of the wireless communications system 100, the wireless communications system 200, the wireless communications system 300, the network architecture diagram 400, the transmission diagram 500, the wireless communications system 600, the process flow 700, the signaling diagram 800, the wireless communications system 900, and the wireless communications system 1000. For example, the wireless communications system 1100 may include a transmitting and receiving device 1102, a receiving device 1104-a, and a receiving device 1104-b, which may be examples of one or more NEs (e.g., base stations, gNBs, TRPs, or other NEs) and UEs, as described with reference to FIGS. 1 through 10.

The signaling may be directed towards a target 1106 (e.g., a sensing target), and may be an example of one or more sensing transmissions 1108. The sensing transmissions 1108 may include any numerical quantity of transmissions. A sensing transmission 1108 may include, but is not limited to, a reference signal transmission, a data transmission, and/or a control information transmission (e.g., control signaling) that is part of or related to a sensing mode of operation to detect the target 1106. The wireless communications system 1100 may include a communication link 1110-a to enable communication between the transmitting and receiving device 1102 and a sensing result computation entity 1112, a communication link 1110-b to enable communication between the receiving device 1104-a and the sensing result computation entity 1112, and/or a communication link 1110-c to enable communication between the receiving device 1104-b and the sensing result computation entity 1112. The sensing result computation entity 1112 may be an example of an NE that manages measurements collected via sensing operations and/or one or more configurations related to the sensing operations. The communication link 1110-a through the communication link 1110-c may be examples of wired, such as physical connections, or wireless connections, such as for over-the-air communications.

The wireless communications system 1100 illustrates an example of a bistatic and multistatic mode of operation in a same scenario. The transmitting and receiving device 1102 may be an example of an example of a UE, NE, or TRP. Additionally, or alternatively, the receiving device 1104-a and the receiving device 1104-b may be any combination of UEs, NEs, or TRPs. The transmitting and receiving device 1102 may use any one or more of the methods described in FIGS. 6 through 10 to determine the transmit power control, taking into account the self-interference and other interference.

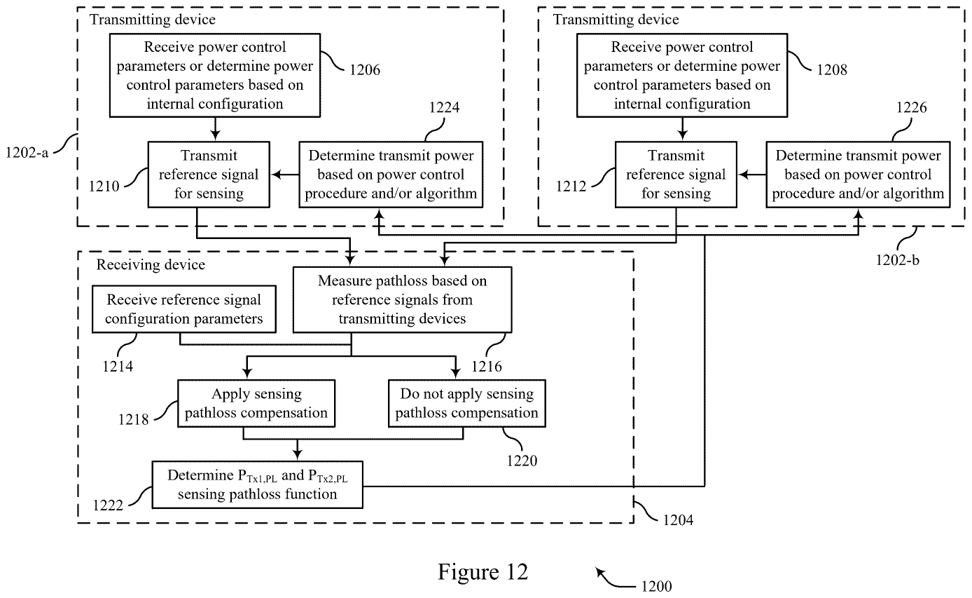

FIG. 12 illustrates an example of a process flow 1200 in accordance with aspects of the present disclosure. In some examples, the process flow 1200 implements or is implemented by aspects of the wireless communications system 100, the wireless communications system 200, the wireless communications system 300, the network architecture diagram 400, the transmission diagram 500, the wireless communications system 600, the process flow 700, the signaling diagram 800, and the wireless communications system 900 through the wireless communications system 1100. The process flow 1200 may implement or be implemented by a transmitting device 1202-a, a transmitting device 1202-b, and a receiving device 1204, which may be examples of transmitting devices and a receiving device, as described with reference to FIGS. 1 through 11. For example, the process flow 1200 includes an example of a power control procedure for a bistatic or multistatic sensing mode of operation, where multiple transmitting devices coordinate with a single receiving device to perform sensing operations. Alternative examples of the following may be implemented, where some processes are performed in a different order than described or are not performed. In some cases, processes may include additional features not mentioned below, or further processes may be added.

At 1206 and 1208, the transmitting device 1202-a and the transmitting device 1202-b, respectively, may receive power control parameters from another entity, including a distributed sensing SMC either in an NG-RAN or UE or by a centralized sensing configuration and result computation entity residing in the CN (e.g., sensing function, SensMF, or sensing result computation entity). Additionally, or alternatively, the transmitting device 1202-a and the transmitting device 1202-b may select default settings for one or more power control parameters depending on internal configurations or from a pre-configuration. The power control parameters may be received via higher layer signaling (e.g., NAS or RRC signaling), MAC-CEs, DCI, UCI, or SCI. Exemplary power control parameters may include, but are not limited to, beam-specific power adjustments for bistatic configurations, inter-transmitter coordination parameters, maximum transmit power limits per transmitting device, interference mitigation factors between multiple transmitters, and target received power levels at the receiving device 1204. In some cases, the power control parameters may be coordinated between the transmitting device 1202-a and the transmitting device 1202-b to reduce interference while maintaining sensing performance.

At 1210 and 1212, the transmitting device 1202-a and the transmitting device 1202-b, respectively, may transmit initial sensing transmissions, such as a reference signal or multiple reference signals for sensing purposes. The sensing transmissions may be used for detection and/or tracking of one or more targets in a bistatic or multistatic configuration. The transmission at 1210 and/or at 1212 may include a reference signal used for communication other than sensing, sensing, or communication other than sensing and sensing. The reference signal may be used to measure at least the sensing pathloss reference, which will be then used to determine the required transmit power to detect and/or track the object. The sensing transmissions may include orthogonal or semi-orthogonal reference signals to enable the receiving device 1204 to distinguish between signals from different transmitting devices. The initial sensing transmissions may be characterized by coordinated time-frequency resource allocations, distinct resource identifiers for each transmitting device, synchronized or offset timing patterns, beam-specific configurations, time-frequency resource locations, one or more time-frequency patterns, bandwidth, periodicity, and time and frequency offset with respect to slot and RE, respectively.

For the initial transmission, a default reference signal configuration may depend on the deployment of the network, inter-site distance between neighboring TRPs, distance between the UE and TRP, or geometry of the various anchor nodes (e.g., TRPs and/or UEs). For example, the transmitting device 1202-a may transmit a PRS with a first sequence identifier, while the transmitting device 1202-b may transmit a PRS with a second sequence identifier, enabling the receiving device 1204 to perform separate pathloss measurements for each transmit-target-receive path. Exemplary reference signals may include PRSs, SeRSs, SRSs, CSI-RS, TRS, DMRS, SSB, or other reference signals. The transmissions may utilize coordinated waveforms, such as time-division multiplexed OFDM signals or frequency-division multiplexed sensing signals to reduce or avoid interference between transmitting devices. In some cases, the transmitting device 1202-a and transmitting device 1202-b may transmit the reference signal based on a target SSNR (e.g., not dependent on the sensing pathloss) to achieve one or more target metrics, such as probability of detection, probability of false alarm, or probability of missed detection.

At 1214, the receiving device 1204 may receive reference signal configuration parameters from both the transmitting device 1202-a and the transmitting device 1202-b, which can be used as input for computing sensing pathloss functions for multiple transmit-target-receive paths. The configuration parameters may include beam-specific information for each transmitting device, antenna array characteristics, calibration data for accurate pathloss estimation, and coordination information to enable proper signal separation and processing. Additionally, or alternatively, sensing-specific parameters, such as σ_{RCS}, may also be provided to the receiving device 1204 to be used to compute the sensing pathloss functions, P_{Tx1,PL} and P_{Tx2,PL}. Such sensing-specific parameters may include expected RCS characteristics of targets, target velocity estimates, multipath channel characteristics for each transmit path, and environmental clutter statistics. The configuration parameters may also include timing synchronization information to enable coherent processing of signals from multiple transmitting devices and interference cancellation parameters to mitigate cross-transmitter interference. In some examples, the measurement of the sensing pathloss and/or computation of the adjusted transmit power level is done subsequent to a determination or detection of a target being present, detection of a propagation path associated with a sensing target, and thereby the measurement or determination of the pathloss and/or receive or transmit power levels are done after the determination of the sensing target being present and/or the measured path is associated with scattering of a sensing target of interest. In some cases, the indication of the target being present is further received from a sensing controller and/or aggregator entity.

At 1216, the receiving device 1204 may measure pathloss references based on the received sensing transmissions from both the transmitting device 1202-a and the transmitting device 1202-b. The receiving device 1204 may separately measure the pathloss reference based on the received reference signals from transmitting device 1202-a and transmitting device 1202-b, respectively. The pathloss references may be used to compute separate sensing pathloss functions, P_{Tx1,PL} and P_{Tx2,PL}, for each transmit-target-receive path in the bistatic or multistatic configuration. The pathloss references may be used in the context of the measured received power or path power to compute the sensing transmit power based on pathloss functions. The pathloss measurements may account for different propagation characteristics for each transmitting device, including varying LOS and NLOS conditions, multipath fading effects specific to each transmit path, and frequency-dependent propagation characteristics. The receiving device 1204 may perform measurements across multiple spatial directions and beam configurations to obtain comprehensive pathloss characterization for each transmitting device. The pathloss references may be measured separately for different transmitting devices using signal separation techniques, such as sequence-based identification or time-division processing.

At 1218 and 1220, the receiving device 1204 may autonomously choose or be configured to apply pathloss compensation for each transmitting device independently via respective β_{2-way} parameters. The selection provides for independent configuration of the pathloss compensation for each transmitting device. The decision to apply or not apply pathloss compensation may be based on sensing mode criterion, target detection criterion (e.g., a probability of missed detection or a probability of detection) for each transmit path, interference levels between transmitting devices, or network configuration. At 1218, when pathloss compensation is applied for the transmitting device 1202-a, the receiving device 1204 may use the β_{2-way} parameter to adjust the recommended transmit power based on the two-way pathloss experienced by the sensing signal from the transmitting device 1202-a. At 1220, similar pathloss compensation processing may be applied for the transmitting device 1202-b. The choice between the approaches may be dynamically determined based on real-time channel conditions for each transmit path, sensing performance criterion, or interference management considerations between multiple transmitting devices.

At 1222, the receiving device 1204 may compute or determine separate sensing pathloss functions, P_{Tx,PL} and P_{Tx2,PL}, for each transmitting device or perform detection measurements based on SNR, SSNR, SSINR, or SINR for each transmit-target-receive path. The sensing pathloss functions may incorporate various factors specific to each transmitting device, including distance-dependent pathloss for each transmit path, frequency-dependent attenuation, RCS characteristics of sensing targets as observed from different transmit angles, and multipath propagation effects unique to each transmit-target-receive geometry. The computation may utilize algorithms, such as joint maximum likelihood estimation across multiple transmit paths, Bayesian inference with prior knowledge of transmitter locations, or machine learning approaches trained on multi-transmitter sensing scenarios. The receiving device 1204 may also perform additional measurements, such as differential AoA estimation using signals from multiple transmitting devices, multi-path ToF measurements, and joint Doppler shift analysis to enhance the sensing pathloss functions.

At 1224 and 1226, the receiving device 1204 may share the outcomes of the sensing pathloss functions for the transmitting device 1202-a and the transmitting device 1202-b, respectively, and/or interference mitigation schemes with the respective transmitting devices to determine transmit powers, P_{Bistatic-Sense-Tx1} and P_{Bistatic-Sense-Tx2}. The receiving device 1204 may share or report the outcome of the sensing transmit powers based on pathloss functions, P_{Tx1,PL} and P_{Tx2PL}, or based on detection measurements, such as SSNR, SNR, SINR, or SSINR, with transmitting device 1202-a and transmitting device 1202-b, respectively, to determine the desired transmit powers based on the information received from the receiver. The information sharing may occur through various signaling mechanisms, including UCI, MAC-CEs, RRC signaling, dedicated sensing control channels, or sensing protocols (e.g., based on NAS signaling) that can address multiple transmitting devices. The receiving device 1204 may provide separate power control recommendations for the transmitting device 1202-a and the transmitting device 1202-b based on respective pathloss measurements and interference contributions. The shared information may include per-transmitter pathloss measurements, interference levels caused by each transmitting device, recommended power adjustments to optimize sensing performance, and coordination information to minimize mutual interference between transmitting devices. In some cases, the sensing transmit powers, P_{Bistatic-Sense-Tx1} and P_{Bistatic-Sense-Tx2}, may be first reported to a distributed sensing SMC either in the NG-RAN or UE or by a centralized sensing configuration and result computation entity residing in the CN, such as sensing function or SensMF. The respective transmit powers may be determined in part due to the receiving device saturation power supported by the receiver and further the achievable isolation level between transmit and receive chains. The transmitter may determine the power control based on the pre-detection power control mechanism, which is independent of the pathloss for sensing.

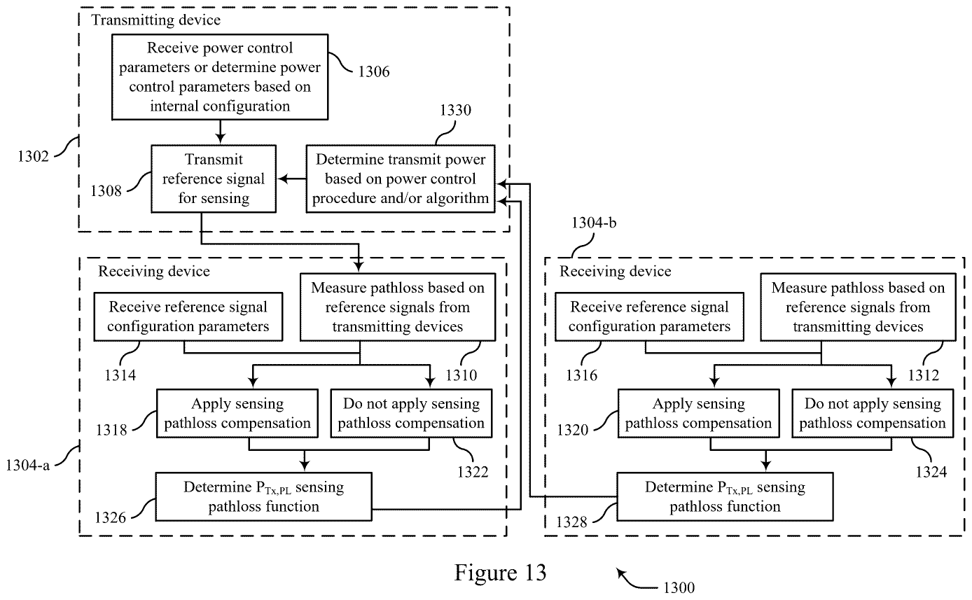

FIG. 13 illustrates an example of a process flow 1300 in accordance with aspects of the present disclosure. In some examples, the process flow 1300 implements or is implemented by aspects of the wireless communications system 100, the wireless communications system 200, the wireless communications system 300, the network architecture diagram 400, the transmission diagram 500, the wireless communications system 600, the process flow 700, the signaling diagram 800, the wireless communications system 900 through the wireless communications system 1100, and the process flow 1200. The process flow 1300 may implement or be implemented by a transmitting device 1302, a receiving device 1304-a, and a receiving device 1304-b, which may be examples of a transmitting device and receiving devices, as described with reference to FIGS. 1 through 12. For example, the process flow 1300 includes an example of a power control procedure for a bistatic sensing mode of operation, where a single transmitting device coordinates with multiple receiving devices to perform sensing operations. Alternative examples of the following may be implemented, where some processes are performed in a different order than described or are not performed. In some cases, processes may include additional features not mentioned below, or further processes may be added.

At 1306, the transmitting device 1302 may receive power control parameters from another entity, including a distributed sensing SMC either in an NG-RAN or UE or by a centralized sensing configuration and result computation entity residing in the CN (e.g., sensing function, SensMF, or sensing result computation entity). Additionally, or alternatively, the transmitting device 1302 may select default settings for one or more power control parameters depending on an internal configuration or from a pre-configuration. The power control parameters may be received via higher layer signaling (e.g., NAS or RRC signaling), MAC-CEs, DCI, UCI, SCI, or any other control signaling. Exemplary power control parameters may be one or parameters described in the P_{Bistatic-Sense-Tx,Beam1} or p_{Bistatic-Sense-Tx,Beam2} procedures (e.g., P_{0,Rx1} and/or P_{0,Rx2}). For example, the power control parameters may include, but are not limited to, beam-specific power adjustments for bistatic configurations, coordination parameters for multiple receiving devices, maximum transmit power limits, interference mitigation factors for multi-receiver scenarios, and target received power levels at each receiving device. In some cases, the power control parameters may be different for each receiving device to account for varying channel conditions and sensing criterion at the receiving devices.

At 1308, the transmitting device 1302 may transmit initial sensing transmissions, such as a reference signal or multiple reference signals for sensing purposes. The sensing transmissions may be used for detection and/or tracking of one or more targets in a bistatic configuration with multiple receiving devices. The sensing transmissions may include a reference signal used for communication other than sensing, sensing, or communication other than sensing and sensing. The reference signal may be used to measure at least the sensing pathloss reference, which is then used to determine a transmit power utilized to detect and/or track the object. The sensing transmissions may be configured to enable both receiving devices to perform separate measurements, while minimizing interference. The initial sensing transmissions may be characterized by coordinated time-frequency resource allocations, beam patterns optimized for multiple receiver coverage, synchronized timing patterns, and power levels that account for different propagation paths to each receiving device. For the initial transmission, a default reference signal configuration may depend on a deployment of the network, inter-site distances between the transmitting device and receiving devices, geometry of the various nodes, and expected sensing target characteristics. Exemplary reference signals may include PRSs, SeRSs, SRSs, CSI-RSs, TRSs, DMRSs, SSBs, or other reference signals. The transmissions may utilize waveforms for multi-receiver sensing scenarios, such as coordinated OFDM signals or frequency-division multiplexed sensing signals. In some cases, the transmitting device 1302 may transmit the reference signal based on a target SSNR (e.g., not dependent on the sensing pathloss) to achieve one or more target metrics, such as probability of detection, probability of false alarm, or probability of missed detection.

At 1310 and 1312, the receiving device 1304-a and the receiving device 1304-b may measure pathloss references based on the received sensing transmissions from the transmitting device 1302. Each receiving device may separately measure the pathloss reference based on the received reference signals, accounting for respective propagation environments and geometric relationships with the transmitting device 1302 and sensing targets. The pathloss references may be used to compute separate sensing pathloss functions for each transmit-target-receive path in the bistatic configuration. The pathloss references may be used in the context of the measured received power or path power to compute the sensing transmit power based on pathloss functions. The pathloss measurements may account for different propagation characteristics for each receiving device, including varying LOS and NLOS conditions, multipath fading effects specific to each receive path, frequency-dependent propagation characteristics, and spatial diversity effects. Each receiving device may perform measurements across multiple spatial directions and beam configurations to obtain comprehensive pathloss characterization. The pathloss references may be measured using signal processing techniques for the receiving device capabilities and environmental conditions.

At 1314 and 1316, the receiving device 1304-a and the receiving device 1304-b, respectively, may receive transmit configuration parameters from the transmitting device 1302, which can be used as input for computing sensing pathloss functions (e.g., P_{Tx,Beam1,PL} and P_{Tx,Beam2,PL}) for respective transmit-target-receive paths. The configuration parameters, such as σ_{RCS}, may include beam-specific information for the transmitting device, antenna array characteristics, calibration data for accurate pathloss estimation, and coordination information to enable proper signal processing at each receiving device. Additionally, or alternatively, sensing-specific parameters may also be provided to the receiving devices to be used to compute the sensing pathloss functions. Such sensing-specific parameters may include expected RCS characteristics of targets, target velocity estimates, multipath channel characteristics for each receive path, and environmental clutter statistics. The configuration parameters may also include timing synchronization information to enable coherent processing of signals from the transmitting device 1302 and interference coordination parameters to manage potential interference between the receiving devices. In some examples, the measurement of the sensing pathloss and/or computation of the adjusted transmit power level is done subsequent to a determination or detection step of a target being present, detection of a propagation path associated with a sensing target, and thereby the measurement or determination of the pathloss and/or receive and transmit power levels are done after the determination of the sensing target being present and/or the measured path is associated with scattering of a sensing target of interest. In some cases, the indication of the target being present is received from a sensing controller and/or aggregator entity.

At 1318, 1320, 1322, and 1324, the receiving device 1304-a and the receiving device 1304-b may autonomously choose or be configured to apply pathloss compensation independently via respective #_{2-way} parameters. The procedure provides for independent configuration of the pathloss compensation for each receiving device based on individual channel conditions and sensing criterion. The decision to apply or not apply pathloss compensation may be based on sensing mode criterion, target detection criterion (e.g., a probability of missed detection or a probability of detection) for each receive path, interference levels, or network configuration. At 1318 and 1320, when pathloss compensation is applied for the receiving device 1304-a and the receiving device 1304-b, respectively, the devices may use the β_{2-way} parameters to determine recommended transmit power adjustments based on the two-way pathloss experienced by the sensing signal. At 1322 and 1324, similar pathloss compensation processing may be applied for the receiving device 1304-a and the receiving device 1304-b, respectively. The choice between the approaches may be dynamically determined based on real-time channel conditions for each receive path, sensing performance criterion, or coordination requirements between multiple receiving devices.

At 1326 and 1328, the receiving device 1304-a and the receiving device 1304-b, respectively may compute or determine separate sensing pathloss functions (e.g., P_{Tx,PL}) or perform detection measurements based on SNR, SSNR, SSINR, or SINR for respective transmit-target-receive paths. The sensing pathloss functions may incorporate various factors for each receiving device, including distance-dependent pathloss for each receive path, frequency-dependent attenuation, RCS characteristics of sensing targets as observed from different receive angles, and multipath propagation effects unique to each transmit-target-receive geometry. The computation may utilize algorithms, such as distributed maximum likelihood estimation across multiple receive paths, Bayesian inference with prior knowledge of receiver locations, or machine learning approaches trained on multi-receiver sensing scenarios. Each receiving device may also perform additional measurements, such as AoA estimation, ToF measurements, and Doppler shift analysis to enhance their respective sensing pathloss functions.

At 1330, the receiving device 1304-a and the receiving device 1304-b may share the outcomes of the respective sensing pathloss functions and/or interference mitigation schemes with the transmitting device 1302 to determine a transmit power in terms of P_{Bistatic-Sense-Tx,Beam1} or P_{Bistatic-Sense-Tx,Beam2} based on the received information. The receiving devices may share or report the outcome of the sensing transmit powers based on pathloss functions or based on detection measurements, such as SSNR, SNR, SINR, or SSINR, to enable the transmitting device 1302 to determine the transmit powers P_{Bistatic-Sense-Tx,Beam1} or P_{Bistatic-Sense-Tx,Beam2} based on the information received from both receivers. The information sharing may occur through various signaling mechanisms, including UCI, MAC-CEs, RRC signaling, or dedicated sensing control channels. Each receiving device may provide separate power control recommendations based on respective pathloss measurements and sensing criterion. The shared information may include per-receiver pathloss measurements, interference levels observed at each receiving device, recommended power adjustments to optimize sensing performance for each receiver, and coordination information to balance performance across multiple receiving devices. In some cases, the sensing transmit powers, P_{Bistatic-Sense-Tx,Beam1} or P_{Bistatic-Sense-Tx,Beam2}, may be first reported to a distributed sensing SMC either in the NG-RAN or UE or by a centralized sensing configuration and result computation entity residing in the CN, such as sensing function or SensMF. The sensing transmit power may be determined in part due to the saturation power of the receiving device 1304-a and the receiving device 1304-b supported by the receiver and further an achievable isolation level between transmit and receive chains. The transmitting device 1302 may determine the power control based on the pre-detection power control mechanism, which is independent of the pathloss for sensing.

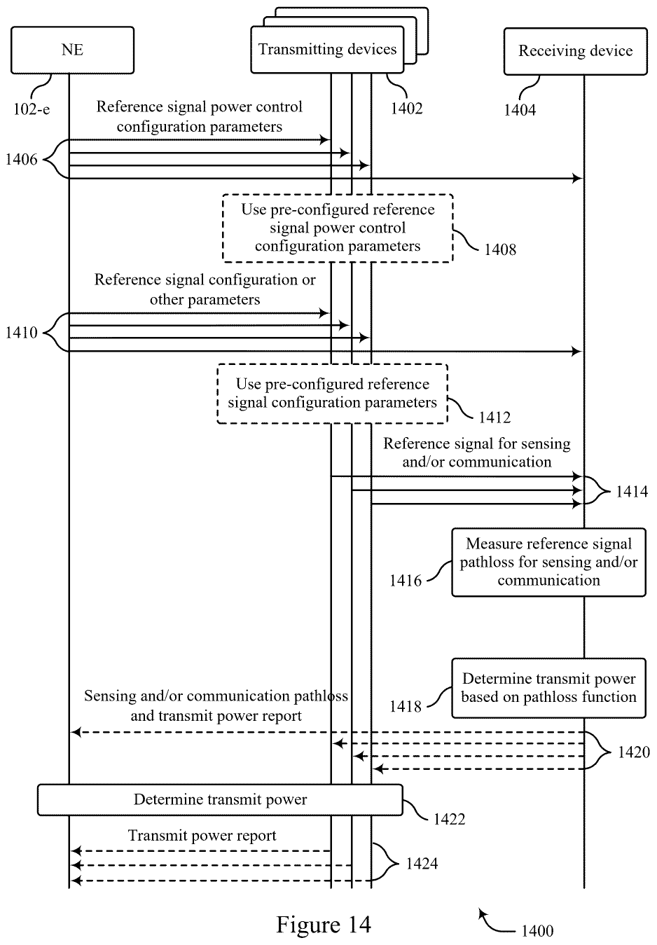

FIG. 14 illustrates an example of a signaling diagram 1400 in accordance with aspects of the present disclosure. In some examples, the signaling diagram 1400 implements or is implemented by aspects of the wireless communications system 100, the wireless communications system 200, the wireless communications system 300, the network architecture diagram 400, the transmission diagram 500, the wireless communications system 600, the process flow 700, the signaling diagram 800, the wireless communications system 900 through the wireless communications system 1100, the process flow 1200, and the process flow 1300. The signaling diagram 1400 may implement or be implemented by an NE 102-e, one or more transmitting devices 1402, and a receiving device 1404, which may be examples of an NE, transmitting devices, and a receiving device, as described with reference to FIGS. 1 through 13. For example, the signaling diagram 1400 includes an example of bistatic power control from a single sensing receiver perspective. Alternative examples of the following may be implemented, where some processes are performed in a different order than described or are not performed. In some cases, processes may include additional features not mentioned below, or further processes may be added.

At 1406, the NE 102-e may transmit reference signal power control configuration parameters to the transmitting devices 1402 (e.g., reference signal-specific and/or sensing-specific configuration parameters). Although the signaling diagram illustrates three transmitting devices 1402, the signaling diagram 1400 may include any numerical quantity of transmitting devices 1402. The transmitting devices 1402 may utilize the power control configuration parameters to transmit reference signals for sensing purposes. For example, the transmitting devices 1402 may receive power control parameters from another entity, such as a distributed sensing SMC either in the NG-RAN or UE or by a centralized sensing configuration and result computation entity residing in the CN (e.g., sensing function, SensMF).

In some cases, at 1408, the transmitting devices 1402 may utilize available pre-configured reference signal power control parameters. The transmitting devices 1402 may utilize reference signal configuration parameters, such as bandwidth (e.g., expressed in number of PRBs), subcarrier spacing, carrier frequency, time domain parameters including number of symbols, periodicity, or normal or extended cyclic prefix, to transmit reference signals for sensing purposes and/or adaptive power control. Other sensing-specific parameters include RCS, type of object, target material, expected point cloud, point cloud format (e.g., static point clouds, dynamic point clouds, lidar sequence point clouds), point cloud quality, anticipated organized point clouds or anticipated unorganized point clouds including 3D Cartesian (X, Y, Z) coordinates, additional attributes, like RGB color, normal vectors, masks, intensity, and timestamps.

At 1410, the NE 102-e may transmit a reference signal configuration or other parameters to the transmitting devices 1402. The reference signal-specific configuration parameters may include reference signal sequence identifiers, resource allocation patterns, transmission timing parameters, FDRAs, PSD configurations, and reference signal port mappings. The sensing-specific configuration parameters may include target detection parameters, such as expected RCS values, sensing range criterion, velocity estimation parameters, AoA estimation configurations, and sensing waveform characteristics. At 1412, the transmitting devices 1402 may utilize available reference signal-specific configuration and/or sensing-specific configuration parameters or internal reference signal configuration parameters. The internal reference signal configuration parameters may include stored reference signal sequences, default resource allocation patterns, fallback transmission parameters, and device-specific sensing capabilities.

At 1414, the transmitting devices 1402 may transmit reference signals for sensing and/or communication to the receiving device 1404. The transmitting devices 1402 may transmit one or more reference signals which may be used for detection and/or tracking of a target, reference signals for communication other than sensing, and/or reference signals for communication other than sensing and sensing. The reference signal transmission may include various types of signals, such as SeRSs, PRSs, TRSs, CSI-RSs, DMRSs, PTRSs, SRSs, or SSBs, among other examples.

At 1416, the receiving device 1404 may perform one or more measurements based on the received scatterers and/or reflections from the target object. The measurements may include RSRP, RSRPP, or any other related received strength measurement according to one or more received paths associated to one or more scattering points of a sensing target. Additional measurements may include SNR, SINR, SSNR, SSINR, Doppler-delay path profiles, range-Doppler profiles, and angle-delay profiles.

At 1418, the receiving device 1404 determines the pathloss function taking into account sensing-specific characteristics. In some cases, the pathloss function takes into account communication-specific pathloss or both sensing-specific pathloss and communication-specific pathloss. The sensing-specific pathloss function may account for unique characteristics of sensing operations, such as the two-way propagation path (e.g., transmitter to target to receiver), RCS of the sensing target, multipath propagation effects in the sensing environment, and frequency-dependent scattering characteristics.

In some cases, at 1420, the receiving device 1404 may report the sensing-specific pathloss, communication-specific pathloss, or both sensing-specific pathloss and communication-specific pathloss to the transmitting devices 1402 (e.g., a distributed sensing SMC either in the NG-RAN or UE or by a centralized sensing configuration and result computation entity residing in the CN, including a sensing function, SensMF or one or more sensing transmitters). The report may be solicited by the requesting entity or based on an unsolicited request. Associated information with the pathloss may include timestamp, pathloss margins and/or uncertainty, quality indicators and related parameters. In some examples, the receiving device 1404 may signal STPCs to increment the transmit power in configured step sizes to determine one or more sensing results, such as detection results, position, or velocity results based on the computed pathloss.

At 1422, the transmitting devices 1402 may compute or determine transmit power based in part on the pathloss function and various other parameters, such as maximum allowable transmit power, co-site or inter-site interference, or other interference considerations. The power determination may be performed on a per-resource basis according to time-frequency resource identifiers, where different transmit power levels may be applied to different REs, resource sets, frequency layers, or carrier frequencies.

At 1424, the transmitting devices 1402 may report the determined transmit power to the NE 102-e. The report may be solicited by the requesting entity or based on an unsolicited request. Associated information with the transmit power may include timestamp and transmission related parameters. The transmit power report may provide information about the determined transmit power, including the transmit power levels applied to different time-frequency resources, the factors for determining the power adjustments, and performance metrics achieved with the selected transmit power levels.

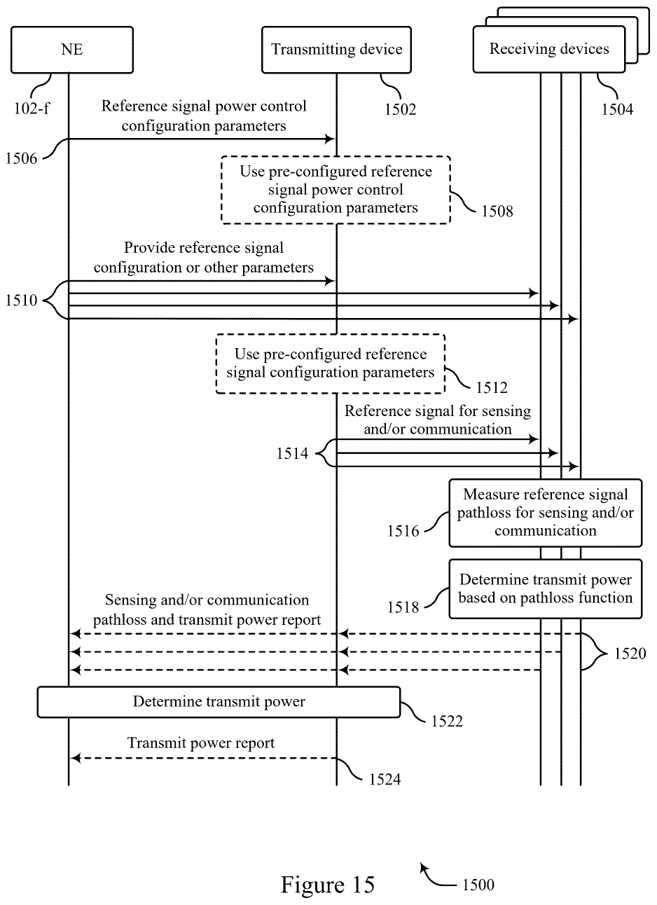

FIG. 15 illustrates an example of a signaling diagram 1500 in accordance with aspects of the present disclosure. In some examples, the signaling diagram 1500 implements or is implemented by aspects of the wireless communications system 100, the wireless communications system 200, the wireless communications system 300, the network architecture diagram 400, the transmission diagram 500, the wireless communications system 600, the process flow 700, the signaling diagram 800, the wireless communications system 900 through the wireless communications system 1100, the process flow 1200, the process flow 1300, and the signaling diagram 1400. The signaling diagram 1500 may implement or be implemented by an NE 102-f, a transmitting device 1502, and one or more receiving devices 1504, which may be examples of an NE, a transmitting device, and receiving devices, as described with reference to FIGS. 1 through 14. For example, the signaling diagram 1500 includes an example of bistatic power control from multiple sensing receivers. Alternative examples of the following may be implemented, where some processes are performed in a different order than described or are not performed. In some cases, processes may include additional features not mentioned below, or further processes may be added.

At 1506, the NE 102-f may transmit reference signal power control configuration parameters to the transmitting device 1502. The transmitting device 1502 may utilize the power control configuration parameters to transmit reference signals for sensing purposes. For example, the transmitting device 1502 may receive power control parameters from another entity, such as a distributed sensing SMC either in the NG-RAN or UE or by a centralized sensing configuration and result computation entity residing in the CN (e.g., sensing function, SensMF, or sensing result computation entity). Additional information can also be provided regarding the power control parameters of other neighboring TRPs (e.g., transmit power, muting patterns, transmit power step size, target base receiver power or sensitivity, receiver saturation power, among other information).

In some cases, at 1508, the transmitting device 1502 may utilize available pre-configured reference signal power control parameters. The transmitting device 1502 may utilize reference signal configuration parameters, such as bandwidth (e.g., expressed in number of PRBs), subcarrier spacing, carrier frequency, time domain parameters including number of symbols, periodicity, or normal or extended cyclic prefix, to transmit reference signals for sensing purposes and/or adaptive power control. Other sensing-specific parameters include RCS, type of object, target material, expected point cloud, point cloud format (e.g., static point clouds, dynamic point clouds, lidar sequence point clouds), point cloud quality, anticipated organized point clouds or anticipated unorganized point clouds including 3D Cartesian (X, Y, Z) coordinates, additional attributes, like RGB color, normal vectors, masks, intensity, and timestamps.

At 1510, the NE 102-f may transmit a reference signal configuration or other parameters to both the transmitting device 1502 and the receiving devices 1504. Although the signaling diagram 1500 is illustrated as including three receiving devices 1504, the signaling diagram may include any numerical quantity of receiving devices 1504. The reference signal-specific configuration parameters may include reference signal sequence identifiers, resource allocation patterns, transmission timing parameters, FDRAs, PSD configurations, and reference signal port mappings. The sensing-specific configuration parameters may include target detection parameters, such as expected RCS values, sensing range criterion, velocity estimation parameters, AoA estimation configurations, and sensing waveform characteristics.

In some cases, at 1512, the receiving devices 1504 may utilize available reference signal-specific configuration and/or sensing-specific configuration parameters or internal reference signal configuration parameters. The internal reference signal configuration parameters may include stored reference signal sequences, default resource allocation patterns, fallback transmission parameters, and device-specific sensing capabilities.

At 1514, the transmitting device 1502 may transmit reference signals for sensing and/or communication to the receiving devices 1504. The transmitting device 1502 may transmit one or more reference signals which may be used for detection and/or tracking of a target, reference signals for communication other than sensing, and/or reference signals for communication other than sensing and sensing. The reference signal transmission may include various types of signals, such as SeRSs, PRSs, TRSs, CSI-RSs, DMRSs, PTRSs, SRSs, or SSBs, among other examples.

At 1516, each of the receiving devices 1504 may perform one or more measurements based on the received scatterers and/or reflections from the target object. The measurements may include RSRP, RSRPP, or any other related received strength measurement according to one or more received paths associated to one or more scattering points of a sensing target. Additional measurements may include SNR, SINR, SSNR, SSINR, Doppler-delay path profiles, range-Doppler profiles, and angle-delay profiles.

At 1518, each of the receiving devices 1504 determines a transmit power based on the pathloss function (e.g., taking into account sensing-specific characteristics). In some cases, the pathloss function takes into account communication-specific pathloss or both sensing-specific pathloss and communication-specific pathloss. The sensing-specific pathloss function may account for characteristics of sensing operations, such as the two-way propagation path (e.g., transmitter to target to receiver), RCS of the sensing target, multipath propagation effects in the sensing environment, and frequency-dependent scattering characteristics.

In some cases, at 1520, the receiving devices 1504 may report the sensing-specific pathloss, communication-specific pathloss, or both sensing-specific pathloss and communication-specific pathloss to both the NE 102-f and the transmitting device 1502 (e.g., a distributed sensing SMC either in the NG-RAN or UE or by a centralized sensing configuration and result computation entity residing in the CN, including a sensing function, SensMF or one or more sensing transmitters). The report may be solicited by the requesting entity or based on an unsolicited request. Associated information with the pathloss may include timestamp, pathloss margins and/or uncertainty, quality indicators and related parameters. In some examples, each receiving device 1504 may signal STPCs to increment the transmit power for a particular beam or antenna panel or sub-array in configured step sizes to increment the power to determine one or more sensing results, such as detection results, position, or velocity results based on the computed pathloss or due to lack of any sensing result if the expected one or more targets. The report may also indicate whether the receive saturation limit at the receiver corresponding to different transmissions from different transmitter and/or different received reflections from the same sensing target has been reached, using a flag or in other cases report the actual saturation receive power at the receiving device. The report may also indicate the measurement quantities in terms of the SNR, SSNR, SINR, and/or SSINR, among other example measurements.

At 1522, the NE 102-f may compute or determine transmit power based on the pathloss function and various other parameters, such as maximum allowable transmit power, co-site or inter-site interference, or other interference considerations. The power determination may be performed on a per-resource basis according to time-frequency resource identifiers, where different transmit power levels may be applied to different REs, resource sets, frequency layers, or carrier frequencies.

In some examples, at 1524, the NE 102-f may report the determined transmit power to the NE 102-f. The report may be solicited by the requesting entity (e.g., the NE 102-f) or based on an unsolicited request. Associated information with the transmit power may include timestamp and transmission related parameters. The transmit power report may provide information about the determined transmit power, including the transmit power levels applied to different time-frequency resources, the factors for determining the power adjustments, and performance metrics achieved with the selected transmit power levels. The bistatic call flow procedures do not preclude the support for deployments involving multiple transmitters and multiple receivers. In some cases, the STPC step size and transmit power increment provided by the receiving devices 1504 may be different based on the transmit capability of the transmitting device 1502, antenna configuration of the transmitting device 1502, different set of pathloss parameters, and/or pathloss, among other parameters. In some examples, such as for a bistatic sensing mode of operation, the receiving devices 1504 may not directly determine the transmit power of the sensing signal for the transmitting device 1502. If a group of receiving devices 1504 are expected to perform measurements based on a shared sensing transmitter signal, each receiving device 1504 may determine and report (e.g., to the transmitting device 1502 or the NE 102-f, including a sensing function, SensMF, and/or sensing result computation entity) an associated pathloss to the corresponding transmit-target-receive path, or a recommendation to increase, decrease, or maintain a transmit power based on a received signal power.

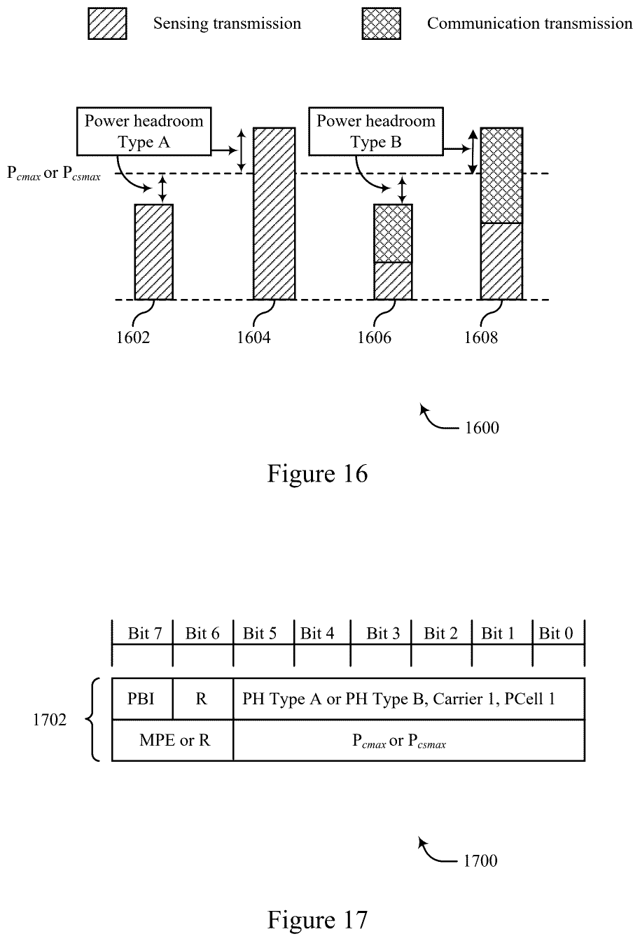

FIG. 16 illustrates an example of a transmission diagram 1600 in accordance with aspects of the present disclosure. In some examples, the transmission diagram 1600 implements or is implemented by aspects of the wireless communications system 100, the wireless communications system 200, the wireless communications system 300, and the network architecture diagram 400, the transmission diagram 500, the wireless communications system 600, the process flow 700, the signaling diagram 800, the wireless communications system 900 through the wireless communications system 1100, the process flow 1200, the process flow 1300, the signaling diagram 1400, and the signaling diagram 1500. For example, the transmission diagram 1600 may implement or be implemented by one or more NEs and UEs, which may be examples of the corresponding devices as described with reference to FIGS. 1 through 15.

The transmission diagram 1600 illustrates power headroom report 1602 through the power headroom report 1608 for managing transmit power budgets in sensing and communication operations. The power headroom report 1602 and the power headroom report 1604 may represent a Type A power headroom configured for sensing transmissions, providing information about remaining transmit power budget when the device is performing sensing operations without concurrent communication transmissions. The power headroom report 1606 and the power headroom report 1608 may represent a Type B power headroom that accounts for both sensing and communication transmissions, indicating the remaining power budget when the device multiplexes reference signals with data or control transmissions. One or more devices (e.g., a transmitting device, a receiving device, and/or a device that is capable of both transmitting and receiving in a sensing mode of operation) may implement an adaptive power headroom procedure to understand a transmit power budget between data and/or reference signal transmissions dedicated to communication on one or more channels (e.g., communication other than sensing), sensing on one or more channels, or a combination of both sensing and communication on one or more channels. The power headroom provides the remaining transmit power budget per carrier or frequency layer, enabling the resource scheduler at a transmitter to select a modulation and coding scheme (MCS), time-frequency resources (e.g., in terms of REs) for sensing, communication or both sensing and communication, that does not impact the power limitations of the transmitting device.

A transmitter for sensing or a transmitter for sensing and communications can be configured to provide frequent or infrequent (e.g., periodic or aperiodic) power headroom reports according to a periodicity and start time in line with a usage based on sensing transmissions, transmissions for communications other than sensing, or transmissions for both sensing and communications other than sensing. The power headroom report may be triggered by one or more trigger conditions, including a periodicity associated with the power headroom report, a start time associated with the power headroom report, a timer associated with the power headroom report, a threshold change in one or more of a sensing pathloss or a communication pathloss, one or more threshold energy values associated with the device, a priority between transmission types, an expiration of a sensing prohibit timer, or an expiration of a communication prohibit timer. The power headroom report 1602 through the power headroom report 1608 may each be associated with different trigger conditions and reporting periodicities based on operational contexts. For example, the power headroom report 1602 and the power headroom report 1604 for sensing operations may be triggered more frequently during active sensing periods, while the power headroom report 1606 and the power headroom report 1608 for combined sensing and communication may be triggered based on changes in either sensing pathloss or communication pathloss.

A separate transmit power limitation (e.g., threshold, maximum) may be applicable for each component carrier. The component carrier can support sensing transmissions, transmissions for communications other than sensing, or both transmissions for sensing and communications other than sensing. The adaptive power headroom tailored for both sensing and communications other than sensing may be measured and reported separately for each component carrier. The remaining transmit power may include respective remaining transmit powers corresponding to a set of component carriers. A transmitting device may coordinate transmissions with both low to high data rates in symbols or slots multiplexed with sensing transmission sub-symbols or symbols, which can be managed based on the available transmit power budget provided by the power headroom.

The adaptive power headroom report can be provided to any transmitter (e.g., from UE to TRP or base station or from TRP or base station to TRP or base station or from TRP or base station to UE). The power headroom report can be provided prior to a transmitter scheduled to transmit on a channel which multiplexes data transmissions, sensing transmissions, or both data and sensing transmissions (e.g., a downlink sensing channel (DL-SCH), an uplink sensing channel (UL-SCH), or a shared channel). The power headroom report 1602 through the power headroom report 1608 may be formatted as MAC-CEs including one or more fields for different power headroom types, which is described in further detail with respect to FIG. 17. The transmission in the sensing mode of operation may include at least one of a SeRS, a PRS, a TRS, a CSI-RS, a DMRS, a PTRS, an SRS, an SSB, control signaling, or data symbols.

There may be multiple different types of power headroom. A first type of power headroom, referred to as a Type A power headroom, (PH_{Sense,TypeA}), takes into account a remaining transmit power for sensing transmissions (e.g., without transmissions other than sensing transmissions) as a function of the sensing pathloss. The function is expressed according to Equation 20:

PH_{Sense,TypeA}=P_{csmax}−(P_{0,2-way}+10 log₁₀(2^{μ}M)+β_{2-way}PL_{sensing}+Δₛₑₙₛₑ) (20)

A second type of power headroom, referred to as a Type B power headroom, (PH_{Sense,TypeB}), takes into account a remaining transmit power for sensing transmissions (e.g., without transmissions other than sensing transmissions) as function of a sensing pathloss and transmissions for communications other than sensing as a function of a communication pathloss. The communications other than sensing can include control information or data transmissions, and can be referred to as communications. The function is expressed according to Equation 21:

$$P {H}_{Sense , TypeB} = {P}_{cs max} - 10 {log}_{10} ( \frac{{10}^{( {P}_{0 , 2 - way} + 10 {log}_{10} ( {2}^{μ} M ) {β}_{2 - way} {PL}_{sensing} + {Δ}_{sense} )}}{10} + \frac{1 {0}^{( {P}_{0 , DL} + 10 {log}_{10} ( {2}^{μ} N ) + {a}_{D L} P {L}_{D L} + Δ )}}{10} ) , \qquad ( 21 )$$

where N PRBs include data transmissions and M PRBs include sensing transmissions.

The power headroom can be based on a transmit power for sensing, transmit power for control information, and/or a transmit power for (e.g., user) data information. The power headroom type takes into account concurrent transmissions of each of the types of information. The above-described Type A and Type B power headroom is a measure of the difference between P_{csmax} and the transmit power assuming no upper bound and therefore can take on values which are positive or negative. Thus, the transmit power is limited by one or more power limits of a carrier or power class of the transmitter. Additionally, or alternatively, the resource scheduler at the transmitting device or configuration entity may have overprovisioned resources for both communication and sensing, configured more data than the transmitter can actually support given the real time (e.g., current) power headroom, overprovisioned resources for communication compared to sensing or vice versa, and/or can adapt the modulation accordingly between communication symbols and sensing reference symbols.

The resource scheduler at the transmitter determines one or more valid combinations of MCS and resource size allocation, assuming that either sensing pathloss, communication pathloss, or both sensing and communication loss remain constant within a margin at the instances of determining and reporting power headroom Type A and Type B. If one or more other target and/or candidate carriers with different supported P_{csmax} and/or different quality of PL_{sensing} or PL_{DL} compared to a current carrier are available and the transmitter has not yet been configured to transmit on the target carrier, another type of power headroom can be reported based on Type A or Type B to evaluate the quality of the target carrier. If one or more target carriers have an improved headroom when compared to a current carrier, then the transmitter may trigger a switch to the target carrier from the set of candidate carriers with respect to the current carrier based on whether Type A or Type B was determined. If one or more target carriers have a degraded headroom when compared to a current carrier, then the transmitter may remain on the current carrier based on whether Type A or Type B was determined.

The multiple power headroom values may be determined depending on the instance of transmission or TTI. For example, a power headroom may be associated with one instance of a transmission or TTI, while a second power headroom may be associated with another subsequent instance of a transmission or TTI. An instance of transmission may correspond to a TTI allocated for or including a transmission, which may span sub-symbols (e.g., a portion of a symbol, cyclic prefix), symbols, sub-slots, mini slots, subframes, frames, hyper frames, etc. In the case of bandwidth aggregated or multi-carrier transmissions, a consolidated maximum power may be derived across the carriers. The consolidation may be in the form of choosing a maximum configured transmit power from the set of carriers or a linear combination or summation of the maximum configured transmit power from each carrier. This results in a consolidated power headroom that takes into account each of the carriers when performing bandwidth aggregated sensing or multi-carrier communications and sensing.

For multi-antenna, multi-panel transmission, massive MIMO, and/or multi-beam transmissions, a different maximum power may be associated with an antenna configuration including different grouped or one or more antenna elements, antenna arrays, antenna panels, sub-arrays, or beams. This results in multiple power headroom values that can be determined based on the different grouped or one or more antenna elements, antenna arrays, antenna panels, sub-arrays, or beams. The assumed transmit power for a transmitting device by which the power headroom of any of the defined types are calculated may be the maximum available or total transmit power available at the transmitting device node. In some other examples, if the transmit power of the transmitting device is limited due to the limitations of an interfering path towards a receiving device (e.g., via a LOS path or an interfering path belonging to the background channel of the transmitting device-receiving device channel), then the power headroom is determined at the transmitting device according to a maximum allowed transmit power via the corresponding antenna port, panel, and/or beam associated with the maximum tolerable interference or receiver saturation power.

FIG. 17 illustrates an example of a transmission diagram 1700 in accordance with aspects of the present disclosure. In some examples, the transmission diagram 1700 implements or is implemented by aspects of the wireless communications system 100, the wireless communications system 200, the wireless communications system 300, and the network architecture diagram 400, the transmission diagram 500, the wireless communications system 600, the process flow 700, the signaling diagram 800, the wireless communications system 900 through the wireless communications system 1100, the process flow 1200, the process flow 1300, the signaling diagram 1400, the signaling diagram 1500, and the transmission diagram 1600. For example, the transmission diagram 1700 may implement or be implemented by one or more NEs, UEs, and/or TRPs, which may be examples of the corresponding devices as described with reference to FIGS. 1 through 16.

The transmission diagram 1700 includes an example of a MAC-CE 1702 (e.g., or other type of lower layer signaling, control signaling) utilized to request a power headroom report from a transmitting device in a sensing mode of operation. Although the transmission diagram illustrates a MAC-CE 1702, the request for the power headroom report may be in high-layer signaling (e.g., via a new sensing protocol utilized to request and report the power headroom report) or any other type of control signaling. The MAC-CE 1702 provides information about a transmit power budget of a transmitting device, indicating how much additional power is available for transmission. The MAC-CE 1702 may have a defined structure for the sensing and/or communication adaptive power headroom reporting. The MAC-CE 1702 may be applicable to uplink, downlink, sidelink, a base station to base station interface (e.g., Xn), an F1 interface, a RAN-CN interface, or a UE-CN interface, among other examples.

The MAC-CE 1702 may include a power backoff indicator, P, which is a 1-bit field that indicates whether power backoff is applied due to power management or regulation when the transmitting device operates in one or more frequency bands. Additionally, or alternatively, the MAC-CE 1702 may include one or more reserved bits, R, such as a 1-bit field that is reserved and set to 0. The reserved bits can be used for any metadata and/or information. In some cases, a timestamp may be provided in the reserved bits. In some other cases, a target energy or power criterion may be included in the reserved bits. Additionally, or alternatively, the MAC-CE 1702 may include a power headroom Type A or Type B, which is a 6-bit field that indicates the power headroom level of the transmitting device for a primary cell (PCell) depending on a Type A or Type B power headroom, as described with reference to FIG. 16. Additionally, or alternatively, the MAC-CE 1702 may include measured power reduction or more reserved bits. The measured power reduction field is used to indicate the effective power reduction for an maximum permissible exposure (MPE) or is reserved. Additionally, or alternatively, the MAC-CE 1702 may include a PCSMAX or PCMAX, which is a 6-bit field that indicates a nominal UE transmit power level for sensing transmission or sensing and communication transmissions. In some cases, the power headroom illustrated in the transmission diagram 1700 can extend to multiple MAC-CEs applicable to a power headroom type, multiple carriers associated with a single cell (e.g., PCell, secondary cell (Scell)), and/or multiple carriers associated with multiple cells.

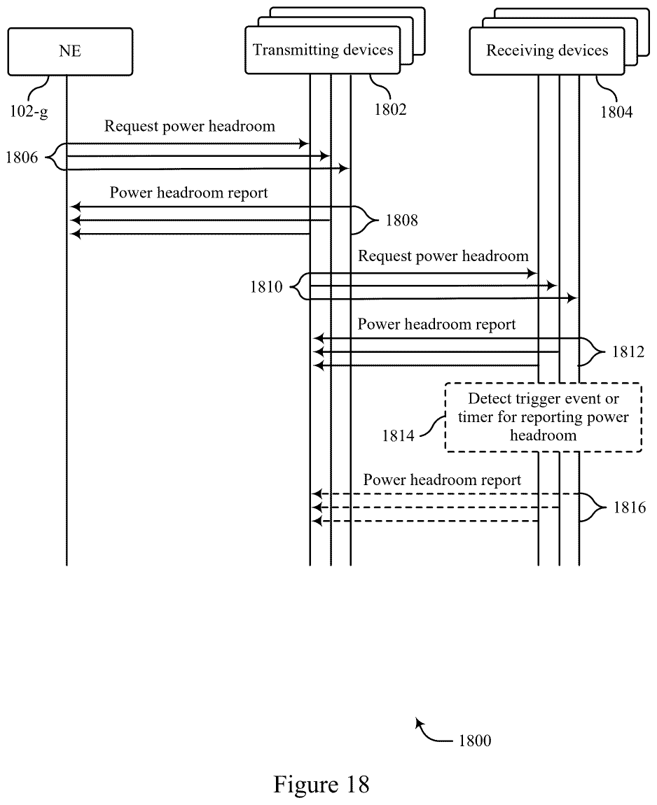

FIG. 18 illustrates an example of a signaling diagram 1800 in accordance with aspects of the present disclosure. In some examples, the signaling diagram 1800 implements or is implemented by aspects of the wireless communications system 100, the wireless communications system 200, the wireless communications system 300, the network architecture diagram 400, the transmission diagram 500, the wireless communications system 600, the process flow 700, the signaling diagram 800, the wireless communications system 900 through the wireless communications system 1100, the process flow 1200, the process flow 1300, the signaling diagram 1400, the signaling diagram 1500, the transmission diagram 1600, and the transmission diagram 1700. The signaling diagram 1800 may implement or be implemented by an NE 102-g, one or more transmitting devices 1802, and one or more receiving devices 1804, which may be examples of an NE (e.g., a base station, gNB, and/or an entity of a CN), transmitting devices, and receiving devices, as described with reference to FIGS. 1 through 17. For example, the signaling diagram 1800 includes an example of power headroom reporting procedures for sensing operations. Alternative examples of the following may be implemented, where some processes are performed in a different order than described or are not performed. In some cases, processes may include additional features not mentioned below, or further processes may be added.

The signaling diagram 1800 illustrates power headroom report procedures with three implementation categories to enable power headroom triggering and reporting. The three implementation categories may provide different approaches for managing power headroom reporting based on network configuration, device capabilities, and operational criterion. A first implementation category may include network-initiated power headroom reporting, where the NE 102-g requests power headroom information from the transmitting devices 1802 based on network conditions or resource allocation. A second implementation category may involve device-to-device power headroom reporting, where the transmitting devices 1802 and the receiving devices 1804 exchange power headroom information directly to coordinate sensing operations and manage interference. A third implementation category may involve event-triggered power headroom reporting, where devices autonomously initiate power headroom reporting based on defined trigger conditions or timer expirations.

One or more devices (e.g., the NE 102-g, the transmitting devices 1802, and/or the receiving devices 1804) may perform power headroom reporting according to the different implementation categories based on a network topology, a sensing mode of operation (e.g., monostatic, bistatic, multistatic), one or more device capabilities, and/or QoS criterion for a transmission. In some cases, the implementation categories may be combined or implemented concurrently to provide enhanced power management and coordination. For example, a network may configure both network-initiated reporting for centralized resource management and event-triggered reporting for responsive power adjustments based on changing channel conditions. The combination of implementation categories may enable more robust power headroom management across different operational scenarios and sensing configurations.

In the first implementation category, at 1806, the NE 102-g may transmit first signaling that requests a power headroom report from one or more transmitting devices 1802. The power headroom report may include a remaining transmit power for a transmission in a sensing mode of operation. The remaining transmit power may be based on a first maximum transmit power that is a total transmit power available at the device or a second maximum transmit power that is determined based on at least one of a maximum interference (e.g., a maximum acceptable interference that results in a threshold signal quality or satisfies other signal performance metrics) or a receiver saturation power. For example, the first maximum transmit power may be calculated as the configured maximum transmit power capability of the device minus the current transmit power being used for ongoing transmissions, providing an indication of the absolute power budget available for additional sensing or communication transmissions. The second maximum transmit power may be calculated by determining the minimum value between a configured maximum transmit power for the respective transmitting devices 1802 and a power level that ensures interference at neighboring devices remains below a threshold or that prevents receiver saturation at one or more receiver components (e.g., of a same device for a monostatic sensing mode of operation). The calculation of the second maximum transmit power may account for isolation levels between transmit and receive chains, path loss to interfering receivers, and maximum allowable interference levels specified by network configuration or regulatory criterion.

In some cases, the request (e.g., or separate signaling that is different from the signaling including the request) may also indicate one or more trigger conditions for transmitting the power headroom report, including a periodicity, a start time, one or more timers, threshold changes in sensing or communication pathloss, threshold energy values, a priority between transmission types, or expiration of prohibit timers. Additional associated information may also be requested in terms of frequency of reporting, priority of power headroom reporting, periodicity of power headroom reporting, and measurement quantities to be used for power headroom reporting. For example, the trigger conditions may indicate a period for transmitting the power headroom report, such as every 10 ms, 20 ms, or 100 ms. Additionally, or alternatively, the trigger conditions may indicate a timing for transmitting the power headroom report, such as at the beginning of a sensing operation, at a defined SFN, or according to a timer (e.g., a 500 ms timer that triggers reporting upon expiration). Additionally, or alternatively, the trigger conditions may indicate threshold changes in sensing or communication pathloss for transmitting the power headroom report (e.g., when pathloss changes by more than 3 dB or 5 dB from a previously reported value). Additionally, or alternatively, the trigger conditions may indicate threshold energy values for transmitting the power headroom report, such as if a remaining power headroom falls below a percentage value (e.g., 10% or 20% of maximum transmit power). Additionally, or alternatively, the trigger conditions may indicate a priority between transmission types for transmitting the power headroom report, such as prioritizing power headroom reporting for sensing transmissions over communication transmissions or vice versa based on QoS criterion or other factors. Additionally, or alternatively, the trigger conditions may indicate to transmit the power headroom report upon expiration of one or more prohibit timers. The request may also indicate additional associated information for transmitting the power headroom report, such as information indicating a frequency of reporting (e.g., once per slot, once per subframe, or once per frame), a priority of power headroom reporting (e.g., higher priority for one or more types of sensing operations or lower priority for one or more other types of sensing operations, including background sensing operations), and measurement quantities to be used for power headroom reporting (e.g., average power consumption over a measurement window, peak power consumption, instantaneous power levels, or power consumption per beam or antenna port).

At 1808, the transmitting devices 1802 may transmit signaling that indicates the power headroom report according to the request received at 1806. The remaining transmit power may include respective remaining transmit powers corresponding to a set of component carriers. The report may include additional metadata and/or information, such as timestamps and power headroom quality, for one or more different power headroom types. The signaling may include a MAC-CE or other control signaling (e.g., NAS, RRC, DCI, UCI, or SCI) with a field that indicates the power headroom report. The power headroom report may include a first type of power headroom report for the transmission in the sensing mode of operation, referred to as a Type A power headroom, as described with reference to FIG. 16, or a second type of power headroom report for the transmission in the sensing mode of operation and one or more data (e.g., communication) transmissions, referred to as a Type B power headroom, as described with reference to FIG. 16.

The transmitting devices 1802 may transmit different power headroom reports for different instances of a sensing transmission or TTIs due to varying channel conditions, changing interference levels, or dynamic resource allocations that impact an available transmit power budget. Additionally, or alternatively, the transmitting devices 1802 may utilize different transmit power levels for different sensing targets or sensing scenarios, and the power headroom may change based on the sensing operation being performed or the multiplexing of sensing and communication transmissions within different TTIs. Thus, the power headroom report may correspond to at least one of a first instance of the transmission in the sensing mode of operation or a first TTI associated with the transmission in the sensing mode of operation. The transmitting devices 1802 may transmit one or more additional power headroom reports corresponding to at least one of a second instance of the transmission in the sensing mode of operation or a second TTI associated with the transmission in the sensing mode of operation.

In the second implementation category, at 1810, the transmitting devices 1802 may request a power headroom report from one or more receiving devices 1804. At 1812, the receiving devices 1804 may respond with the power headroom report according to the request at 1810.

In the third implementation category, at 1814, one or more transmitting devices 1812 and/or one or more receiving devices 1804 may be configured with event-triggered power headroom reporting (e.g., including the event-triggered reporting conditions). Upon detection of a trigger event or timer expiration, the transmitting devices may initiate power headroom reporting. At 1816, the transmitting devices may transmit a power headroom report in response to the detected trigger event. Additionally, or alternatively, a time domain reporting timer or transmit power monitoring timer may be triggered, which enables periodic reporting of the power headroom until timer expiration. The timer starts when the transmitting devices 1802 are allocated time-frequency resources for transmitting power headroom reports.

The transmission in the sensing mode of operation may be associated with at least one of a set of antennas, a set of antenna panels, a set of beams, or massive MIMO. The power headroom report includes a set of power headroom reports corresponding to respective groups of antenna elements, antenna arrays, antenna panels, antenna sub-arrays, or beams. In some cases, the transmitting devices 1802 may receive a prohibit timer configuration that prevents the transmitting device from transmitting power headroom reports until the prohibit timer expires. In some other cases, a monitoring window may be configured at the transmitting devices 1802, which defines a power headroom monitoring period with a start time, end time, duration, periodicity, or any combination thereof.

In some cases, if power headroom types are to be reported as described above, a transmitting devices co-located with a receiving device may perform one or more measurements for pathloss determination. The features described in the signaling diagram 1800 therefore also support transmitting devices co-located with receiving devices to support a monostatic sensing mode of operation, where the sensing mode of operation includes one or more of a monostatic sensing mode, a bistatic sensing mode, a multistatic sensing mode, or a common sensing mode. In some examples, upon configuration of a receiving device with measurement quantity reporting based on reception of a sensing signal resource, the receiving device may determine and report an estimated excessive received power level that exceeds the estimated required received power level for reliable estimation and computation of the measurement quantity. Based on the remaining transmit power, the NE 102-g may transmit additional signaling that indicates one or more of an MCS or one or more time-frequency resources for at least one of the transmission in the sensing mode of operation or a data transmission.

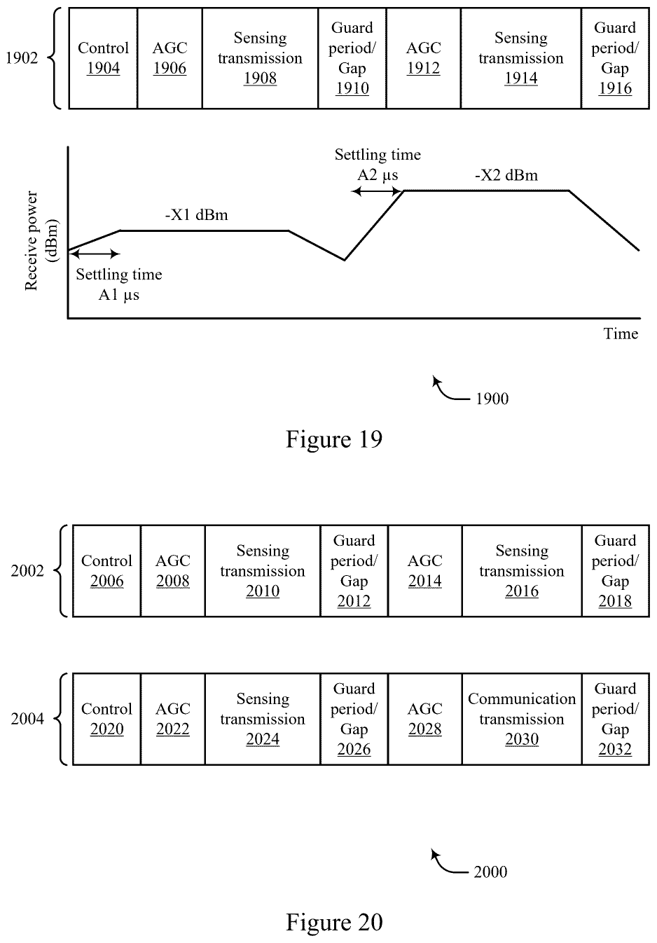

FIG. 19 illustrates an example of a transmission diagram 1900 in accordance with aspects of the present disclosure. In some examples, the transmission diagram 1900 implements or is implemented by aspects of the wireless communications system 100, the wireless communications system 200, the wireless communications system 300, and the network architecture diagram 400, the transmission diagram 500, the wireless communications system 600, the process flow 700, the signaling diagram 800, the wireless communications system 900 through the wireless communications system 1100, the process flow 1200, the process flow 1300, the signaling diagram 1400, the signaling diagram 1500, the transmission diagram 1600, the transmission diagram 1700, and the signaling diagram 1800. For example, the transmission diagram 1900 may implement or be implemented by one or more NEs, UEs, and/or TRPs, which may be examples of the corresponding devices as described with reference to FIGS. 1 through 18.

The transmission diagram 1900 illustrates AGC generation and/or gap symbol configuration for sensing and communication operations. In some cases, receiving devices in a sensing mode of operation may experience signal clipping when incoming signals exceed maximum power handling capabilities of ADCs and other radio frequency components at the receiving device, which may degrade signal quality and introduce measurement errors. Additionally, or alternatively, devices operating in monostatic sensing modes of operation may experience interference between concurrent transmit and receive operations. To reduce or prevent clipping, as well as to reduce interference between concurrent transmit and receive operations, an NE may transmit signaling to configure one or more AGC symbols and/or one or more gap symbols (e.g., a guard period) with or within sensing transmissions. The AGC symbols enable receiving devices to calibrate AGC circuitry before processing sensing signals, while gap symbols provide temporal isolation between different transmission types or operations.

In some cases, the NE may transmit a single signal that indicates for one or more receiving devices and/or one or more transmitting devices to include both AGC symbols and/or gap symbols (e.g., indicates a presence of the gap symbols, among other information) in a sensing transmission. In some other cases, the NE may transmit first signaling that indicates for the one or more receiving devices and/or one or more transmitting devices to include AGC symbols in a sensing transmission and different signaling that indicates for the one or more receiving devices and/or one or more transmitting devices to include gap symbols in a sensing transmission. The signaling (e.g., the single signaling or the multiple signaling) may include a flag that indicates a presence of the AGC symbols and/or the gap symbols, such that the AGC symbols and the gap symbols can be dynamically included or not included according to the flag. The signaling (e.g., the single signaling or the multiple signaling) may also include details related to a location of the AGC symbols and/or the gap symbols in or in relation to the sensing transmission, a numerical quantity of the AGC symbols and/or the gap symbols, or any other details related to the AGC symbols and/or the gap symbols.

In some examples, one or more AGC symbols are generated for performing sensing transmission and reception or sensing and communication transmission and reception. The AGC symbols may be configured in either monostatic or bistatic or multi-static sensing modes of operation depending on whether sensing transmission resources are configured within a TTI or control and/or user data is multiplexed with the sensing transmission resources. The transmission diagram 1900 includes a transmission 1902 that includes multiple types of symbols arranged in a sequence for sensing operations. For example, the transmission 1902 includes control, AGC, sensing, and guard symbols organized to support both sensing and communication functions within a TTI. The transmission 1902 includes a set of time-frequency resources allocated for the sensing mode of operation and at least one of the one or more AGC symbols or the one or more gap symbols, as configured based on signaling that indicates configuration information for at least one of the AGC symbols or the gap symbols in the transmission 1902 (e.g., additional signaling).

The transmission 1902 begins with control symbols 1904, which include control information for managing sensing and communication operations. The control symbols 1904 may carry configuration parameters, resource allocation information, or coordination messages between devices to establish the parameters for subsequent sensing operations.

Following the control symbols 1904, the transmission 1902 includes AGC symbols 1906, which enable AGC calibration for receiving devices. The AGC symbols 1906 may be generated using different approaches. In some cases, the first symbol preceding a reference signal used for sensing is copied or duplicated to generate an AGC symbols 1906, which offers front-end protection in terms of lowered risk of early clipping from near targets or near strong clutters or potential transmission leakages and provides a Doppler or phase snapshot at the start of the sensing processing. That is, the AGC symbols 1906 may include one or more of a first duplicate symbol of an initial symbol of the set of time-frequency resources or a second duplicate symbol of a final symbol of the set of time-frequency resources. The first duplicate symbol is prior to the initial symbol of the set of time-frequency resources, and the second duplicate symbol is after the final symbol of the set of time-frequency resources. The AGC symbols 1906 are transmitted at predetermined power levels to provide for receiving devices to adjust one or more receiver gain settings before processing subsequent sensing symbols, thereby preventing signal clipping and improving receiver sensitivity. The AGC symbols 1906 are associated with a settling time A1, which represents the time duration for the AGC circuitry to stabilize and adjust to a gain level based on the received signal characteristics. The settling time A1 enables the receiving device to calibrate receiver components to handle the expected signal power levels, which may be characterized by a reference power level of −X1 dBm, where −X1 dBm represents a predetermined power threshold used for initial AGC calibration and receiver sensitivity adjustment. The AGC symbols 1906 may also be configured depending on a distance between the receiving device and a sensing target (e.g., for range gated AGCs), as the reflected received path power of near field targets (e.g., targets within a threshold distance from a receiving device and/or a transmitting device) differs from far field targets (e.g., targets outside of a threshold distance from the receiving devices and/or a transmitting device).

The transmission 1902 then includes sensing transmission symbols 1908, which carry reference signals or data configured for sensing operations. The sensing transmission symbols 1908 may include one or more reference signals related to sensing, data related to sensing, and/or control information related to sensing. For example, the sensing transmission symbols 1908 may include at least one of a SeRS, a PRS, a TRS, a CSI-RS, a DMRS, a PTRS, an SRS, an SSB, control signaling, or data symbols.

After the sensing transmission symbols 1908, the transmission 1902 includes guard period and/or gap symbols 1910, which provide temporal isolation between different transmission types or from different transmitting devices. A gap and/or guard symbol is enabled to be generated for performing sensing transmission and reception or sensing and communication transmission and reception. The goal of the gap and/or guard symbol supports temporal isolation between transmissions from multiple transmitting devices, in the case of monostatic sensing modes offering isolation between transmit and receive modes, and between sensing transmissions and control and/or shared channel data. The guard period and/or gap symbols 1910 may be muted symbols or time intervals with zero transmission power to prevent interference between sensing transmissions and facilitate transmit-receive switching in monostatic sensing scenarios. The one or more gap symbols may be generated between at least one of two time-frequency resources that are TDMed within the TTI, between the signaling carrying control information or data, or between signaling received in the sensing mode of operation.

The transmission 1902 includes one or more additional AGC symbols 1912, which provide further AGC calibration capabilities. For cases where the receiver settling time is within a fraction of a symbol for a reference signal used for sensing, the last symbol of a sensing resource is duplicated to generate as an AGC after the sensing resource, which provides for tight phase-coherent sensing and larger swings or variations in a dynamic range within a coherent processing interval (CPI). The AGC symbols 1912 may be positioned after sensing transmission symbols to enable receiver adjustment based on the received signal characteristics and to maintain phase continuity for enhanced Doppler estimation in sensing operations. That is, the AGC symbols 1912 may include a symbol that is subsequent to a final symbol of the set of time-frequency resources based on the second signaling being associated with at least one of a first time-frequency resource pattern associated with the sensing mode of operation or a second time-frequency resource pattern associated with a data transmission, and where the symbol is appended to the set of time-frequency resources. The AGC symbols 1912 are associated with a settling time A2, which represents the time duration for the AGC circuitry to readjust and stabilize after processing the sensing transmission symbols 1908. The settling time A2 enables the receiving device to recalibrate receiver components based on an actual received signal power levels from the sensing transmission, which may be characterized by a reference power level of −X2 dBm, where −X2 dBm represents a power threshold used for post-sensing AGC adjustment and receiver optimization based on the measured signal characteristics from the sensing transmission symbols 1908.

Following the AGC symbols 1912, the transmission 1902 includes additional sensing transmission symbols 1914, which carry further reference signals or data for sensing operations. The sensing transmission symbols 1914 may provide additional sensing opportunities within the same TTI, enabling enhanced target detection and characterization through multiple sensing instances.

The transmission 1902 concludes with guard period and/or gap symbols 1916, which provide final temporal isolation and protection. To enable transmit-receive switching within a TTI, a gap symbol and/or guard period may be configured for scenarios between two sensing resources which are TDMed within a same TTI, between sensing transmissions and control symbols and/or channels or sensing transmission and data symbols, and between sensing transmission and sensing reception resources which are TDMed. The guard period and/or gap symbols 1916 ensure proper separation between the current transmission and subsequent transmissions, preventing interference and enabling efficient transmit-receive switching for continuous sensing operations.

The time domain signal structure may vary depending on the sensing mode of operation, such as monostatic, bistatic, multi-static, or a common sensing mode, and the range, two dimensional (2D) distance, and/or 3D distance between the transmitting device and sensing target and between the sensing target and receiving device. The time domain signal structure may be configured from a configuration entity, such as a transmitting device or a distributed sensing SMC either in the NG-RAN or UE or by a centralized sensing configuration and result computation entity residing in the CN, such as a sensing function or SensMF to a sensing receiver. The configuration information may be based on one or more of channel conditions associated with the sensing transmission, a first spatial geometry of the device, a second spatial geometry of an additional device receiving the second signaling, a third spatial geometry of a sensing target, or a type of communication resources within a TTI associated with the second signaling (e.g., sensing or other communication). The spatial geometry includes, but is not limited to, a relative distance and/or direction between a transmitting device and a target, a target and a receiving device, and/or a transmitting device and a receiving device.

Additional approaches for generating AGC symbols include a hybrid implementation incorporating both the first symbol duplication and last symbol duplication, which offers benefits of lower clipping risk and maintains phase continuity with additional overhead of two additional AGC symbols. Additionally, or alternatively, the sensing resource follows a pre-determined time-frequency pattern, and the AGC is generated by appending the subsequent symbol and/or RE pattern. Additionally, or alternatively, a new generated reference signal for sensing purposes is generated as an AGC and prepended before the first symbol of the sensing resource to avoid peak ambiguity. An adaptive AGC symbol generation may be configured to the receiver, depending on the dynamic channel conditions, spatial geometry of the transmitter, receiver and target, and near, mid-range, and/or far range targets.

One or more configurations for AGC and/or guard period may be described for time-frequency resources that may be configured for dedicated sensing, where sensing symbols occupy a configured TTI. Sensing resources from multiple sensing transmitters may be multiplexed in a given TTI with protections and isolation enabled by both AGC and guard periods and/or gap symbols. An indication of the presence of such AGC symbol or guard period may be provided to the sensing transmitter and/or sensing receiver through static, semi-static, or dynamic signaling methods.

FIG. 20 illustrates an example of a transmission diagram 2000 in accordance with aspects of the present disclosure. In some examples, the transmission diagram 2000 implements or is implemented by aspects of the wireless communications system 100, the wireless communications system 200, the wireless communications system 300, and the network architecture diagram 400, the transmission diagram 500, the wireless communications system 600, the process flow 700, the signaling diagram 800, the wireless communications system 900 through the wireless communications system 1100, the process flow 1200, the process flow 1300, the signaling diagram 1400, the signaling diagram 1500, the transmission diagram 1600, the transmission diagram 1700, the signaling diagram 1800, and the transmission diagram 1900. For example, the transmission diagram 2000 may implement or be implemented by one or more NEs and UEs, which may be examples of the corresponding devices as described with reference to FIGS. 1 through 19.

The transmission diagram 2000 includes a transmission 2002 and a transmission 2004. The transmission 2002 may include control symbols 2006, AGC symbols 2008, sensing transmission symbols 2010, guard period and/or gap symbols 2012, AGC symbols 2014, sensing transmission symbols 2016, and guard period and/or gap symbols 2018. The transmission 2004 may include control symbols 2020, AGC symbols 2022, sensing transmission symbols 2024, guard period and/or gap symbols 2026, AGC symbols 2028, communication transmission symbols 2030, and guard period and/or gap symbols 2032.

The control symbols 2006 and the control symbols 2020 may include control information for managing sensing and communication operations. In some examples, the control symbols 2006 and the control symbols 2020 may carry configuration parameters, resource allocation information, or coordination messages between devices. The control symbols 2006 and the control symbols 2020 may be positioned at the beginning of a transmission to provide control information before data or sensing operations.

The AGC symbols 2008, AGC symbols 2014, AGC symbols 2022, and AGC symbols 2028 may enable AGC calibration for receiving devices. In some examples, the AGC symbols 2008, AGC symbols 2014, AGC symbols 2022, and AGC symbols 2028 may be transmitted at defined power levels to provide for receiving devices to adjust receiver gain settings before processing subsequent sensing or communication symbols. The AGC symbols 2008, AGC symbols 2014, AGC symbols 2022, and AGC symbols 2028 may be duplicated from adjacent sensing symbols or generated according to predetermined patterns to maintain signal continuity.

The sensing transmission symbols 2010, sensing transmission symbols 2016, and sensing transmission symbols 2024 may carry reference signals or data configured for sensing operations. In some examples, the sensing transmission symbols 2010, sensing transmission symbols 2016, and sensing transmission symbols 2024 may include PRSs, SeRSs, or other signals designed to reflect off sensing targets and provide information about target characteristics, such as position, velocity, or RCS.

The guard period and/or gap symbols 2012, guard period and/or gap symbols 2018, guard period and/or gap symbols 2026, and guard period and/or gap symbols 2032 may provide temporal isolation between different transmission types or from different transmitting devices. In some examples, the guard periods may be muted symbols or time intervals with zero transmission power to prevent interference between sensing transmissions, communication transmissions, or transmissions from multiple devices. The gap symbols may facilitate transmit-receive switching in monostatic sensing scenarios.

The communication transmission symbols 2030 may carry data or control information for communication services other than sensing. In some examples, the communication transmission symbols 2030 may include user data, control channel information, or other communication-related signaling that is multiplexed with sensing operations within the same TTI.

In some examples, the receiving device may receive the configuration of the AGC and gap symbol/guard time in a joint manner, based on the symbol index within a defined slot index, subframe index, frame index, or other timing reference. The configuration may be dependent on a variety of factors, including the RCS of the sensing target, sensing target to receiving device distance, target or background clutter characteristics, channel conditions, and interference levels.

In some other examples, for shared and/or integrated communication and sensing resources, control or data symbols may be multiplexed with sensing symbols in a configured TTI. Sensing resources from multiple sensing transmitters and control or data from the serving cell may be multiplexed in a TTI with clipping protections and isolation enabled by both AGC and guard periods/gap symbols. The multiplexing may enable efficient spectrum utilization, while maintaining sensing performance and communication quality. The transmission diagram 2000 may illustrate exemplary implementations of both AGC and gap symbol/guard period configurations in control, shared data and sensing TTIs, such as slots, which can be supported at the receiving device. The arrangement of symbols may vary based on sensing mode criterion (e.g., requirements), interference conditions, and coordination between multiple transmitting devices.

In some cases, AGC and guard periods/gap sub-symbol durations may be supported for full symbol pulse shaping including sensing reference pulse transmissions. The configuration may enable a higher pulse compression gain resulting in a higher sensing SNR and increased range resolution. The sub-symbol approach may provide finer temporal control over AGC and guard period placement within transmission symbols. In some other cases, AGC and guard periods/gap sub-symbol configurations may be supported for sub-symbol sensing transmissions within a cyclic prefix duration of an OFDM symbol. If data is transmitted in the main portion of the symbol, then there may be a sharp settling time between the data portion of the symbol and sensing duration within a cyclic prefix. This approach may enable sensing operations to coexist with communication transmissions within a same symbol duration, while maintaining signal quality for both applications.

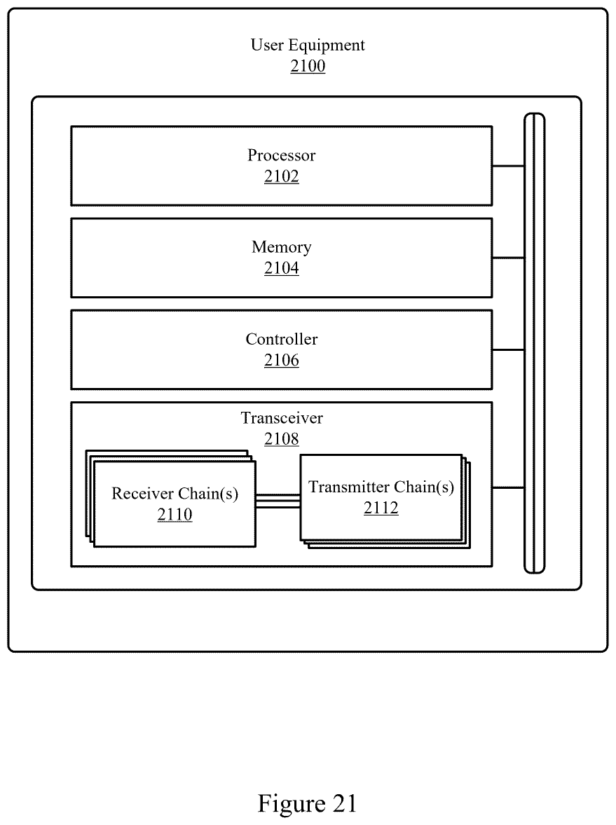

FIG. 21 illustrates an example of a UE 2100 in accordance with aspects of the present disclosure. The UE 2100 may include a processor 2102, a memory 2104, a controller 2106, and a transceiver 2108. The processor 2102, the memory 2104, the controller 2106, or the transceiver 2108, or various combinations thereof or various components thereof may be examples of means for performing various aspects of the present disclosure as described herein. These components may be coupled (e.g., operatively, communicatively, functionally, electronically, electrically) via one or more interfaces.

The processor 2102, the memory 2104, the controller 2106, or the transceiver 2108, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 2102 may include an intelligent hardware device (e.g., a general-purpose processor, a DSP, a central processing unit (CPU), an ASIC, a field-programmable gate-array (FPGA), or any combination thereof). In some implementations, the processor 2102 may be configured to operate the memory 2104. In some other implementations, the memory 2104 may be integrated into the processor 2102. The processor 2102 may be configured to execute computer-readable instructions stored in the memory 2104 to cause the UE 2100 to perform various functions of the present disclosure.

The memory 2104 may include volatile or non-volatile memory. The memory 2104 may store computer-readable, computer-executable code including instructions when executed by the processor 2102 cause the UE 2100 to perform various functions described herein. The code may be stored in a non-transitory computer-readable medium such as the memory 2104 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 2102 and the memory 2104 coupled with the processor 2102 may be configured to cause the UE 2100 to perform one or more of the functions described herein (e.g., executing, by the processor 2102, instructions stored in the memory 2104). For example, the processor 2102 may support wireless communication at the UE 2100 in accordance with examples as disclosed herein. The UE 2100 may be configured to or operable to support a means for receiving first signaling that indicates time-frequency resource information including at least one or more time-frequency resource identifiers for second signaling and that indicates respective sets of power control parameters corresponding to the one or more time-frequency resource identifiers, where the second signaling is associated with a sensing mode of operation, and transmitting, in the sensing mode of operation and based on the time-frequency resource information, the second signaling using at least one transmit power, where the at least one transmit power is based on the respective sets of power control parameters.

Additionally, the UE 2100 may be configured or operable to support any one or combination of transmitting the second signaling using an update to the at least one transmit power, where the update to the at least one transmit power is based on one or more of a pathloss associated with one or more sensing targets, a maximum received self-interference power, a saturation power level, an isolation level between a transmitter and a receiver associated with the device, or a configured maximum transmit power for sensing and communication. Additionally, or alternatively, the UE 2100 may be configured or operable to support receiving third signaling that indicates one or more measurements associated with the pathloss, the update to the at least one transmit power, a transmit power command, or a sensing transmit power command. Additionally, or alternatively, the UE 2100 may be configured or operable to support the maximum received self-interference power, the saturation power level, or the isolation level are per at least one of transmit beam, receive beam, or transmit and receive beam pair. Additionally, or alternatively, the UE 2100 may be configured or operable to support applying the update to the at least one transmit power for a TTI including at least one of a set of sub-symbols, symbols, sub-slots, slots, subframes, frames, system frames, hyper frames, or a time duration corresponding to the second signaling. Additionally, or alternatively, the UE 2100 may be configured or operable to support the sensing mode of operation is monostatic, and where the respective sets of power control parameters are based on one or more of a relative distance between the device and a sensing target or a direction of the device relative to the sensing target. Additionally, or alternatively, the UE 2100 may be configured or operable to support receiving third signaling from one or more additional devices, performing one or more inter-site interference measurements associated with the third signaling, and transmitting, to an NE, the one or more inter-site interference measurements. Additionally, or alternatively, the UE 2100 may be configured or operable to support receiving a measurement associated with a reflected path of a sensing target, where the measurement includes at least one of an SNR, an SINR, an SSNR, an RSRP, an SSINR, an RSRPP, a Doppler-delay path profile, a range-Doppler profile, or an angle-delay profile, and where the at least one transmit power is based on a difference between the measurement and a target measurement. Additionally, or alternatively, the UE 2100 may be configured or operable to support transmitting, to at least one of an additional device or an NE, third signaling that indicates the at least one transmit power. Additionally, or alternatively, the UE 2100 may be configured or operable to support the at least one transmit power is based on a default transmit power, and where the default transmit power is based on an internal configuration of the device. Additionally, or alternatively, the UE 2100 may be configured or operable to support the respective sets of power control parameters include an average energy per RE associated with the second signaling, a bitmap that indicates one or more time locations of the second signaling for muting, a field that indicates a presence of one or more AGC symbols associated with the second signaling, a number of symbols associated with the second signaling, or the time-frequency resource information (e.g., including the one or more time-frequency resource identifiers and/or a resource allocation for the sensing transmission, among other time-frequency resource information), and where the one or more time-frequency resource identifiers indicate one or more of an RE, a set of REs, a frequency layer, or a carrier frequency. Additionally, or alternatively, the UE 2100 may be configured or operable to support the device includes one of a first UE, a first NE, or a TRP, and where the first signaling is received from one of a second NE or a second UE. Additionally, or alternatively, the UE 2100 may be configured or operable to support the second signaling includes at least one of a sensing PRS, a TRS, a CSI-RS, a DMRS, a PTRS, an SRS, an SSB, control signaling, or data symbols, and where the sensing mode of operation includes one or more of a monostatic sensing mode, a bistatic sensing mode, a multistatic sensing mode, or a common sensing mode.

Additionally, or alternatively, the UE 2100 may support at least one memory (e.g., the memory 2104) and at least one processor (e.g., the processor 2102) coupled with the at least one memory and configured to cause the UE to receive first signaling that indicates time-frequency resource information including at least one or more time-frequency resource identifiers for second signaling and that indicates respective sets of power control parameters corresponding to the one or more time-frequency resource identifiers, where the second signaling is associated with a sensing mode of operation, and transmit, in the sensing mode of operation and based on the time-frequency resource information, the second signaling using at least one transmit power, where the at least one transmit power is based on the respective sets of power control parameters.

Additionally, the UE 2100 may be configured or operable to support any one or combination of to transmit the second signaling using an update to the at least one transmit power, where the update to the at least one transmit power is based on one or more of a pathloss associated with one or more sensing targets, a maximum received self-interference power, a saturation power level, an isolation level between a transmitter and a receiver associated with the device, or a configured maximum transmit power for sensing and communication. Additionally, or alternatively, the UE 2100 may be configured or operable to support to receive third signaling that indicates one or more measurements associated with the pathloss, the update to the at least one transmit power, a transmit power command, or a sensing transmit power command. Additionally, or alternatively, the UE 2100 may be configured or operable to support the maximum received self-interference power, the saturation power level, or the isolation level are per at least one of transmit beam, receive beam, or transmit and receive beam pair. Additionally, or alternatively, the UE 2100 may be configured or operable to support to apply the update to the at least one transmit power for a TTI including at least one of a set of sub-symbols, symbols, sub-slots, slots, subframes, frames, system frames, hyper frames, or a time duration corresponding to the second signaling. Additionally, or alternatively, the UE 2100 may be configured or operable to support the sensing mode of operation is monostatic, and where the respective sets of power control parameters are based on one or more of a relative distance between the device and a sensing target or a direction of the device relative to the sensing target. Additionally, or alternatively, the UE 2100 may be configured or operable to support to receive third signaling from one or more additional devices, perform one or more inter-site interference measurements associated with the third signaling, and transmit, to an NE, the one or more inter-site interference measurements. Additionally, or alternatively, the UE 2100 may be configured or operable to support to receive a measurement associated with a reflected path of a sensing target, where the measurement includes at least one of an SNR, an SINR, an SSNR, an RSRP, an SSINR, an RSRPP, a Doppler-delay path profile, a range-Doppler profile, or an angle-delay profile, and where the at least one transmit power is based on a difference between the measurement and a target measurement. Additionally, or alternatively, the UE 2100 may be configured or operable to support to transmit, to at least one of an additional device or an NE, third signaling that indicates the at least one transmit power. Additionally, or alternatively, the UE 2100 may be configured or operable to support the at least one transmit power is based on a default transmit power, and where the default transmit power is based on an internal configuration of the device. Additionally, or alternatively, the UE 2100 may be configured or operable to support the respective sets of power control parameters include an average energy per RE associated with the second signaling, a bitmap that indicates one or more time locations of the second signaling for muting, a field that indicates a presence of one or more AGC symbols associated with the second signaling, a number of symbols associated with the second signaling, or the time-frequency resource information (e.g., including the one or more time-frequency resource identifiers and/or a resource allocation for the sensing transmission, among other time-frequency resource information), and where the one or more time-frequency resource identifiers indicate one or more of an RE, a set of REs, a frequency layer, or a carrier frequency. Additionally, or alternatively, the UE 2100 may be configured or operable to support the device includes one of a first UE, a first NE, or a TRP, and where the first signaling is received from one of a second NE or a second UE. Additionally, or alternatively, the UE 2100 may be configured or operable to support the second signaling includes at least one of an SeRS, a sensing PRS, a TRS, a CSI-RS, a DMRS, a PTRS, an SRS, an SSB, control signaling, or data symbols, and where the sensing mode of operation includes one or more of a monostatic sensing mode, a bistatic sensing mode, a multistatic sensing mode, or a common sensing mode.

The UE 2100 may be configured to or operable to support a means for receiving signaling associated with a sensing mode of operation, where the signaling is associated with at least one transmit power that is based on time-frequency resource information including at least one or more time-frequency resource identifiers for the signaling and that is based on respective sets of power control parameters corresponding to the one or more time-frequency resource identifiers, and performing, based on the at least one transmit power, one or more measurements associated with the signaling.

Additionally, the UE 2100 may be configured or operable to support any one or combination of transmitting, to at least one of an additional device or an NE, additional signaling that indicates at least one of an update to the at least one transmit power or the one or more measurements. Additionally, or alternatively, the UE 2100 may be configured or operable to support the one or more measurements include a pathloss as a function of one or more pathloss parameters associated with the sensing mode of operation, and where the one or more pathloss parameters include one or more of a carrier frequency of the signaling, a first pathloss between an additional device that transmitted the signaling and a sensing target, a second pathloss between the sensing target and the device, an RCS of the sensing target, a first estimated shadow fading between the additional device and the sensing target, or a second estimated shadow fading between the device and the sensing target. Additionally, or alternatively, the UE 2100 may be configured or operable to support the device includes one of a first UE, a first NE, or a first TRP, and where the signaling is received from one of a second UE, a second NE, or a second TRP.

Additionally, or alternatively, the UE 2100 may support at least one memory (e.g., the memory 2104) and at least one processor (e.g., the processor 2102) coupled with the at least one memory and configured to cause the UE to receive signaling associated with a sensing mode of operation, where the signaling is associated with at least one transmit power that is based on time-frequency resource information including at least one or more time-frequency resource identifiers for the signaling and that is based on respective sets of power control parameters corresponding to the one or more time-frequency resource identifiers, and perform, based on the at least one transmit power, one or more measurements associated with the signaling.

Additionally, the UE 2100 may be configured or operable to support any one or combination of to transmit, to at least one of an additional device or an NE, additional signaling that indicates at least one of an update to the at least one transmit power or the one or more measurements. Additionally, or alternatively, the UE 2100 may be configured or operable to support the one or more measurements include a pathloss as a function of one or more pathloss parameters associated with the sensing mode of operation, and where the one or more pathloss parameters include one or more of a carrier frequency of the signaling, a first pathloss between an additional device that transmitted the signaling and a sensing target, a second pathloss between the sensing target and the device, an RCS of the sensing target, a first estimated shadow fading between the additional device and the sensing target, or a second estimated shadow fading between the device and the sensing target. Additionally, or alternatively, the UE 2100 may be configured or operable to support the device includes one of a first UE, a first NE, or a first TRP, and where the signaling is received from one of a second UE, a second NE, or a second TRP.

The controller 2106 may manage input and output signals for the UE 2100. The controller 2106 may also manage peripherals not integrated into the UE 2100. In some implementations, the controller 2106 may utilize an operating system such as iOS®, ANDROID®, WINDOWS®, or other operating systems. In some implementations, the controller 2106 may be implemented as part of the processor 2102.

In some implementations, the UE 2100 may include at least one transceiver 2108. In some other implementations, the UE 2100 may have more than one transceiver 2108. The transceiver 2108 may represent a wireless transceiver. The transceiver 2108 may include one or more receiver chains 2110, one or more transmitter chains 2112, or a combination thereof.

A receiver chain 2110 may be configured to receive signals (e.g., control information, data, packets) over a wireless medium. For example, the receiver chain 2110 may include one or more antennas to receive a signal over the air or wireless medium. The receiver chain 2110 may include at least one amplifier (e.g., a low-noise amplifier (LNA)) configured to amplify the received signal. The receiver chain 2110 may include at least one demodulator configured to demodulate the receive signal and obtain the transmitted data by reversing the modulation technique applied during transmission of the signal. The receiver chain 2110 may include at least one decoder for decoding the demodulated signal to receive the transmitted data.

A transmitter chain 2112 may be configured to generate and transmit signals (e.g., control information, data, packets). The transmitter chain 2112 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature AM (QAM). The transmitter chain 2112 may also include at least one power amplifier configured to amplify the modulated signal to an appropriate power level suitable for transmission over the wireless medium. The transmitter chain 2112 may also include one or more antennas for transmitting the amplified signal into the air or wireless medium.

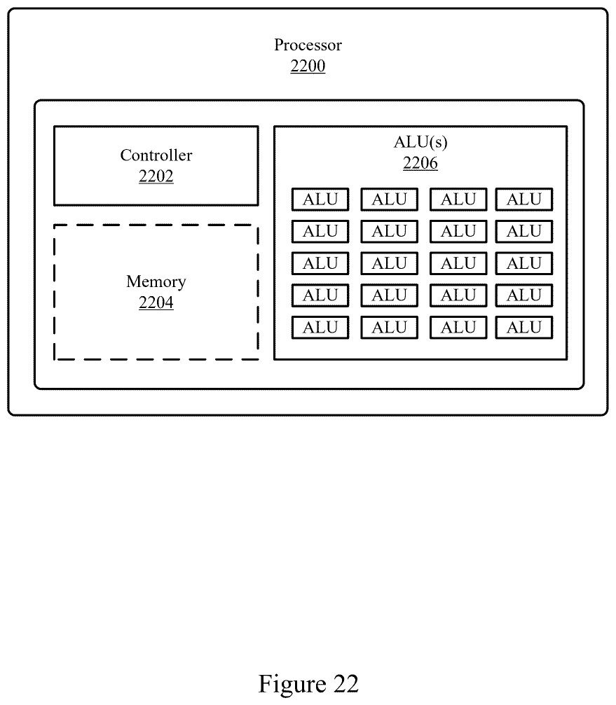

FIG. 22 illustrates an example of a processor 2200 in accordance with aspects of the present disclosure. The processor 2200 may be an example of a processor configured to perform various operations in accordance with examples as described herein. The processor 2200 may include a controller 2202 configured to perform various operations in accordance with examples as described herein. The processor 2200 may optionally include at least one memory 2204, which may be, for example, an L1/L2/L3 cache. Additionally, or alternatively, the processor 2200 may optionally include one or more arithmetic-logic units (ALUs) 2206. One or more of these components may be in electronic communication or otherwise coupled (e.g., operatively, communicatively, functionally, electronically, electrically) via one or more interfaces (e.g., buses).

The processor 2200 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 2200) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 2202 may be configured to manage and coordinate various operations (e.g., signaling, receiving, obtaining, retrieving, transmitting, outputting, forwarding, storing, determining, identifying, accessing, writing, reading) of the processor 2200 to cause the processor 2200 to support various operations in accordance with examples as described herein. For example, the controller 2202 may operate as a control unit of the processor 2200, generating control signals that manage the operation of various components of the processor 2200. These control signals include enabling or disabling functional units, selecting data paths, initiating memory access, and coordinating timing of operations.

The controller 2202 may be configured to fetch (e.g., obtain, retrieve, receive) instructions from the memory 2204 and determine subsequent instruction(s) to be executed to cause the processor 2200 to support various operations in accordance with examples as described herein. The controller 2202 may be configured to track memory addresses of instructions associated with the memory 2204. The controller 2202 may be configured to decode instructions to determine the operation to be performed and the operands involved. For example, the controller 2202 may be configured to interpret the instruction and determine control signals to be output to other components of the processor 2200 to cause the processor 2200 to support various operations in accordance with examples as described herein. Additionally, or alternatively, the controller 2202 may be configured to manage flow of data within the processor 2200. The controller 2202 may be configured to control transfer of data between registers, ALUs 2206, and other functional units of the processor 2200.

The memory 2204 may include one or more caches (e.g., memory local to or included in the processor 2200 or other memory, such as RAM, ROM, DRAM, SDRAM, SRAM, MRAM, flash memory, etc. In some implementations, the memory 2204 may reside within or on a processor chipset (e.g., local to the processor 2200). In some other implementations, the memory 2204 may reside external to the processor chipset (e.g., remote to the processor 2200).

The memory 2204 may store computer-readable, computer-executable code including instructions that, when executed by the processor 2200, cause the processor 2200 to perform various functions described herein. The code may be stored in a non-transitory computer-readable medium such as system memory or another type of memory. The controller 2202 and/or the processor 2200 may be configured to execute computer-readable instructions stored in the memory 2204 to cause the processor 2200 to perform various functions. For example, the processor 2200 and/or the controller 2202 may be coupled with or to the memory 2204, the processor 2200, and the controller 2202, and may be configured to perform various functions described herein. In some examples, the processor 2200 may include multiple processors and the memory 2204 may include multiple memories. One or more of the multiple processors may be coupled with one or more of the multiple memories, which may, individually or collectively, be configured to perform various functions herein.

The one or more ALUs 2206 may be configured to support various operations in accordance with examples as described herein. In some implementations, the one or more ALUs 2206 may reside within or on a processor chipset (e.g., the processor 2200). In some other implementations, the one or more ALUs 2206 may reside external to the processor chipset (e.g., the processor 2200). One or more ALUs 2206 may perform one or more computations such as addition, subtraction, multiplication, and division on data. For example, one or more ALUs 2206 may receive input operands and an operation code, which determines an operation to be executed. One or more ALUs 2206 may be configured with a variety of logical and arithmetic circuits, including adders, subtractors, shifters, and logic gates, to process and manipulate the data according to the operation. Additionally, or alternatively, the one or more ALUs 2206 may support logical operations such as AND, OR, exclusive-OR (XOR), not-OR (NOR), and not-AND (NAND), enabling the one or more ALUs 2206 to handle conditional operations, comparisons, and bitwise operations.

The processor 2200 may support wireless communication in accordance with examples as disclosed herein. The processor 2200 may be configured to or operable to support at least one controller (e.g., the controller 2202) coupled with at least one memory (e.g., the memory 2204) and configured to cause the processor to receive first signaling that indicates time-frequency resource information including at least one or more time-frequency resource identifiers for second signaling and that indicates respective sets of power control parameters corresponding to the one or more time-frequency resource identifiers, where the second signaling is associated with a sensing mode of operation, and transmit, in the sensing mode of operation and based on the time-frequency resource information, the second signaling using at least one transmit power, where the at least one transmit power is based on the respective sets of power control parameters.

Additionally, the processor 2200 may be configured to or operable to support any one or combination of to transmit the second signaling using an update to the at least one transmit power, where the update to the at least one transmit power is based on one or more of a pathloss associated with one or more sensing targets, a maximum received self-interference power, a saturation power level, an isolation level between a transmitter and a receiver associated with the device, or a configured maximum transmit power for sensing and communication. Additionally, or alternatively, the processor 2200 may be configured or operable to support to receive third signaling that indicates one or more measurements associated with the pathloss, the update to the at least one transmit power, a transmit power command, or a sensing transmit power command. Additionally, or alternatively, the processor 2200 may be configured or operable to support the maximum received self-interference power, the saturation power level, or the isolation level are per at least one of transmit beam, receive beam, or transmit and receive beam pair. Additionally, or alternatively, the processor 2200 may be configured or operable to support to apply the update to the at least one transmit power for a TTI including at least one of a set of sub-symbols, symbols, sub-slots, slots, subframes, frames, system frames, hyper frames, or a time duration corresponding to the second signaling. Additionally, or alternatively, the processor 2200 may be configured or operable to support the sensing mode of operation is monostatic, and where the respective sets of power control parameters are based on one or more of a relative distance between the device and a sensing target or a direction of the device relative to the sensing target. Additionally, or alternatively, the processor 2200 may be configured or operable to support to receive third signaling from one or more additional devices, perform one or more inter-site interference measurements associated with the third signaling, and transmit, to an NE, the one or more inter-site interference measurements. Additionally, or alternatively, the processor 2200 may be configured or operable to support to receive a measurement associated with a reflected path of a sensing target, where the measurement includes at least one of an SNR, an SINR, an SSNR, an RSRP, an SSINR, an RSRPP, a Doppler-delay path profile, a range-Doppler profile, or an angle-delay profile, and where the at least one transmit power is based on a difference between the measurement and a target measurement. Additionally, or alternatively, the processor 2200 may be configured or operable to support to transmit, to at least one of an additional device or an NE, third signaling that indicates the at least one transmit power. Additionally, or alternatively, the processor 2200 may be configured or operable to support the at least one transmit power is based on a default transmit power, and where the default transmit power is based on an internal configuration of the device. Additionally, or alternatively, the processor 2200 may be configured or operable to support the respective sets of power control parameters include an average energy per RE associated with the second signaling, a bitmap that indicates one or more time locations of the second signaling for muting, a field that indicates a presence of one or more AGC symbols associated with the second signaling, a number of symbols associated with the second signaling, or the time-frequency resource information (e.g., including the one or more time-frequency resource identifiers and/or a resource allocation for the sensing transmission, among other time-frequency resource information), the one or more time-frequency resource identifiers indicate one or more of an RE, a set of REs, a frequency layer, or a carrier frequency. Additionally, or alternatively, the processor 2200 may be configured or operable to support the device includes one of a first UE, a first NE, or a TRP, and where the first signaling is received from one of a second NE or a second UE. Additionally, or alternatively, the processor 2200 may be configured or operable to support the second signaling includes at least one of a SeRS, a sensing PRS, a TRS, a CSI-RS, a DMRS, a PTRS, an SRS, an SSB, control signaling, or data symbols, and where the sensing mode of operation includes one or more of a monostatic sensing mode, a bistatic sensing mode, a multistatic sensing mode, or a common sensing mode.

The processor 2200 may be configured to or operable to support at least one controller (e.g., the controller 2202) coupled with at least one memory (e.g., the memory 2204) and configured to cause the processor to receive signaling associated with a sensing mode of operation, where the signaling is associated with at least one transmit power that is based on time-frequency resource information including at least one or more time-frequency resource identifiers for the signaling and that is based on respective sets of power control parameters corresponding to the one or more time-frequency resource identifiers, and perform, based on the at least one transmit power, one or more measurements associated with the signaling.

Additionally, the processor 2200 may be configured to or operable to support any one or combination of to transmit, to at least one of an additional device or an NE, additional signaling that indicates at least one of an update to the at least one transmit power or the one or more measurements. Additionally, or alternatively, the processor 2200 may be configured or operable to support the one or more measurements include a pathloss as a function of one or more pathloss parameters associated with the sensing mode of operation, and where the one or more pathloss parameters include one or more of a carrier frequency of the signaling, a first pathloss between an additional device that transmitted the signaling and a sensing target, a second pathloss between the sensing target and the device, an RCS of the sensing target, a first estimated shadow fading between the additional device and the sensing target, or a second estimated shadow fading between the device and the sensing target. Additionally, or alternatively, the processor 2200 may be configured or operable to support the device includes one of a first UE, a first NE, or a first TRP, and where the signaling is received from one of a second UE, a second NE, or a second TRP.

The processor 2200 may be configured to or operable to support at least one controller (e.g., the controller 2202) coupled with at least one memory (e.g., the memory 2204) and configured to cause the processor to transmit first signaling that indicates time-frequency resource information including at least one or more time-frequency resource identifiers for signaling and that indicates respective sets of power control parameters corresponding to the one or more time-frequency resource identifiers, where the first signaling is associated with a sensing mode of operation, and where at least one transmit power for the first signaling is based on the respective sets of power control parameters, and receive, based on the first signaling and the sensing mode of operation, second signaling that indicates a set of measurements corresponding to one or more sensing targets.

Additionally, the processor 2200 may be configured to or operable to support any one or combination of to transmit third signaling that indicates one or more measurements associated with a pathloss, an update to the at least one transmit power, a transmit power command, or a sensing transmit power command. Additionally, or alternatively, the processor 2200 may be configured or operable to support to receive, from one or more devices, one or more inter-site interference measurements. Additionally, or alternatively, the processor 2200 may be configured or operable to support to receive, from a first device, a measurement associated with a reflected path of a sensing target, where the measurement includes at least one of an SNR, an SINR, an SSNR, an RSRP, an SSINR, an RSRPP, a Doppler-delay path profile, a range-Doppler profile, or an angle-delay profile, and where the at least one transmit power is based on a difference between the measurement and a target measurement. Additionally, or alternatively, the processor 2200 may be configured or operable to support to receive, from a device, third signaling that indicates the at least one transmit power.

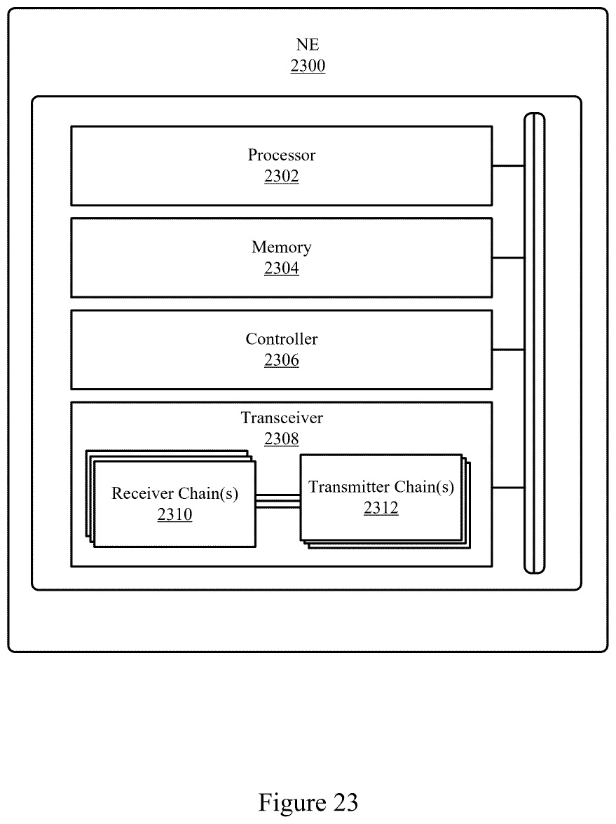

FIG. 23 illustrates an example of an NE 2300 in accordance with aspects of the present disclosure. The NE 2300 may include a processor 2302, a memory 2304, a controller 2306, and a transceiver 2308. The processor 2302, the memory 2304, the controller 2306, or the transceiver 2308, or various combinations thereof or various components thereof may be examples of means for performing various aspects of the present disclosure as described herein. These components may be coupled (e.g., operatively, communicatively, functionally, electronically, electrically) via one or more interfaces.

The processor 2302, the memory 2304, the controller 2306, or the transceiver 2308, or various combinations or components thereof may be implemented in hardware (e.g., circuitry). The hardware may include a processor, a DSP, an ASIC, or other programmable logic device, or any combination thereof configured as or otherwise supporting a means for performing the functions described in the present disclosure.

The processor 2302 may include an intelligent hardware device (e.g., a general-purpose processor, a DSP, a CPU, an ASIC, an FPGA, or any combination thereof). In some implementations, the processor 2302 may be configured to operate the memory 2304. In some other implementations, the memory 2304 may be integrated into the processor 2302. The processor 2302 may be configured to execute computer-readable instructions stored in the memory 2304 to cause the NE 2300 to perform various functions of the present disclosure.

The memory 2304 may include volatile or non-volatile memory. The memory 2304 may store computer-readable, computer-executable code including instructions when executed by the processor 2302 cause the NE 2300 to perform various functions described herein. The code may be stored in a non-transitory computer-readable medium such as the memory 2304 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 2302 and the memory 2304 coupled with the processor 2302 may be configured to cause the NE 2300 to perform one or more of the functions described herein (e.g., executing, by the processor 2302, instructions stored in the memory 2304). For example, the processor 2302 may support wireless communication at the NE 2300 in accordance with examples as disclosed herein. The NE 2300 may be configured to or operable to support a means for receiving first signaling that indicates time-frequency resource information including at least one or more time-frequency resource identifiers for second signaling and that indicates respective sets of power control parameters corresponding to the one or more time-frequency resource identifiers, where the second signaling is associated with a sensing mode of operation, and transmitting, in the sensing mode of operation and based on the time-frequency resource information, the second signaling using at least one transmit power, where the at least one transmit power is based on the respective sets of power control parameters.

Additionally, the NE 2300 may be configured or operable to support any one or combination of transmitting the second signaling using an update to the at least one transmit power, where the update to the at least one transmit power is based on one or more of a pathloss associated with one or more sensing targets, a maximum received self-interference power, a saturation power level, an isolation level between a transmitter and a receiver associated with the device, or a configured maximum transmit power for sensing and communication. Additionally, or alternatively, the NE 2300 may be configured or operable to support receiving third signaling that indicates one or more measurements associated with the pathloss, the update to the at least one transmit power, a transmit power command, or a sensing transmit power command. Additionally, or alternatively, the NE 2300 may be configured or operable to support the maximum received self-interference power, the saturation power level, or the isolation level are per at least one of transmit beam, receive beam, or transmit and receive beam pair. Additionally, or alternatively, the NE 2300 may be configured or operable to support applying the update to the at least one transmit power for a TTI including at least one of a set of sub-symbols, symbols, sub-slots, slots, subframes, frames, system frames, hyper frames, or a time duration corresponding to the second signaling. Additionally, or alternatively, the NE 2300 may be configured or operable to support the sensing mode of operation is monostatic, and where the respective sets of power control parameters are based on one or more of a relative distance between the device and a sensing target or a direction of the device relative to the sensing target. Additionally, or alternatively, the NE 2300 may be configured or operable to support receiving third signaling from one or more additional devices, performing one or more inter-site interference measurements associated with the third signaling, and transmitting, to an NE, the one or more inter-site interference measurements. Additionally, or alternatively, the NE 2300 may be configured or operable to support receiving a measurement associated with a reflected path of a sensing target, where the measurement includes at least one of an SNR, an SINR, an SSNR, an RSRP, an SSINR, an RSRPP, a Doppler-delay path profile, a range-Doppler profile, or an angle-delay profile, and where the at least one transmit power is based on a difference between the measurement and a target measurement. Additionally, or alternatively, the NE 2300 may be configured or operable to support transmitting, to at least one of an additional device or an NE, third signaling that indicates the at least one transmit power. Additionally, or alternatively, the NE 2300 may be configured or operable to support the at least one transmit power is based on a default transmit power, and where the default transmit power is based on an internal configuration of the device. Additionally, or alternatively, the NE 2300 may be configured or operable to support the respective sets of power control parameters include an average energy per RE associated with the second signaling, a bitmap that indicates one or more time locations of the second signaling for muting, a field that indicates a presence of one or more AGC symbols associated with the second signaling, a number of symbols associated with the second signaling, or the time-frequency resource information (e.g., including the one or more time-frequency resource identifiers and/or a resource allocation for the sensing transmission, among other time-frequency resource information), and where the one or more time-frequency resource identifiers indicate one or more of an RE, a set of REs, a frequency layer, or a carrier frequency. Additionally, or alternatively, the NE 2300 may be configured or operable to support the device includes one of a first UE, a first NE, or a TRP, and where the first signaling is received from one of a second NE or a second UE. Additionally, or alternatively, the NE 2300 may be configured or operable to support the second signaling includes at least one of a sensing PRS, a TRS, a CSI-RS, a DMRS, a PTRS, an SRS, an SSB, control signaling, or data symbols, and where the sensing mode of operation includes one or more of a monostatic sensing mode, a bistatic sensing mode, a multistatic sensing mode, or a common sensing mode.

Additionally, or alternatively, the NE 2300 may support at least one memory (e.g., the memory 2304) and at least one processor (e.g., the processor 2302) coupled with the at least one memory and configured to cause the UE to receive first signaling that indicates time-frequency resource information including at least one or more time-frequency resource identifiers for second signaling and that indicates respective sets of power control parameters corresponding to the one or more time-frequency resource identifiers, where the second signaling is associated with a sensing mode of operation, and transmit, in the sensing mode of operation and based on the time-frequency resource information, the second signaling using at least one transmit power, where the at least one transmit power is based on the respective sets of power control parameters.

Additionally, the NE 2300 may be configured or operable to support any one or combination of to transmit the second signaling using an update to the at least one transmit power, where the update to the at least one transmit power is based on one or more of a pathloss associated with one or more sensing targets, a maximum received self-interference power, a saturation power level, an isolation level between a transmitter and a receiver associated with the device, or a configured maximum transmit power for sensing and communication. Additionally, or alternatively, the NE 2300 may be configured or operable to support to receive third signaling that indicates one or more measurements associated with the pathloss, the update to the at least one transmit power, a transmit power command, or a sensing transmit power command. Additionally, or alternatively, the NE 2300 may be configured or operable to support the maximum received self-interference power, the saturation power level, or the isolation level are per at least one of transmit beam, receive beam, or transmit and receive beam pair. Additionally, or alternatively, the NE 2300 may be configured or operable to support to apply the update to the at least one transmit power for a TTI including at least one of a set of sub-symbols, symbols, sub-slots, slots, subframes, frames, system frames, hyper frames, or a time duration corresponding to the second signaling. Additionally, or alternatively, the NE 2300 may be configured or operable to support the sensing mode of operation is monostatic, and where the respective sets of power control parameters are based on one or more of a relative distance between the device and a sensing target or a direction of the device relative to the sensing target. Additionally, or alternatively, the NE 2300 may be configured or operable to support to receive third signaling from one or more additional devices, perform one or more inter-site interference measurements associated with the third signaling, and transmit, to an NE, the one or more inter-site interference measurements. Additionally, or alternatively, the NE 2300 may be configured or operable to support to receive a measurement associated with a reflected path of a sensing target, where the measurement includes at least one of an SNR, an SINR, an SSNR, an RSRP, an SSINR, an RSRPP, a Doppler-delay path profile, a range-Doppler profile, or an angle-delay profile, and where the at least one transmit power is based on a difference between the measurement and a target measurement. Additionally, or alternatively, the NE 2300 may be configured or operable to support to transmit, to at least one of an additional device or an NE, third signaling that indicates the at least one transmit power. Additionally, or alternatively, the NE 2300 may be configured or operable to support the at least one transmit power is based on a default transmit power, and where the default transmit power is based on an internal configuration of the device. Additionally, or alternatively, the NE 2300 may be configured or operable to support the respective sets of power control parameters include an average energy per RE associated with the second signaling, a bitmap that indicates one or more time locations of the second signaling for muting, a field that indicates a presence of one or more AGC symbols associated with the second signaling, a number of symbols associated with the second signaling, or the time-frequency resource information (e.g., including the one or more time-frequency resource identifiers and/or a resource allocation for the sensing transmission, among other time-frequency resource information), and where the one or more time-frequency resource identifiers indicate one or more of an RE, a set of REs, a frequency layer, or a carrier frequency. Additionally, or alternatively, the NE 2300 may be configured or operable to support the device includes one of a first UE, a first NE, or a TRP, and where the first signaling is received from one of a second NE or a second UE. Additionally, or alternatively, the NE 2300 may be configured or operable to support the second signaling includes at least one of a sensing PRS, a TRS, a CSI-RS, a DMRS, a PTRS, an SRS, an SSB, control signaling, or data symbols, and where the sensing mode of operation includes one or more of a monostatic sensing mode, a bistatic sensing mode, a multistatic sensing mode, or a common sensing mode.

The NE 2300 may be configured to or operable to support a means for receiving signaling associated with a sensing mode of operation, where the signaling is associated with at least one transmit power that is based on time-frequency resource information including at least one or more time-frequency resource identifiers for the signaling and that is based on respective sets of power control parameters corresponding to the one or more time-frequency resource identifiers, and performing, based on the at least one transmit power, one or more measurements associated with the signaling.

Additionally, the NE 2300 may be configured or operable to support any one or combination of transmitting, to at least one of an additional device or an NE, additional signaling that indicates at least one of an update to the at least one transmit power or the one or more measurements. Additionally, or alternatively, the NE 2300 may be configured or operable to support the one or more measurements include a pathloss as a function of one or more pathloss parameters associated with the sensing mode of operation, and where the one or more pathloss parameters include one or more of a carrier frequency of the signaling, a first pathloss between an additional device that transmitted the signaling and a sensing target, a second pathloss between the sensing target and the device, an RCS of the sensing target, a first estimated shadow fading between the additional device and the sensing target, or a second estimated shadow fading between the device and the sensing target. Additionally, or alternatively, the NE 2300 may be configured or operable to support the device includes one of a first UE, a first NE, or a first TRP, and where the signaling is received from one of a second UE, a second NE, or a second TRP.

Additionally, or alternatively, the NE 2300 may support at least one memory (e.g., the memory 2304) and at least one processor (e.g., the processor 2302) coupled with the at least one memory and configured to cause the UE to receive signaling associated with a sensing mode of operation, where the signaling is associated with at least one transmit power that is based on time-frequency resource information including at least one or more time-frequency resource identifiers for the signaling and that is based on respective sets of power control parameters corresponding to the one or more time-frequency resource identifiers, and perform, based on the at least one transmit power, one or more measurements associated with the signaling.

Additionally, the NE 2300 may be configured or operable to support any one or combination of to transmit, to at least one of an additional device or an NE, additional signaling that indicates at least one of an update to the at least one transmit power or the one or more measurements. Additionally, or alternatively, the NE 2300 may be configured or operable to support the one or more measurements include a pathloss as a function of one or more pathloss parameters associated with the sensing mode of operation, and where the one or more pathloss parameters include one or more of a carrier frequency of the signaling, a first pathloss between an additional device that transmitted the signaling and a sensing target, a second pathloss between the sensing target and the device, an RCS of the sensing target, a first estimated shadow fading between the additional device and the sensing target, or a second estimated shadow fading between the device and the sensing target. Additionally, or alternatively, the NE 2300 may be configured or operable to support the device includes one of a first UE, a first NE, or a first TRP, and where the signaling is received from one of a second UE, a second NE, or a second TRP.

The NE 2300 may be configured to or operable to support a means for transmitting first signaling that indicates time-frequency resource information including at least one or more time-frequency resource identifiers for signaling and that indicates respective sets of power control parameters corresponding to the one or more time-frequency resource identifiers, where the first signaling is associated with a sensing mode of operation, and where at least one transmit power for the first signaling is based on the respective sets of power control parameters, and receiving, based on the first signaling and the sensing mode of operation, second signaling that indicates a set of measurements corresponding to one or more sensing targets.

Additionally, the NE 2300 may be configured to or operable to support any one or combination of transmitting third signaling that indicates one or more measurements associated with a pathloss, an update to the at least one transmit power, a transmit power command, or a sensing transmit power command. Additionally, or alternatively, the NE 2300 may be configured or operable to support receiving, from one or more devices, one or more inter-site interference measurements. Additionally, or alternatively, the NE 2300 may be configured or operable to support receiving, from a first device, a measurement associated with a reflected path of a sensing target, where the measurement includes at least one of an SNR, an SINR, an SSNR, an RSRP, an SSINR, an RSRPP, a Doppler-delay path profile, a range-Doppler profile, or an angle-delay profile, and where the at least one transmit power is based on a difference between the measurement and a target measurement. Additionally, or alternatively, the NE 2300 may be configured or operable to support receiving, from a device, third signaling that indicates the at least one transmit power.

Additionally, or alternatively, the NE 2300 may support at least one memory (e.g., the memory 2304) and at least one processor (e.g., the processor 2302) coupled with the at least one memory and configured to cause the NE to transmit first signaling that indicates time-frequency resource information including at least one or more time-frequency resource identifiers for signaling and that indicates respective sets of power control parameters corresponding to the one or more time-frequency resource identifiers, where the first signaling is associated with a sensing mode of operation, and where at least one transmit power for the first signaling is based on the respective sets of power control parameters, and receive, based on the first signaling and the sensing mode of operation, second signaling that indicates a set of measurements corresponding to one or more sensing targets.

Additionally, the NE 2300 may be configured or operable to support any one or combination of to transmit third signaling that indicates one or more measurements associated with a pathloss, an update to the at least one transmit power, a transmit power command, or a sensing transmit power command. Additionally, or alternatively, the NE 2300 may be configured or operable to support to receive, from one or more devices, one or more inter-site interference measurements. Additionally, or alternatively, the NE 2300 may be configured or operable to support to receive, from a first device, a measurement associated with a reflected path of a sensing target, where the measurement includes at least one of an SNR, an SINR, an SSNR, an RSRP, an SSINR, an RSRPP, a Doppler-delay path profile, a range-Doppler profile, or an angle-delay profile, and where the at least one transmit power is based on a difference between the measurement and a target measurement. Additionally, or alternatively, the NE 2300 may be configured or operable to support to receive, from a device, third signaling that indicates the at least one transmit power.

The controller 2306 may manage input and output signals for the NE 2300. The controller 2306 may also manage peripherals not integrated into the NE 2300. In some implementations, the controller 2306 may utilize an operating system such as iOS®, ANDROID®, WINDOWS®, or other operating systems. In some implementations, the controller 2306 may be implemented as part of the processor 2302.

In some implementations, the NE 2300 may include at least one transceiver 2308. In some other implementations, the NE 2300 may have more than one transceiver 2308. The transceiver 2308 may represent a wireless transceiver. The transceiver 2308 may include one or more receiver chains 2310, one or more transmitter chains 2312, or a combination thereof.

A receiver chain 2310 may be configured to receive signals (e.g., control information, data, packets) over a wireless medium. For example, the receiver chain 2310 may include one or more antennas to receive a signal over the air or wireless medium. The receiver chain 2310 may include at least one amplifier (e.g., an LNA) configured to amplify the received signal. The receiver chain 2310 may include at least one demodulator configured to demodulate the receive signal and obtain the transmitted data by reversing the modulation technique applied during transmission of the signal. The receiver chain 2310 may include at least one decoder for decoding the demodulated signal to receive the transmitted data.

A transmitter chain 2312 may be configured to generate and transmit signals (e.g., control information, data, packets). The transmitter chain 2312 may include at least one modulator for modulating data onto a carrier signal, preparing the signal for transmission over a wireless medium. The at least one modulator may be configured to support one or more techniques such as AM, FM, or digital modulation schemes like PSK or QAM. The transmitter chain 2312 may also include at least one power amplifier configured to amplify the modulated signal to an appropriate power level suitable for transmission over the wireless medium. The transmitter chain 2312 may also include one or more antennas for transmitting the amplified signal into the air or wireless medium.

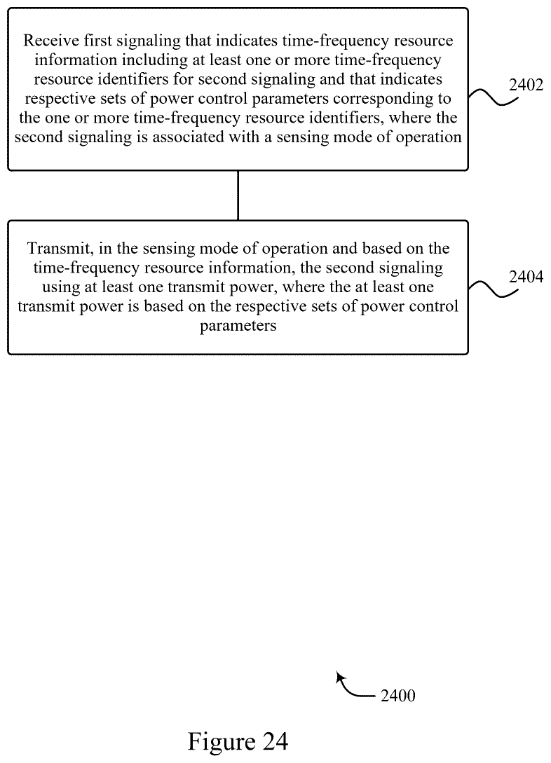

FIG. 24 illustrates a flowchart of a method 2400 performed by a transmitting device (e.g., an NE, a TRP, or a UE) in accordance with aspects of the present disclosure. The operations of the method may be implemented by a transmitting device, such as a UE, an NE, and/or a TRP as described herein. In some implementations, the transmitting device may execute a set of instructions to control the function elements of the transmitting device to perform the described functions. It should be noted that the method described herein describes a possible implementation, and that the operations and the steps may be rearranged or otherwise modified and that other implementations are possible.

At 2402, the method may include receiving first signaling that indicates time-frequency resource information including at least one or more time-frequency resource identifiers for second signaling and that indicates respective sets of power control parameters corresponding to the one or more time-frequency resource identifiers, where the second signaling is associated with a sensing mode of operation. The operations of 2402 may be performed in accordance with examples as described herein. In some implementations, aspects of the operations of 2402 may be performed by a transmitting device, such as a UE as described with reference to FIG. 21 and/or an NE as described with reference to FIG. 23.

At 2404, the method may include transmitting, in the sensing mode of operation and based on the time-frequency resource information, the second signaling using at least one transmit power, where the at least one transmit power is based on the respective sets of power control parameters. The operations of 2404 may be performed in accordance with examples as described herein. In some implementations, aspects of the operations of 2404 may be performed by a transmitting device, such as a UE as described with reference to FIG. 21 and/or an NE as described with reference to FIG. 23.

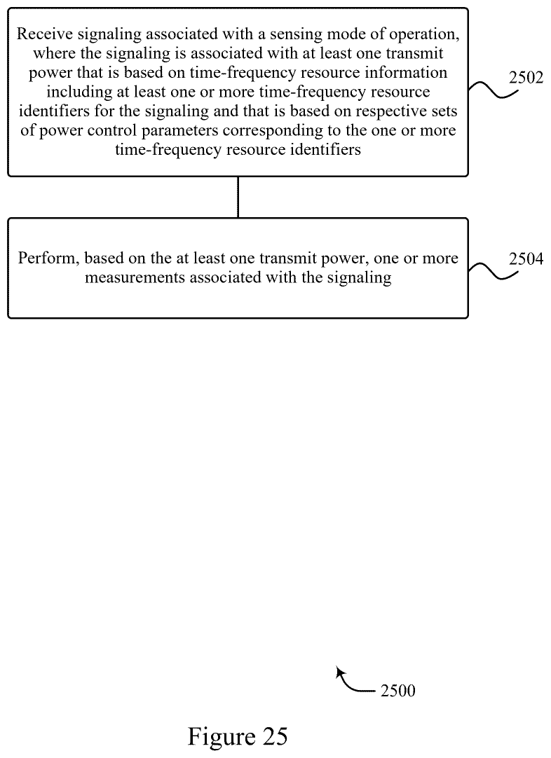

FIG. 25 illustrates a flowchart of a method 2500 performed by a receiving device (e.g., an NE, a TRP, or a UE) in accordance with aspects of the present disclosure. The operations of the method may be implemented by a receiving device, such as a UE, an NE, and/or a TRP as described herein. In some implementations, the receiving device may execute a set of instructions to control the function elements of the receiving device to perform the described functions. It should be noted that the method described herein describes a possible implementation, and that the operations and the steps may be rearranged or otherwise modified and that other implementations are possible.

At 2502, the method may include receiving signaling associated with a sensing mode of operation, where the signaling is associated with at least one transmit power that is based on time-frequency resource information including at least one or more time-frequency resource identifiers for the signaling and that is based on respective sets of power control parameters corresponding to the one or more time-frequency resource identifiers. The operations of 2502 may be performed in accordance with examples as described herein. In some implementations, aspects of the operations of 2502 may be performed by a receiving device, such as a UE as described with reference to FIG. 21 and/or an NE as described with reference to FIG. 23.

At 2504, the method may include performing, based on the at least one transmit power, one or more measurements associated with the signaling. The operations of 2504 may be performed in accordance with examples as described herein. In some implementations, aspects of the operations of 2504 may be performed by a receiving device, such as a UE as described with reference to FIG. 21 and/or an NE as described with reference to FIG. 23.

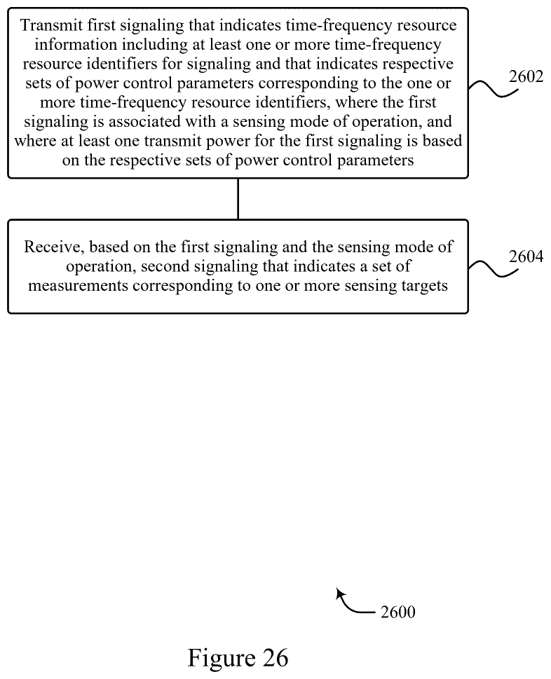

FIG. 26 illustrates a flowchart of a method 2600 in accordance with aspects of the present disclosure. The operations of the method may be implemented by an NE (e.g., a base station, a gNB, a configuration entity, and/or sensing result computation entity) as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 2602, the method may include transmitting first signaling that indicates time-frequency resource information including at least one or more time-frequency resource identifiers for signaling and that indicates respective sets of power control parameters corresponding to the one or more time-frequency resource identifiers, where the first signaling is associated with a sensing mode of operation, and where at least one transmit power for the first signaling is based on the respective sets of power control parameters. The operations of 2602 may be performed in accordance with examples as described herein. In some implementations, aspects of the operations of 2602 may be performed by an NE as described with reference to FIG. 23.

At 2604, the method may include receiving, based on the first signaling and the sensing mode of operation, second signaling that indicates a set of measurements corresponding to one or more sensing targets. The operations of 2604 may be performed in accordance with examples as described herein. In some implementations, aspects of the operations of 2604 may be performed by an NE as described with reference to FIG. 23.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A device for wireless communication, comprising:
at least one memory; and
at least one processor coupled with the at least one memory and operable to cause the device to:
receive first signaling that indicates time-frequency resource information comprising at least one or more time-frequency resource identifiers for second signaling and that indicates respective sets of power control parameters corresponding to the one or more time-frequency resource identifiers, wherein the second signaling is associated with a sensing mode of operation; and
transmit, in the sensing mode of operation and based at least in part on the time-frequency resource information, the second signaling using at least one transmit power, wherein the at least one transmit power is based at least in part on the respective sets of power control parameters.

2. The device of claim 1, wherein the at least one processor is further operable to cause the device to transmit the second signaling using an update to the at least one transmit power, wherein the update to the at least one transmit power is based at least in part on one or more of a pathloss associated with one or more sensing targets, a maximum received self-interference power, a saturation power level, an isolation level between a transmitter and a receiver associated with the device, or a configured maximum transmit power for sensing and communication.

3. The device of claim 2, wherein the at least one processor is further operable to cause the device to receive third signaling that indicates one or more measurements associated with the pathloss, the update to the at least one transmit power, a transmit power command, or a sensing transmit power command.

4. The device of claim 2, wherein the maximum received self-interference power, the saturation power level, or the isolation level are per at least one of transmit beam, receive beam, or transmit and receive beam pair.

5. The device of claim 2, wherein the at least one processor is further operable to cause the device to apply the update to the at least one transmit power for a transmission time interval (TTI) comprising at least one of a set of sub-symbols, symbols, sub-slots, slots, subframes, frames, system frames, hyper frames, or a time duration corresponding to the second signaling.

6. The device of claim 1, wherein the sensing mode of operation is monostatic, and wherein the respective sets of power control parameters are based at least in part on one or more of a relative distance between the device and a sensing target or a direction of the device relative to the sensing target.

7. The device of claim 1, wherein the at least one processor is further operable to cause the device to:
receive third signaling from one or more additional devices;
perform one or more inter-site interference measurements associated with the third signaling; and
transmit, to a network entity (NE), the one or more inter-site interference measurements.

8. The device of claim 1, wherein the at least one processor is further operable to cause the device to receive a measurement associated with a reflected path of a sensing target, wherein the measurement comprises at least one of a signal-to-noise ratio (SNR), a signal-to-interference-noise ratio (SINR), a sensing SNR (SSNR), a sensing SINR (SSINR), a reference signal received power (RSRP), a reference signal received path power (RSRPP), a Doppler-delay path profile, a range-Doppler profile, or an angle-delay profile, and wherein the at least one transmit power is based at least in part on a difference between the measurement and a target measurement.

9. The device of claim 1, wherein the at least one processor is further operable to cause the device to transmit, to at least one of an additional device or a network entity (NE), third signaling that indicates the at least one transmit power.

10. The device of claim 1, wherein the at least one transmit power is based at least in part on a default transmit power, and wherein the default transmit power is based at least in part on an internal configuration of the device.

11. The device of claim 1, wherein the respective sets of power control parameters comprise an average energy per resource element (RE) associated with the second signaling, a bitmap that indicates one or more time locations of the second signaling for muting, a field that indicates a presence of one or more automatic gain control (AGC) symbols associated with the second signaling, a number of symbols associated with the second signaling, or the time-frequency resource information, and wherein the one or more time-frequency resource identifiers indicate one or more of an RE, a set of REs, a frequency layer, or a carrier frequency.

12. The device of claim 1, wherein the device comprises one of a first user equipment (UE), a first network entity (NE), or a transmission-reception point (TRP), wherein the first signaling is received from one of a second NE or a second UE, wherein the second signaling comprises at least one of a sensing reference signal (SeRS), a positioning reference signal (PRS), a tracking reference signal (TRS), a channel state information reference signal (CSI-RS), a demodulation reference signal (DMRS), a phase tracking reference signal (PTRS), a sounding reference signal (SRS), a synchronization signal block (SSB), control signaling, or data symbols, and wherein the sensing mode of operation comprises one or more of a monostatic sensing mode, a bistatic sensing mode, a multistatic sensing mode, or a common sensing mode.

13. A method performed by a device, the method comprising:
receiving first signaling that indicates time-frequency resource information comprising at least one or more time-frequency resource identifiers for second signaling and that indicates respective sets of power control parameters corresponding to the one or more time-frequency resource identifiers, wherein the second signaling is associated with a sensing mode of operation; and
transmitting, in the sensing mode of operation and based at least in part on the time-frequency resource information, the second signaling using at least one transmit power, wherein the at least one transmit power is based at least in part on the respective sets of power control parameters.

14. A device for wireless communication, comprising:
at least one memory; and
at least one processor coupled with the at least one memory and operable to cause the device to:
receive signaling associated with a sensing mode of operation, wherein the signaling is associated with at least one transmit power that is based at least in part on time-frequency resource information comprising at least one or more time-frequency resource identifiers for the signaling and that is based at least in part on respective sets of power control parameters corresponding to the one or more time-frequency resource identifiers; and
perform, based at least in part on the at least one transmit power, one or more measurements associated with the signaling.

15. The device of claim 14, wherein the at least one processor is further operable to cause the device to transmit, to at least one of an additional device or a network entity (NE), additional signaling that indicates at least one of an update to the at least one transmit power or the one or more measurements.

16. The device of claim 14, wherein the one or more measurements comprise a pathloss as a function of one or more pathloss parameters associated with the sensing mode of operation, and wherein the one or more pathloss parameters comprise one or more of a carrier frequency of the signaling, a first pathloss between an additional device that transmitted the signaling and a sensing target, a second pathloss between the sensing target and the device, a radar cross section (RCS) of the sensing target, a first estimated shadow fading between the additional device and the sensing target, or a second estimated shadow fading between the device and the sensing target.

17. A network entity (NE) for wireless communication, comprising:
at least one memory; and
at least one processor coupled with the at least one memory and operable to cause the NE to:
transmit first signaling that indicates time-frequency resource information comprising at least one or more time-frequency resource identifiers for signaling and that indicates respective sets of power control parameters corresponding to the one or more time-frequency resource identifiers, wherein the first signaling is associated with a sensing mode of operation, and wherein at least one transmit power for the first signaling is based at least in part on the respective sets of power control parameters; and
receive, based at least in part on the first signaling and the sensing mode of operation, second signaling that indicates a plurality of measurements corresponding to one or more sensing targets.

18. The NE of claim 17, wherein the at least one processor is further operable to cause the NE to transmit third signaling that indicates one or more measurements associated with a pathloss, an update to the at least one transmit power, a transmit power command, or a sensing transmit power command.

19. The NE of claim 17, wherein the at least one processor is further operable to cause the NE to receive, from one or more devices, one or more inter-site interference measurements.

20. The NE of claim 17, wherein the at least one processor is further operable to cause the NE to:
receive, from a first device, a measurement associated with a reflected path of a sensing target, wherein the measurement comprises at least one of a signal-to-noise ratio (SNR), a signal-to-interference-noise ratio (SINR), a sensing SNR (SSNR), a reference signal received power (RSRP), a sensing SINR (SSINR), a reference signal received path power (RSRPP), a Doppler-delay path profile, a range-Doppler profile, or an angle-delay profile, and wherein the at least one transmit power is based at least in part on a difference between the measurement and a target measurement.
